(19) United States
(12) Patent Application Publication
(10) Pub. No.: US 2026/0327249 A1
(43) Pub. Date: Oct. 22, 2026

(54) COMPOUND, COMPOSITION, SURFACE TREATMENT AGENT, ARTICLE, AND METHOD FOR MANUFACTURING ARTICLE

(71) Applicant: AGC Inc., Tokyo (JP)

(72) Inventor: Koki WATANABE, Tokyo (JP)

(73) Assignee: AGC Inc., Tokyo (JP)

(21) Appl. No.: 19/466,681

(22) Filed: Feb. 2, 2026

Related U.S. Application Data
(63) Continuation of application No. PCT/JP2024/027748, filed on Aug. 2, 2024.

(30) Foreign Application Priority Data
Aug. 4, 2023 (JP) 2023-128137

(51) Int. Cl. C07F 7/30; C07F 7/22; C09D 4/00; C09D 7/20

(52) U.S. Cl. CPC C07F 7/30; C07F 7/2208; C09D 4/00; C09D 7/20

(57) ABSTRACT

A novel compound capable of forming a surface treatment layer with excellent fingerprint removal property, a composition and a surface treatment agent comprising this novel compound, an article including a surface treatment layer with excellent fingerprint removal property, and a method for manufacturing the same are provided. The compound includes the following Group P and the following group Q: Group P: -M¹R¹₂—, Group Q: —Si(R²)ₙL₃₋ₙ, where M¹ is Sn or Ge, R¹ is each independently a hydrocarbon group or a trialkylsilyloxy group, R is each independently a hydrocarbon group, L is each independently a hydrolyzable group, a group having a hydrolyzable group, or a hydroxyl group, and n is an integer from 0 to 2.

### INCORPORATION BY REFERENCE

This application is based upon and claims the benefit of priority from Japanese patent application No. 2023-128137, filed on Aug. 4, 2023, and PCT application No. PCT/JP2024/027748 filed on Aug. 2, 2024, the disclosure of which is incorporated herein in its entirety by reference.

### BACKGROUND

The present disclosure relates to a compound, a composition, a surface treatment agent, an article, and a method for manufacturing an article.

In recent years, in order to improve performance such as appearance and visibility, a technique for making it difficult for a fingerprint to adhere to a surface of an article and a technique for making it easy to remove dirt are required. As a specific method, a method of performing a surface treatment on a surface of an article using a surface treatment agent is known.

Patent Literature 1 discloses a specific siloxane group-containing silane compound including a divalent linear organopolysiloxane group and a hydrolyzable silyl group.
[Patent Literature 1] International Patent Publication No. WO 2023/017830

### SUMMARY

Further improvement of surface treatment agents has been required from the viewpoint of fingerprint removal property and so on.

The present disclosure has been made in view of such circumstances, and an object of the present disclosure is to provide a novel compound capable of forming a surface treatment layer with excellent fingerprint removal property, a composition and a surface treatment agent comprising the novel compound, an article including a surface treatment layer with excellent fingerprint removal property, and a method for manufacturing the same.

The present disclosure includes the following aspects.

[1]

A compound comprising the following Group P and the following group Q:
Group P: -M¹R¹₂—
Group Q: —Si(R²)ₙL₃₋ₙ
where
M¹ is Sn or Ge,
R¹ is each independently a hydrocarbon group or a trialkylsilyloxy group,
R² is each independently a hydrocarbon group,
L is each independently a hydrolyzable group, a group having a hydrolyzable group, or a hydroxyl group, and
n is an integer from 0 to 2.
   [2]

The compound according to Item [1], wherein the compound is represented by the following Formula (1) or the following Formula (2):

[R¹¹-M¹(R¹)₂-(Q)ᵣ₁-Z¹]ₚ₁A¹(Si(R²)ₙL₃₋ₙ)_{q1} (1)

(L₃₋ₙ(R²)ₙSi)_{q1}A²[Z¹-(Q)ᵣ₁-M¹(R¹)₂-(Q)ᵣ₁-Z¹]A²(Si(R²)ₙL₃₋ₙ)_{q1} (2)
where
M¹ is Sn or Ge,
R¹ is each independently a hydrocarbon group or a trialkylsilyloxy group,
R¹¹ is each independently a hydrocarbon group or a trialkylsilyloxy group, or an organopolysiloxane group,
Q is each independently —O— or —OC(═O)—,
r1 is each independently 0 or 1,
Z¹ is each independently an alkylene group, a polyalkylene oxide group, an organopolysiloxane group, or a combination of an alkylene group with an organopolysiloxane group,
A¹ is a single bond or a (p1+q1)-valent linking group,
R² is each independently a hydrocarbon group,
L is each independently a hydrolyzable group, a group having a hydrolyzable group, or a hydroxyl group,
n is each independently an integer from 0 to 2,
p1 and q1 are each independently an integer of 1 or more, and
A² is each independently a single bond or a (1+q1)-valent linking group.
   [3]

The compound according to Item [1] or [2], wherein M¹ is Ge.

[4]

The compound according to Item [2] or [3], wherein the Z¹ is each independently a group represented by the following Formula (3):

—[{Si(R³)₂—O}ₛ₁—Si(R³)₂—(O)ᵣ₂]ₛ₂—(R²¹)ₛ₃— (3)
where
R³ is each independently a hydrocarbon group,
R²¹ is an alkylene group,
r2 is 0 or 1,
s1 is a number from 0 to 500,
s2 is 0 or 1,
s3 is 0 or 1, and
s2+s3 is 1 or 2.
   [5]

The compound according to any one of Items [2] to [4], wherein the p1 is an integer from 1 to 4.

[6]

The compound according to any one of Items [2] to [5], wherein the q1 is each independently an integer from 1 to 4.

[7]

A composition comprising the compound according to any one of [1] to [6], and a liquid medium.

[8]

A surface treatment agent comprising the compound according to any one of [1] to [6].

[9]

A surface treatment agent comprising the compound according to any one of [1] to [6], and a liquid medium.

[10]

A method for manufacturing an article including a surface treatment layer formed on a substrate by performing surface treatment on the substrate by using a surface treatment agent comprising the compound according to any one of [1] to [6].

[11]

An article comprising a substrate, and a surface treatment layer disposed on the substrate, a surface of the surface treatment layer being treated with the surface treatment agent comprising the compound according to any one of [1] to [6].

[12]

The article according to Item [11], wherein the article is an optical member.

[13]

The article according to Item [11] or [12], wherein the article is a display or a touch panel.

According to an embodiment of the present disclosure, it is possible to provide a novel compound capable of forming a surface treatment layer with excellent fingerprint removal property, a composition and a surface treatment agent comprising the novel compound, an article including a surface treatment layer with excellent fingerprint removal property, and a method for manufacturing the same.

The above and other objects, features and advantages of the present disclosure will become more fully understood from the detailed description given hereinbelow.

### DESCRIPTION OF EMBODIMENTS

A numerical value range specified by using “to” in the specification of the present disclosure includes numerical values before and after “to” as a lower limit value and an upper limit value, respectively, of the range.

In numerical ranges according to a stepwise manner in the present specification, the upper or lower limit value of one numerical range may be replaced with the upper or lower limit value of another numerical range described in a stepwise manner. Further, in numerical ranges described in the present specification, the upper or lower limit value of a numerical range may be replaced with values shown in Examples.

In the specification of the present disclosure, the “surface treatment layer” refers to a layer that is formed on the surface of a substrate by a surface treatment.

In this specification, “Me” may refer to a methyl group and “Et” may refer to an ethyl group.

In this specification, when a compound or a group is represented by a specific formula (X), the compound or the group represented by this formula (X) may be expressed as a compound (X) or a compound X, and a group (X) or a group X, respectively.

When the same symbol exists in a single chemical formula, these symbols may represent structures that are identical to each other, or may represent structures that are different from each other within a defined range.

The bonding direction of a divalent group shown in the specification of the present disclosure is not limited to any particular directions unless otherwise specified. For example, when Y is —COO— in a compound represented by a formula “X—Y—Z”, Y may be —CO—O— or —O—CO—. Further, the aforementioned compound may be “X—CO—O—Z” or “X—O—CO—Z”.

A compound according to the present disclosure includes the following Group P and the following Group Q:
Group P: -M¹R¹₂—
Group Q: —Si(R²)ₙL₃₋ₙ
where
M¹ is Sn or Ge,
R¹ is each independently a hydrocarbon group or a trialkylsilyloxy group,
R² is each independently a hydrocarbon group,
L is each independently a hydrolyzable group, a group having a hydrolyzable group, or a hydroxyl group, and
n is an integer from 0 to 2.

When the compound according to the present disclosure is used as a surface treatment agent, a surface treatment layer with excellent fingerprint removal property can be formed. Although details of this reason are not clear, it is presumed as follows.

The compound of the present disclosure including the above Group Q provides a high adhesion between the Group Q and a substrate, and a surface treatment layer with excellent durability can be formed on the substrate. Further, with the compound of the present disclosure including the above Group P, since Sn or Ge having a large atomic size is present at the center of the structure of the Group P, spatial density of the R¹ group bonded to this atom is reduced and the surface free energy is reduced. As a result, the contact angle relative to water and oil becomes great, and a surface treatment layer with excellent fingerprint removal property is formed.

### <Group P>

The compound according to the present disclosure includes the above Group P. In the compound, only one Group P may be contained, or two or more Groups P may be contained. The compound of the present disclosure preferably includes only one Group P from the viewpoint of availability of raw materials and the ease of manufacturing of the compound. The Group P is a divalent group, and thus may be located on the side of the terminal of the compound or may be located at the central part.
Group P: -M¹R¹₂—
M¹ is Sn or Ge, and R¹ is each independently a hydrocarbon group or a trialkylsilyloxy group.

In a case where there are a plurality of Groups P in one molecule, the plurality of Groups P may be the same as each other or different from each other. The plurality of Groups P are preferably the same as each other from the viewpoint of availability of raw materials and the ease of manufacturing of the compound.

R¹ is a hydrocarbon group or a trialkylsilyloxy group. Examples of the hydrocarbon group include an alkyl group, a cycloalkyl group, an alkenyl group, an allyl group, and the like, and the hydrocarbon group is preferably a saturated hydrocarbon group, and more preferably an alkyl group from the viewpoint of ease of synthesis and so on. The number of carbon atoms of R¹ is preferably from 1 to 6, more preferably from 1 to 3, and among them —CH₃ or —CH₂CH₃ is preferable.

The trialkylsilyloxy group is preferably a group represented by —O—SiR⁴⁰₃, where R⁴⁰ is each independently a hydrocarbon group. The hydrocarbon group in R⁴⁰ is preferably an alkyl group or an aryl group, and more preferably an alkyl group. The number of carbon atoms of R⁴⁰ is preferably from 1 to 6, more preferably from 1 to 4, and further preferably from 1 to 2. Specific examples of the hydrocarbon group in R⁴⁰ include —CH₃, —CH₂CH₃, and —C(CH₃)₃.

### <Group Q>

The compound according to the present disclosure includes a group Q. In the compound, only one Group Q may be contained, or two or more Groups Q may be contained. The number of groups Q included in the compound may be, for example, from 1 to 18, from 2 to 12, and from 2 to 8. The Group Q is a monovalent group, and thus is located at the terminal of the compound.
Group Q: —Si(R²)ₙL₃₋ₙ
R² is each independently a hydrocarbon group, L is each independently a hydrolyzable group, a group having a hydrolyzable group, or a hydroxyl group, and n is an integer from 0 to 2.

In a case where there are a plurality of Groups Q in one molecule, the plurality of Groups Q may be the same as each other or different from each other. The plurality of Groups Q are preferably the same as each other from the viewpoint of availability of raw materials and ease of manufacturing of the compound.

R² is a hydrocarbon group. Examples of the hydrocarbon group include an alkyl group, a cycloalkyl group, an alkenyl group, an allyl group, and the like, and the hydrocarbon group is preferably a saturated hydrocarbon group, and more preferably an alkyl group from the viewpoint of ease of synthesis. The number of carbon atoms of R² is preferably from 1 to 6, more preferably from 1 to 3, and further preferably from 1 to 2.

L is each independently a hydrolyzable group, a group having a hydrolyzable group, or a hydroxyl group. The hydrolyzable group is a group that becomes a hydroxyl group by a hydrolysis reaction. That is, the hydrolyzable silyl group represented by Si-L undergoes a hydrolysis reaction to become a silanol group represented by Si—OH. The silanol group further reacts between the silanol groups to form a Si—O—Si bond. The silanol group undergoes dehydration condensation reaction with a silanol group derived from an oxide present on the surface of the substrate to allow forming a Si—O—Si bond.

Examples of the hydrolyzable group include an alkoxy group, an aryloxy group, a halogen atom, an acyl group, an acyloxy group, and an isocyanato group (—NCO).

The number of carbon atoms of the alkoxy group is preferably from 1 to 6, and more preferably from 1 to 4. The number of carbon atoms of the aryloxy group is preferably from 3 to 10. The aryl group of the aryloxy group may be a heteroaryl group. The halogen atom is preferably a chlorine atom. The acyl group is preferably an acyl group having a number of carbon atoms from 1 to 6. The acyloxy group is preferably an acyloxy group having a number of carbon atoms from 1 to 6.

Examples of the group having the hydrolyzable group may be a group having the hydrolyzable group illustrated above. The group having the hydrolyzable group is preferably —O-L^{A}-L^{B}. L^{A} is an alkylene group, and L^{B} is a hydrolyzable group. The number of carbon atoms of the alkylene group is preferably from 1 to 10. The hydrolyzable group represented by L^{B} is the same as the hydrolyzable group represented by L described above, and its preferred aspect is also the same. Specific examples of the group having the hydrolyzable group include —O—CH₂CH₂—OCH₃, which is one of alkylene oxide-modified alkoxy groups. In this manner, the group having the hydrolyzable group may be an alkylene oxide-modified alkoxy group. The alkylene oxide-modified alkoxy group is preferably a group represented by —(O—R⁴¹)ₙ₁₁-L¹. Here, R⁴¹ is an alkylene group having a number of carbon atoms from 1 to 10, L¹ is an alkoxy group having a number of carbon atoms from 1 to 6, and n11 is an integer from 1 to 6. Among them, R⁴¹ is an alkylene group having a number of carbon atoms from 1 to 6, and n11 is preferably 1.

Among them, L is preferably an alkoxy group having a number of carbon atoms from 1 to 4, an alkylene oxide-modified alkoxy group, or a halogen atom from the viewpoint of the ease of manufacturing of the compound. L is preferably an alkoxy group having a number of carbon atoms from 1 to 4, and more preferably an ethoxy group or a methoxy group from the viewpoint of the fact that outgassing during the application is small and more excellent storage stability of the compound.

n is an integer from 0 to 2, preferably 0 or 1, and more preferably 0. The presence of a plurality of L causes stronger adhesion of the surface treatment layer to a substrate.

When n is 1 or smaller, the plurality of L present in one molecule may be the same as each other or different from each other. The plurality of L are preferably the same as each other from the viewpoint of availability of raw materials and ease of manufacturing of the compound. When n is 2, the plurality of R² present in one molecule may be the same as each other or different from each other. The plurality of R² are preferably the same as each other from the viewpoint of availability of raw materials and ease of manufacturing of the compound.

Specific examples of the Group Q include —Si(OCH₃)₃, —SiCH₃(OCH₃)₂, —Si(OCH₂CH₃)₃, —SiCl₃, —Si(OCOCH₃)₃, —Si(NCO)₃, and —Si(OCH₂CH₂OCH₃)₃.

Hereinafter, the compound according to the present disclosure will be described more specifically by showing general formulas. However, regarding parts similar to the groups described above, the above descriptions may be referred to and detailed descriptions thereof may be omitted.

### (Compound (1), Compound (2))

One embodiment of the compound according to the present disclosure is a compound represented by the following Formula (1) or the following Formula (2):

[R¹¹-M¹(R¹)₂-(Q)ᵣ₁-Z¹]ₚ₁A¹(Si(R²)ₙL₃₋ₙ)_{q1} (1)

(L₃₋ₙ(R²)ₙSi)_{q1}A²[Z¹-(Q)ᵣ₁-M¹(R¹)₂-(Q)ᵣ₁-Z¹]A²(Si(R²)ₙL₃₋ₙ)_{q1} (2)
where
M¹ is Sn or Ge,
R¹ is each independently a hydrocarbon group or a trialkylsilyloxy group,
R¹¹ is each independently a hydrocarbon group or a trialkylsilyloxy group, or an organopolysiloxane group,
Q is each independently —O— or —OC(═O)—,
r1 is each independently 0 or 1,
Z¹ is each independently an alkylene group, a polyalkylene oxide group, an organopolysiloxane group, or a combination of an alkylene group with an organopolysiloxane group,
A¹ is a single bond or a (p1+q1)-valent linking group,
R² is each independently a hydrocarbon group,
L is each independently a hydrolyzable group, a group having a hydrolyzable group, or a hydroxyl group,
n is each independently an integer from 0 to 2,
p1 and q1 are each independently an integer of 1 or more, and
A² is each independently a single bond or a (1+q1)-valent linking group.

M¹ is Sn or Ge. M¹ is preferably Ge since Ge has an atomic size greater than that of Sn and a surface free energy can be further reduced and thus a surface treatment layer with more excellent fingerprint removal property can be formed.

R¹ is each independently a hydrocarbon group or a trialkylsilyloxy group. The hydrocarbon group and the trialkylsilyloxy group have already been described above.

R¹¹ is each independently a hydrocarbon group or a trialkylsilyloxy group, or an organopolysiloxane group.

Examples of the hydrocarbon group include an alkyl group, a cycloalkyl group, and an aryl group, and the hydrocarbon group is preferably a saturated hydrocarbon group, and more preferably an alkyl group from the viewpoint of ease of synthesis and so on. The number of carbon atoms of R¹¹ is preferably from 1 to 8, more preferably from 1 to 4, and further preferably from 1 to 2. Specific examples of the hydrocarbon group in R¹¹ include —CH₃, —CH₂CH₃, and —C(CH₃)₃.

Specific examples of the trialkylsilyloxy group include a group similar to the trialkylsilyloxy group in the above R¹.

The organopolysiloxane group represented by R¹¹ may be a linear organopolysiloxane group, a cyclic organopolysiloxane group, or a cage-like organopolysiloxane group.

The linear organopolysiloxane group is preferably a group represented by the following Formula (A1):

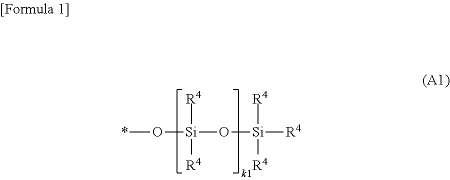

where R⁴ is each independently a hydrocarbon group, and k1 is a number of 1 or more.

The hydrocarbon group in R⁴ is preferably an alkyl group or an aryl group, and more preferably an alkyl group. The number of carbon atoms of R⁴ is preferably from 1 to 6, more preferably from 1 to 4, and further preferably from 1 to 2. Specific examples of the hydrocarbon group in R⁴ include —CH₃, —CH₂CH₃, and —C(CH₃)₃.
k1 may be 1 or more, preferably from 2 to 500, and more preferably from 3 to 300. In Formula (A1), the number k1 of repetitive units represented by “(Si(R⁴)₂—O)” is an average value calculated from data obtained by measuring the compound including the group represented by the Formula (A1) by a nuclear magnetic resonance (NMR) method.

The cyclic organopolysiloxane group is preferably a group represented by the following Formula (A2):

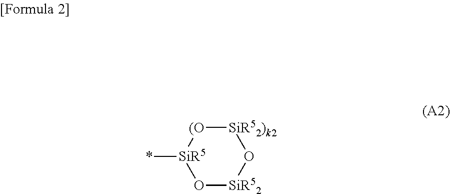

where R⁵ is each independently a hydrocarbon group, a hydrocarbon group having a substituent, or a trialkylsilyloxy group, and k2 is an integer from 1 to 4.

The hydrocarbon group in R⁵ is preferably an alkyl group or an aryl group, and more preferably an alkyl group.

The alkyl group is any of a linear alkyl group, a branched alkyl group, and a cyclic alkyl group, and is preferably a linear alkyl group. The number of carbon atoms of the alkyl group is preferably from 1 to 10, more preferably from 1 to 8, and further preferably from 1 to 4. The same holds true for an alkyl group in a trialkylsilyloxy group.

In a hydrocarbon group having a substituent, examples of the substituent include a halogen atom, a hydroxyl group, an alkoxy group, a trialkylsilyloxy group, a trialkylsilyl group, an amino group, a nitro group, a cyano group, a sulfonyl group, and a trifluoromethyl group.

Specific examples of R⁵ include a methyl group, an ethyl group, a tert-butyl group, and —OSi(CH₃)₃. Among them, R⁵ is preferably a methyl group or an ethyl group, and more preferably a methyl group.

Specific examples of the cyclic organopolysiloxane group include, for example, the following group. Note that * represents a bonding position.

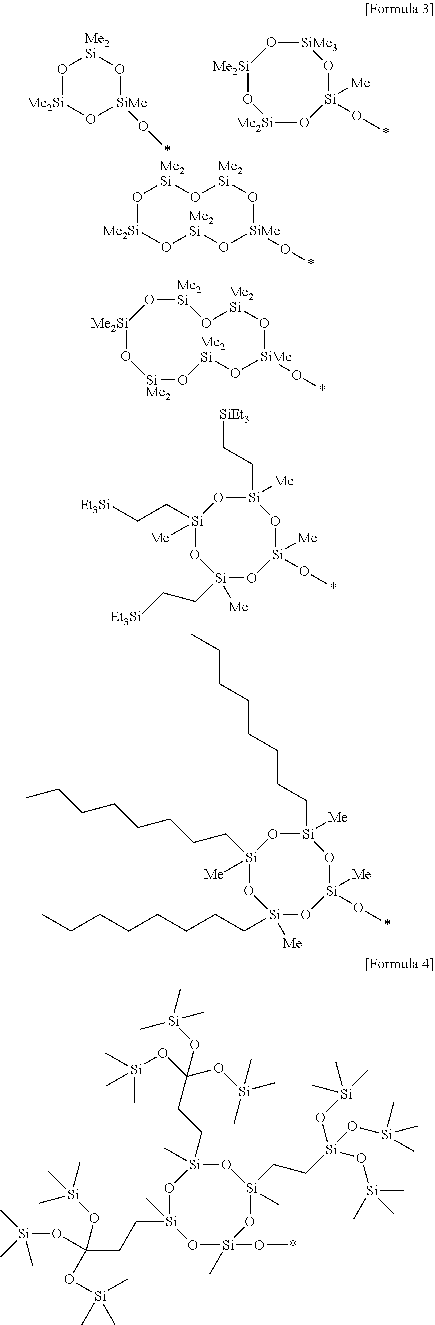

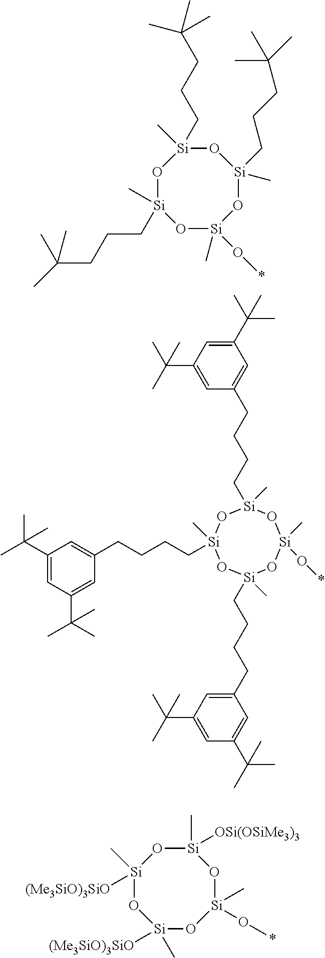

The cage-like organopolysiloxane group is preferably a group represented by the following Formula (A3):

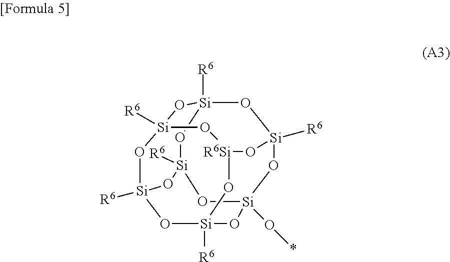

where R⁶ is each independently a hydrocarbon group, a hydrocarbon group having a substituent, or a trialkylsilyloxy group. * represents a bonding position.

The hydrocarbon group in R⁶ is preferably an alkyl group or an aryl group, and more preferably an alkyl group.

The alkyl group is any of a linear alkyl group, a branched alkyl group, and a cyclic alkyl group, and is preferably a linear alkyl group. The number of carbon atoms of the alkyl group is preferably from 1 to 10, more preferably from 1 to 8, and further preferably from 1 to 4. The same holds true for an alkyl group in a trialkylsilyloxy group.

In a hydrocarbon group having a substituent, examples of the substituent include a halogen atom, a hydroxyl group, an alkoxy group, a trialkylsilyloxy group, a trialkylsilyl group, an amino group, a nitro group, a cyano group, a sulfonyl group, and a trifluoromethyl group.

Specific examples of R⁶ include a methyl group, an ethyl group, a tert-butyl group, and —OSi(CH₃)₃. Among them, R⁶ is preferably a methyl group or an ethyl group, and more preferably a methyl group.

Specific examples of the cage-like organopolysiloxane group include the following groups. * represents a bonding position.

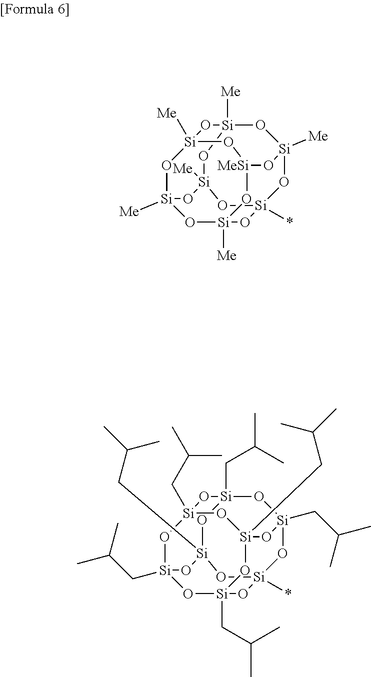

Q is each independently —O— or —OC(═O)—, and is a single bond in a case where r1 is 0.

Z¹ is each independently an alkylene group, a polyalkylene oxide group, an organopolysiloxane group, or a combination of an alkylene group with an organopolysiloxane group.

The number of carbon atoms of the alkylene group in Z¹ may be 1 or more, and from the viewpoint of water repellency, the number of carbon atoms is preferably 2 or more, and more preferably 4 or more. The upper limit of the number of carbon atoms of the alkylene group is not particularly limited, and is, for example, 30 or less, and preferably 24 or less. The alkylene group in Z¹ may be linear, branched, or cyclic, and is preferably linear or branched, and more preferably linear.

The polyalkylene oxide group is preferably a group represented by the following Formula (A4):

*—(R⁴²O)ₙ₁₂—(R⁴²)ₙ₁₃—** (A4)
where R⁴² is each independently an alkylene group having a number of carbon atoms from 1 to 10, n12 is an integer from 1 to 200, n13 is 0 or 1, * is a bond on the side of Q, and ** is a bond on the side of A1 or A².

The number of carbon atoms of the alkylene group in R⁴² is preferably from 1 to 4, and more preferably from 1 to 2 from the viewpoint of ease of manufacturing and so on. Further, n12 is preferably from 3 to 200, and more preferably from 5 to 150 from the viewpoint of ease of manufacturing and so on.

The organopolysiloxane group is preferably a group represented by the following Formula (A5):

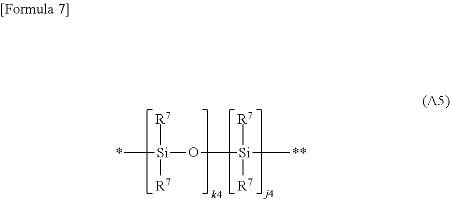

where R⁷ is each independently a hydrocarbon group, k4 is a number of 1 or more, j4 is 0 or 1, * is a bond on the side of Q, and ** is a bond on the side of A¹ or A². Further, in Formula (A5), the number of repetitive units k4 represented by “(Si(R⁷)₂—O)” is an average value calculated from data obtained by measuring the compound including the group represented by the Formula (A5) by a nuclear magnetic resonance (NMR) method.

Examples of the hydrocarbon group in R⁷ include an alkyl group, a cycloalkyl group, an alkenyl group, and an allyl group, and the hydrocarbon group in R⁷ is preferably a saturated hydrocarbon group, and more preferably an alkyl group from the viewpoint of ease of synthesis and so on. The number of carbon atoms of R⁷ is preferably from 1 to 6, more preferably from 1 to 3, and among them, —CH₃ or —CH₂CH₃ is preferable.

k4 may be 1 or more, preferably from 2 to 500, and more preferably from 3 to 300.

Examples of the combination of the alkylene group with the organopolysiloxane group include a group represented by the following Formulas (B1) to (B4):

*—R^{Si}-Ak¹-** (B1)

*-Ak¹-R^{Si}—** (B2)

*-Ak¹-R^{Si}-Ak¹-** (B3)

*—R^{Si}-Ak¹-R^{Si}—** (B4)
where Ak¹ is each independently an alkylene group, R^{Si} is each independently the above Group (A5), * is a bond on the side of Q, and ** is a bond on the side of A1 or A².

The number of carbon atoms of the alkylene group in Ak¹ may be 1 or more, preferably 2 or more, and more preferably 4 or more from the viewpoint of fingerprint removal property. The upper limit of the number of carbon atoms of the alkylene group is not particularly limited, and is, for example, 30 or less, and preferably 24 or less. The alkylene group in Ak¹ is preferably linear or branched, and more preferably linear.

The combination of the alkylene group with the organopolysiloxane group is, from the viewpoint of fingerprint removal property, preferably a Group (B1), a Group (B3), or a Group (B4), and more preferably a Group (B1) or a Group (B4), and more preferably a Group (B1) from the viewpoint of ease of manufacturing.

From the viewpoint of fingerprint removal property, it is preferable that the Z¹ is each independently a group represented by the following Formula (3):

—[{Si(R³)₂—O}ₛ₁—Si(R³)₂—(O)ᵣ₂]ₛ₂—(R²¹)ₛ₃— (3)
where
R³ is each independently a hydrocarbon group,
R²¹ is an alkylene group,
r2 is 0 or 1,
s1 is a number from 0 to 500,
s2 is 0 or 1,
s3 is 0 or 1, and
s2+s3 is 1 or 2.

R³ is each independently a hydrocarbon group. Examples of the hydrocarbon group include an alkyl group, a cycloalkyl group, an alkenyl group, and an allyl group, and the hydrocarbon group is preferably a saturated hydrocarbon group, and more preferably an alkyl group from the viewpoint of ease of synthesis and so on. The number of carbon atoms in R³ is preferably from 1 to 6, more preferably from 1 to 3, and among them, —CH₃ or —CH₂CH₃ is preferable.

The number of carbon atoms of the alkylene group in R²¹ is preferably 1 or more, preferably 2 or more, and more preferably 4 or more. The upper limit of the number of carbon atoms of the alkylene group is not particularly limited, and is, for example, 30 or less, and preferably 24 or less. The alkylene group in R²¹ is preferably linear or branched, and more preferably linear.

s1 is a number from 0 to 500, is preferably a number from 1 to 300, and more preferably a number from 1 to 200 from the viewpoint of excellent liquid repellency and durability of the compound.

In Formula (3), the number of repetitive units s1 represented by “{Si(R³)₂—O}” is an average value calculated from data obtained by measuring the compound including the group represented by the Formula (3) by a nuclear magnetic resonance (NMR) method.

A¹ is a single bond or a (p1+q1)-valent linking group. Further, A² is each independently a single bond or a (1+q1)-valent linking group. Hereinafter, A¹ will be described as a representative example. A² is interpreted as the one in which p1 is limited to 1 in the following description of A¹.

A¹ may be any group that does not impair the effects of the present disclosure, and specific examples of A¹ may include an alkylene group that may have an etheric oxygen atom or a divalent organopolysiloxane group, a carbon atom, a nitrogen atom, a silicon atom, an organopolysiloxane group having a valence of 2 to 8, and a group obtained by removing-Si(R²)ₙL₃₋ₙ (Group Q) from Formulas (3-1A), (3-1B), and (3-1A-1) to (3-1A-7) that will be described later, and a (p1+q1)-valent hydrocarbon group.

In a case where the terminal of Z¹ on the side bonded to A¹ is an alkylene group, the terminal of A¹ on the side bonded to Z¹ is not an alkylene group. Further, in a case where Z¹ is a polyalkylene oxide group, the terminal of A¹ on the side bonded to Z¹ is not an alkylene oxide group.

Further, A¹ may be Groups (g2-1) to (g2-14) that will be described later.

R², L, and n have been described above in the above Group Q.

p1 is an integer of 1 or more. From the viewpoint of more excellent fingerprint removal property of a surface treatment layer, p1 is preferably from 1 to 6, and is preferably from 1 to 4.

q1 is an integer of 1 or more. From the viewpoint of more excellent abrasion resistance of the surface treatment layer, q1 is preferably from 1 to 15, more preferably from 1 to 6, further preferably from 1 to 4, and particularly preferably 2 or 3.

A group represented by A¹(Si(R²)ₙL₃₋ₙ)_{q1} in Formula (1) is preferably a Group (3-1A) or a Group (3-1B), and more preferably a Group (3-1A).

-Q^{a}-X³¹(-Q^{b}-Si(R²)ₙL₃₋ₙ)ₕ(—R³¹)ᵢ (3-1A)

-Q^{c}-[CH₂C(R³²)(-Q^{d}-Si(R²)ₙL₃₋ₙ)]_{y}-R³³ (3-1B)

In Formulas (3-1A) and (3-1B), the definitions of R², L, and n are the same as those described above.

In Formula (3-1A), Q^{a} is a single bond or a divalent linking group.

Noe that, in a case where the terminal of Z¹ on the side bonded to A¹ is an alkylene group, the terminal of Q^{a} on the side bonded to Z¹ is not an alkylene group.

In a case where Z¹ is a polyalkylene oxide group, the terminal of Q^{a} on the side bonded to Z¹ is not an alkylene oxide group.

Specific examples of the divalent linking group include a divalent hydrocarbon group, a divalent heterocyclic group, —O—, —S—, —SO₂—, —N(R^{d})—, —C(O)—, —Si(R^{a})₂—, and a group obtained by combining the two or more kinds of groups of them.

The above divalent hydrocarbon group may be a divalent saturated hydrocarbon group, a divalent aromatic hydrocarbon group, an alkenylene group, or an alkynylene group. The divalent saturated hydrocarbon group may be linear, branched, or cyclic, and examples thereof include an alkylene group. The number of carbon atoms of the alkylene group is preferably from 1 to 30, more preferably from 1 to 20, further preferably from 4 to 20, and particularly preferably from 5 to 15. The divalent aromatic hydrocarbon group is preferably one having a number of carbon atoms from 5 to 20, and examples thereof include a phenylene group. The above divalent hydrocarbon group may instead be an alkenylene group having a number of carbon atoms from 2 to 20 and an alkynylene group having a number of carbon atoms from 2 to 20.

The R^{a} is an alkyl group (preferably having a number of carbon atoms from 1 to 10) or a phenyl group. The R^{d} is a hydrogen atom or an alkyl group (preferably having a number of carbon atoms from 1 to 10).

Examples of the group obtained by combining the two or more kinds of groups of them include —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, an alkylene group having —C(O)N(R^{d})—, an alkylene group having —N(R^{d})C(O)—, an alkylene group having —OC(O)N(R^{d})—, an alkylene group having an etheric oxygen atom, an alkylene group having —S—, an alkylene group having —OC(O)—, an alkylene group having —C(O)O—, an alkylene group having —C(O)S—, an alkylene group having —N(R^{d})—, an alkylene group having —N(R^{d})C(O)N(R^{d})—, an alkylene group having —SO₂N(R^{d})—, an alkylene group-Si(R^{a})₂-phenylene group-Si(R^{a})₂.

Among them, in a case where the terminal of Z¹ on the side bonded to A1 is an alkylene group, Q^{a} is preferably a divalent hydrocarbon group other than an alkylene group, a divalent heterocyclic group, —O—, —S—, —SO₂—, —N(R^{d})—, —C(O)—, —Si(R^{a})₂—, —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, an alkylene group having —C(O)N(R^{d})—, an alkylene group having —N(R^{d})C(O)—, an alkylene group having —OC(O)N(R^{d})—, an alkylene group having an etheric oxygen atom, an alkylene group having —S—, an alkylene group having —OC(O)—, an alkylene group having —C(O)O—, an alkylene group having —C(O)S—, an alkylene group having —N(R^{d})—, an alkylene group having —N(R^{d})C(O)N(R^{d})—, or an alkylene group having —SO₂N(R^{d})—, more preferably —OC(O)—, an alkylene group having —C(O)N(R^{d})—, an alkylene group having —OC(O)N(R^{d})—, an alkylene group having an etheric oxygen atom, an alkylene group having —S—, an alkylene group having —C(O)O—, an alkylene group having —C(O)S—, an alkylene group having —N(R^{d})—, or an alkylene group having —N(R^{d})C(O)N(R^{d})—, and further preferably an alkylene group having —C(O)O—, or an alkylene group having —C(O)N(R^{d})—.

In a case where Z¹ is a polyalkylene oxide group, Q^{a} is preferably a divalent hydrocarbon group, a divalent heterocyclic group, —SO₂—, —C(O)—, —Si(R^{a})₂—, —C(O)O—, —C(O)S—, —C(O)N(R^{d})—, —SO₂N(R^{d})—, an alkylene group having —C(O)N(R^{d})—, an alkylene group having —C(O)O—, an alkylene group having —SO₂N(R^{d})—, an alkylene group-Si(R^{a})₂-phenylene group-Si(R^{a})₂, and more preferably —C(O)—.

In Formula (3-1A), X³¹ a single bond, an alkylene group, a carbon atom, a nitrogen atom, a silicon atom, an organopolysiloxane group having a valence of 2 to 8, or a group having a (h+i+1)-valent ring.

In a case where the terminal of Z¹ on the side bonded to A1 is an alkylene group and Q^{a} is a single bond, the terminal of X³¹ on the side bonded to Z¹ is not an alkylene group.

In addition, in a case where Z¹ is a polyalkylene oxide group and Q^{a} is a single bond, the terminal of X³¹ on the side bonded to Z¹ is not a polyalkylene oxide group. In a case other than the above, the terminal of X³¹ may be an alkylene group or an alkylene oxide group.

The above alkylene group may have —O—, a silphenylene skeleton group, a divalent organopolysiloxane group, or a dialkylsilylene group. The alkylene group may have a plurality of groups selected from the group consisting of —O—, a silphenylene skeleton group, a divalent organopolysiloxane group, and a dialkylsilylene group.

The number of carbon atoms of the alkylene group represented by X³¹ is preferably from 1 to 20, and more preferably from 1 to 10.

Examples of the organopolysiloxane group having a valence of 2 to 8 include a divalent organopolysiloxane group, and a (w+1)-valent organopolysiloxane group described later.

In Formula (3-1A), when X³¹ is a group having a (h+i+1)-valent ring, Q^{a}, (-Q^{b}-Si(R²)ₙL₃₋ₙ) and R³¹ are directly bonded to atoms constituting this ring. However, this ring is a ring other than the organopolysiloxane ring.

The ring in X³¹ may be any of a monocyclic ring, a condensed polycyclic ring, a bridged ring, a spiro ring, and an assembled polycyclic ring, and the atoms constituting the ring may be a carbon ring consisting solely of carbon atoms or a heterocyclic ring consisting of heteroatoms having a valence of 2 or more and carbon atoms. Further, the bond between the atoms constituting the ring may be a single bond or multiple bonds. Further, the ring may be an aromatic ring or a non-aromatic ring.

The monocyclic ring is preferably a 4 to 8 membered ring, and more preferably a 5 membered ring and a 6 membered ring. The condensed polycyclic ring is preferably a condensed polycyclic ring in which two or more 4 to 8 membered rings are condensed, more preferably a condensed polycyclic ring in which two or three rings each selected from a 5 membered ring and a 6 membered ring are bonded, and still more preferably a condensed polycyclic ring in which one or two rings each selected from a 5 membered ring and a 6 membered ring and one 4 membered ring are bonded. The bridged ring is preferably a bridged ring in which a 5 membered ring or a 6 membered ring is the largest ring, and the spiro ring is preferably a spiro ring consisting of two 4 to 6 membered rings. The assembled polycyclic ring is preferably an assembled polycyclic ring in which two or three rings each selected from a 5 membered ring and a 6 membered ring are bonded through a single bond, through one to three carbon atoms, or through one heteroatom having a valence of two or three. Note that in the assembled polycyclic ring, one of Q^{a}, (-Q^{b}-Si(R²)ₙL₃₋ₙ), and R³¹ (when i=1 or more) is preferably bonded to each ring.

The heteroatoms constituting the aforementioned ring are preferably nitrogen atoms, oxygen atoms, and sulfur atoms, and more preferably nitrogen atoms and oxygen atoms. The number of heteroatoms constituting the ring is preferably three or smaller. Further, when the number of heteroatoms constituting the ring is two or more, these heteroatoms may be different from one another.

The ring in X³¹ is preferably one ring selected from the group consisting of a 3 to 8 membered aliphatic ring, a benzene ring, a 3 to 8 membered heterocyclic ring, a condensed ring in which two or three of these rings are condensed, a bridged ring in which a 5 membered ring or a 6 membered ring is the largest ring, and an assembled polycyclic ring having two or more of these rings in which an alkylene group having a number of carbon atoms of 3 or smaller of which the linking group is a single bond, an oxygen atom, or a sulfur atom in view of the ease of manufacturing of the compound and because the abrasion resistance of the surface treatment layer becomes more excellent.

Preferred rings are a benzene ring, a 5 or 6 membered aliphatic ring, a 5 or 6 membered heterocyclic ring having a nitrogen atom or an oxygen atom, and a condensed ring consisting of a 5 or 6 membered carbon ring and a 4 to 6 membered heterocyclic ring.

Specific examples of the ring include the below-shown rings, a 1,3-cyclohexadiene ring, a 1,4-cyclohexadiene ring, an anthracene ring, a cyclopropane ring, a decahydronaphthalene ring, a norbornene ring, a norbornadiene ring, a furan ring, a pyrrole ring, a thiophene ring, a pyrazine ring, a morpholine ring, an aziridine ring, an isoquinoline ring, an oxazole ring, an isoxazole ring, a thiazole ring, an imidazole ring, a pyrazole ring, a pyran ring, a pyridazine ring, a pyrimidine ring, and an indene ring. Note that rings having an oxo Group (═O) are also shown below.

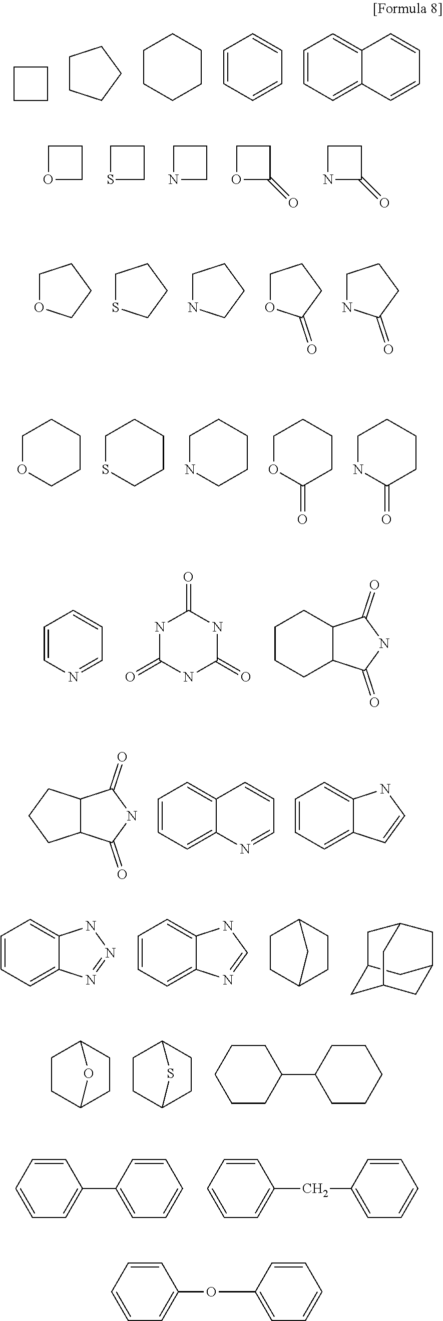

A bond that does not constitute a ring of atoms constituting the ring in X³¹ is a bond bonded to Q^{a}, (-Q^{b}-Si(R²)ₙL₃₋ₙ), or R³¹. When there are remaining bonds, the remaining bonds are bonded to a hydrogen atom or a substituent. Specific examples of the substituent include a halogen atom, an alkyl group (an etheric oxygen atom may be contained between carbon atoms), a cycloalkyl group, an alkenyl group, an allyl group, an alkoxy group, and an oxo group (═O).

Further, in a case where one of the carbon atoms constituting the ring has two bonds bonded to Q^{a}, (-Q^{b}-Si(R²)ₙL₃₋ₙ), or R³¹, Q^{a} and (-Q^{b}-Si(R²)ₙL₃₋ₙ) may be bonded to one of the carbon atoms, or two (-Q^{b}-Si(R²)ₙL₃₋ₙ) may be bonded to one of the carbon atoms. Q^{a}, and (-Q^{b}-Si(R²)ₙL₃₋ₙ) or R³¹ are preferably bonded to another ring-constituting atom. Each of h units of (-Q^{b}-Si(R²)ₙL₃₋ₙ) may be bonded to a separate ring-constituting atom, and two of them may be bonded to one ring-constituting carbon atom, and there may be two or more ring-constituting carbon atoms to which two units of (-Q^{b}-Si(R²)ₙL₃₋ₙ) are bonded. Each of i units of R³¹ may be bonded to a separate ring-constituting atom, two units of them may be bonded to one ring-constituting carbon atom, and further, there may be two or more ring-constituting carbon atoms to which two units of R³¹ are bonded.

Among them, X³¹ is preferably a carbon atom, a nitrogen atom, a silicon atom, an organopolysiloxane group having a valence of 4 to 8, or a group having a (h+i+1)-valent ring, and more preferably a carbon atom from the viewpoint of improving abrasion resistance of the surface treatment layer.

In Formula (3-1A), Q^{b} is a single bond or a divalent linking group.

The definition of the divalent linking group is the same as the definition described in Q^{a} described above.

In a case where the terminal of Z¹ on the side bonded to A1 is an alkylene group and Q^{a} and X³¹ have a single bond, the terminal of Q^{b} on the side bonded to Z¹ is not an alkylene group.

Further, in a case where Z¹ is a polyalkylene oxide group and Q^{a} and X³¹ have a single bond, the terminal of Q^{b} on the side bonded to Z¹ is not an alkylene oxide group. In a case other than the above, the terminal of Q^{b} may be an alkylene group or an alkylene oxide group.

Among them, Q^{b} is preferably an alkylene group which may have an etheric oxygen atom. The number of carbon atoms of the alkylene group is preferably from 1 to 30, more preferably from 1 to 20, further preferably from 2 to 20, and may be from 2 to 10, may be from 2 to 6, or may be from 2 to 5. The number of carbon atoms may be, for example, 2, 3, 8, 9, or 11. Further, the number of carbon atoms may be from 1 to 10.

In Formula (3-1A), R³¹ is a hydrogen atom, a hydroxyl group, or an alkyl group.

The number of carbon atoms of the alkyl group is preferably from 1 to 5, more preferably from 1 to 3, and further preferably 1.

When X³¹ is a single bond or an alkylene group, h is 1 and i is 0,
when X³¹ is a nitrogen atom, h is an integer from 1 to 2, i is an integer from 0 to 1, and h+i=2 is satisfied,
when X³¹ is a carbon atom or a silicon atom, h is an integer from 1 to 3, i is an integer from 0 to 2, and h+i=3 is satisfied,
when X³¹ is an organopolysiloxane group having a valence of 2 to 8, h is an integer from 1 to 7, i is an integer from 0 to 6, and h+i=1 to 7 is satisfied.

When X³¹ is a group having a (h+i+1)-valent ring, h is an integer from 1 to 7, i is an integer from 0 to 6, and h+i=1 to 7 is satisfied.

In a case where there are two or more units of (-Q^{b}-Si(R²)ₙL₃₋ₙ), two or more units of (-Q^{b}-Si(R²)ₙL₃₋ₙ) may be the same as each other or different from each other. In a case where there are two or more units of R³¹, two or more units of (—R³¹) may be the same as each other or different from each other.

Among them, i is preferably 0 from the viewpoint of improving abrasion resistance of the surface treatment layer.

In Formula (3-1A), in a case where Q^{a}, X³¹, and Q^{b} have a single bond, [Si(R²)ₙL₃₋ₙ] is directly bonded to Z¹, and Z¹ is an alkylene group.

In Formula (3-1), Q^{c} is a single bond or a divalent linking group.

However, in a case where the terminal of Z¹ on the side bonded to A¹ is an alkylene group, the terminal of Q^{c} on the side bonded to Z¹ is not an alkylene group.

In a case where Z¹ is a polyalkylene oxide group, the terminal of Q^{c} on the side bonded to Z¹ is not an alkylene oxide group.

The definition of the divalent linking group is the same as the definition described in Q^{a} described above.

In Formula (3-1B), R³² is a hydrogen atom or an alkyl group having a number of carbon atoms from 1 to 10, and is preferably a hydrogen atom from the viewpoint of the ease of manufacturing of the compound.

The alkyl group is preferably a methyl group.

In Formula (3-1B), Q^{d} is a single bond or an alkylene group. The number of carbon atoms of the alkylene group is preferably from 1 to 10, and more preferably from 1 to 6. Q^{d} is preferably a single bond or —CH₂— from the viewpoint of the ease of manufacturing of the compound.

In Formula (3-1B), R³³ is a hydrogen atom or a halogen atom, and is preferably a hydrogen atom from the viewpoint of the ease of manufacturing of the compound.

y is an integer from 1 to 10, and preferably an integer from 1 to 6.

The two or more units of [CH₂C(R³²)(-Q^{d}-Si(R²)ₙL₃₋ₙ)] may be the same as each other or different from each other.

The Group (3-1A) is preferably one of Groups (3-1A-1) to (3-1A-7).

—(X³²)ₛ₄-Q^{b1}-Si(R²)ₙL₃₋ₙ (3-1A-1)

—(X³³)ₛ₅-Q^{a2}-N[-Q^{b2}-Si(R²)ₙL₃₋ₙ]₂ (3-1A-2)

-Q^{a3}-Si(R^{g})[-Q^{b3}-Si(R²)ₙL₃₋ₙ]₂ (3-1A-3)

-[Q^{e}]ₛ₆-Q^{a4}-(O)ₜ₄—C[—(O)ᵤ₄-Q^{b4}-Si(R²)ₙL₃₋ₙ]_{3-w1}(—R³¹)_{w1} (3-1A-4)

-Q^{a5}-Si[-Q^{b5}-Si(R²)ₙL₃₋ₙ]₃ (3-1A-5)

-[Q^{e}]ᵥ-Q^{a6}-Z^{a}[-Q^{b6}-Si(R²)ₙL₃₋ₙ]_{w2} (3-1A-6)

[Q^{e}]ₛ₆-Q^{a4}-(O)ₜ₄—Z^{c}[—(O-Q^{b4})ᵤ₄-Si(R²)ₙL₃₋ₙ]_{w3}(—OH)_{w4} (3-1A-7)

Note that in Formulas (3-1A-1) to (3-1A-7), the definitions of R², L, and n are the same as those described above.

Note that, in a case where the terminal of Z¹ on the side bonded to A¹ is an alkylene group, the terminal of the Groups (3-1A-1) to (3-1A-7) on the side bonded to Z¹ is not an alkylene group.

In a case where Z¹ is a polyalkylene oxide group, the terminal of the Groups (3-1A-1) to (3-1A-7) on the side bonded to Z¹ is not an alkylene oxide group.

Among them, the Group (3-1A) is preferably a Group (3-1A-4).

In the Group (3-1A-1), X³² is —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})— (where N in the formula is bonded to Q^{b1}).

The definition of R^{d} is the same as that described above.

s4 is 0 or 1.

Among them, in a case where the terminal of Z¹ on the side bonded to A¹ is an alkylene group, X³² is preferably —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—, more preferably —O—, —S—, —N(R^{d})—, —C(O)O—, —C(O)S—, —N(R^{d})C(O)N(R^{d})—, —OC(O)N(R^{d})—, or —C(O)N(R^{d})—, and further preferably —C(O)O— or —C(O)N(R^{d})—.

In a case where Z¹ is a polyalkylene oxide group, X³² is preferably —C(O)O—, —C(O)S—, —SO₂N(R^{d})—, or —C(O)N(R^{d})—, and more preferably —C(O)—.

Q^{b1} is a single bond or an alkylene group. The alkylene group may have —O—, a silphenylene skeleton group, or a dialkylsilylene group. The alkylene group may have a plurality of groups selected from the group consisting of —O—, a silphenylene skeleton group, a divalent organopolysiloxane group, and a dialkylsilylene group.

When the alkylene group has —O—, a silphenylene skeleton group, a divalent organopolysiloxane group, or a dialkylsilylene group, it is preferable to have these groups between carbon atoms.

The number of carbon atoms of the alkylene group represented by Q^{b1} is preferably from 1 to 30, more preferably from 1 to 20, further preferably from 2 to 20, and particularly preferably from 2 to 6. Further, the number of carbon atoms may be from 1 to 10.

Among them, in a case where the terminal of Z¹ on the side bonded to A¹ is an alkylene group, s4 is preferably 1, and Q^{b1} is preferably an alkylene group having a number of carbon atoms from 2 to 6.

In a case where Z¹ is a polyalkylene oxide group, s4 is preferably 0, and Q^{b1} is preferably an alkylene group having a number of carbon atoms from 2 to 6.

In a case where the terminal of Z¹ on the side bonded to A¹ is an alkylene group, specific examples of the Group (3-1A-1) include the following groups. In the following formula, * represents a bonding position with Z¹.

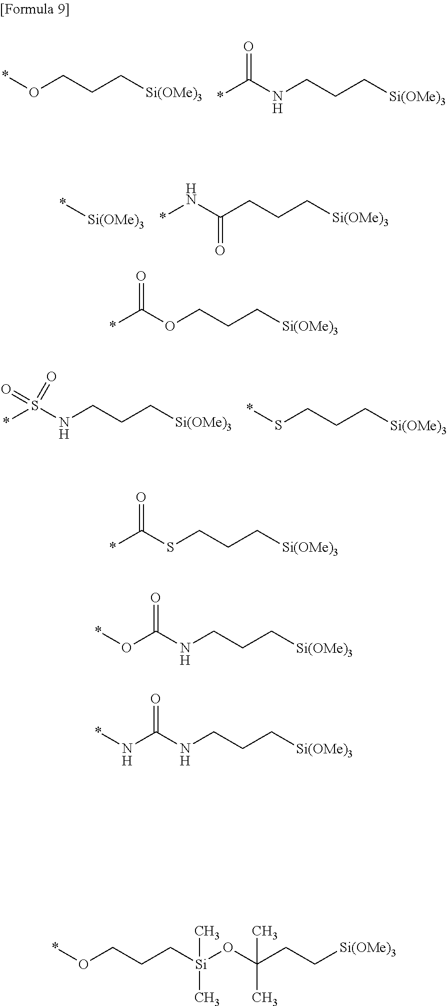

In a case where Z¹ is a polyalkylene oxide group, specific examples of the Group (3-1A-1) include the following groups. In the following formula, * represents a bonding position with Z¹.

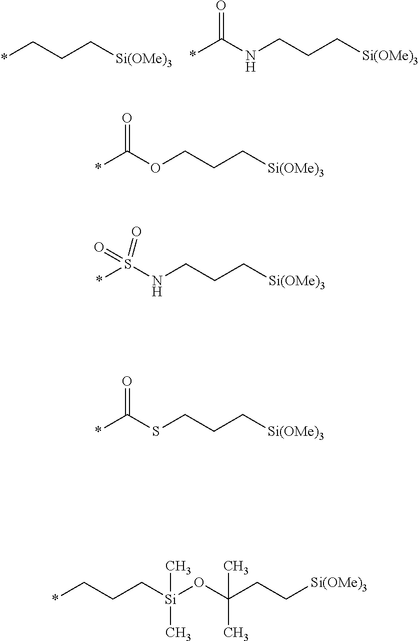

In the Group (3-1A-2), X³³ is —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—.

The definition of R^{d} is the same as that described above.

s5 is 0 or 1. s5 is preferably 0 from the viewpoint of the ease of manufacturing of the compound.

Among them, in a case where the terminal of Z¹ on the side bonded to A¹ is an alkylene group, X³³ is preferably —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—.

When Z¹ is a polyalkylene oxide group, X³³ is preferably —C(O)O—, —C(O)S—, —SO₂N(R^{d})—, or —C(O)N(R^{d})—.

Q^{a2} is a single bond, an alkylene group, —C(O)—, or a group having an etheric oxygen atom, —C(O)—, —C(O)O—, —OC(O)—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, —C(O)N(R^{d})—, or —NH— between carbon atoms of an alkylene group having a number of carbon atoms of 2 or more.

The number of carbon atoms of the alkylene group represented by Q^{a2} is preferably from 1 to 20, more preferably from 1 to 10, further preferably from 1 to 6, and particularly preferably from 1 to 3.

The number of carbon atoms of the group having an etheric oxygen atom, —C(O)—, —C(O)O—, —OC(O)—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, —C(O)N(R^{d})—, or —NH— between carbon atoms of an alkylene group having a number of carbon atoms of 2 or more represented by Q^{a2} is preferably from 2 to 10, and more preferably from 2 to 6.

Q^{a2} is preferably a single bond from the viewpoint of the ease of manufacturing of the compound.

Q^{b2} is an alkylene group, or a group having a divalent organopolysiloxane group, an etheric oxygen atom, or —NH— between carbon atoms of an alkylene group having a number of carbon atoms of 2 or more.

The number of carbon atoms of the alkylene group represented by Q^{b2} is preferably from 1 to 30, more preferably from 1 to 20, further preferably from 2 to 20, may be from 2 to 10, and may be from 2 to 6. The number of carbon atoms may be, for example, 2, 3, 8, 9, or 11. Further, the number of carbon atoms may be from 1 to 10.

The number of carbon atoms of the group having a divalent organopolysiloxane group or a group having an etheric oxygen atom or —NH-between carbon atoms of the alkylene group having a number of carbon atoms of 2 or more represented by Q^{b2} is preferably from 2 to 10, and more preferably from 2 to 6.

Q^{b2} is preferably —CH₂CH₂CH₂—, —CH₂CH₂OCH₂CH₂CH₂— from the viewpoint of the ease of manufacturing of the compound (note that the right side is bonded to Si).

Two units of [-Q^{b2}-Si(R²)ₙL₃₋ₙ] may be the same as each other or different from each other.

In a case where the terminal of Z¹ on the side bonded to A¹ is an alkylene group, specific examples of the Group (3-1A-2) include the following groups. In the following formula, * represents a bonding position with Z¹. Further, in the formula, α in (CH₂)_{α} that is bonded to Si(OMe)₃ is an integer indicating the number of methylene groups, is preferably from 1 to 30, more preferably from 1 to 20, further preferably from 2 to 20, may be from 2 to 10, and may be from 2 to 6. The number of carbon atoms may be, for example, 2, 3, 8, 9, or 11. Further, the number of carbon atoms may be from 1 to 10. A plurality of α contained in the same compound may be the same as each other or different from each other, and are preferably the same as each other. For example, the plurality of a contained in the same compound are all 2, 3, 8, 9, and 11. The same applies hereinafter.

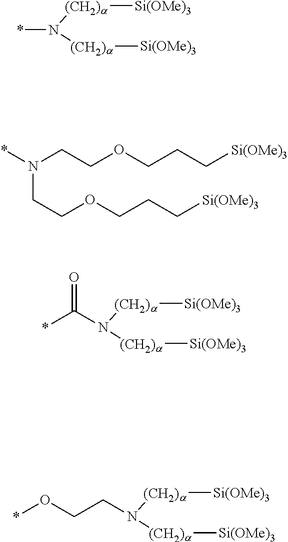

In a case where Z¹ is a polyalkylene oxide group, specific examples of the Group (3-1A-2) include the following groups. In the following formula, * represents a bonding position with Z¹.

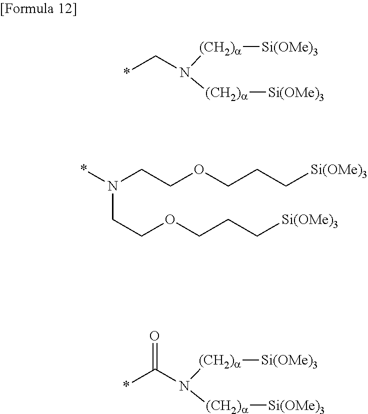

In the Group (3-1A-3), Q^{a3} is a single bond or an alkylene group which may have an etheric oxygen atom. From the viewpoint of the ease of manufacturing of the compound, Q^{a3} is preferably a single bond.

The number of carbon atoms of the alkylene group which may have an etheric oxygen atom is preferably from 1 to 10, and particularly preferably from 2 to 6.

R^{g} is a hydrogen atom, a hydroxyl group, or an alkyl group.

R^{g} is preferably a hydrogen atom or an alkyl group from the viewpoint of the ease of manufacturing of the compound. The number of carbon atoms of the alkyl group is preferably from 1 to 10, more preferably from 1 to 4, and further preferably a methyl group.

Q^{b3} is an alkylene group, or a group having an etheric oxygen atom or a divalent organopolysiloxane group between carbon atoms of the alkylene group having a number of carbon atoms of 2 or more.

The number of carbon atoms of the alkylene group represented by Q^{b3} is preferably from 1 to 30, more preferably from 1 to 20, further preferably from 2 to 20, may be from 2 to 10, and may be from 2 to 6. The number of carbon atoms may be, for example, 2, 3, 8, 9, or 11. Further, the number of carbon atoms may be from 1 to 10.

The number of carbon atoms of the group having an etheric oxygen atom or a divalent organopolysiloxane group between carbon atoms of the alkylene group having a number of carbon atoms of 2 or more represented by Q^{b3} is preferably from 2 to 20, more preferably from 2 to 10, and further preferably from 2 to 6.

Q^{b3} is preferably —CH₂CH₂—, —CH₂CH₂CH₂—, or —CH₂CH₂CH₂CH₂CH₂CH₂CH₂CH₂— from the viewpoint of the ease of manufacturing of the compound.

Two units of [-Q^{b3}-Si(R²)ₙL₃₋ₙ] may be the same as each other or different from each other.

In a case where the terminal of Z¹ on the side bonded to A¹ is an alkylene group, specific examples of the Group (3-1A-3) include the following groups. In the following formula, * represents a bonding position with Z¹.

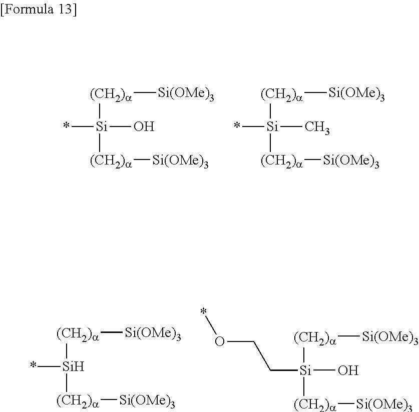

In a case where Z¹ is a polyalkylene oxide group, specific examples of the Group (3-1A-3) include the following groups. In the following formula, * represents a bonding position with Z¹.

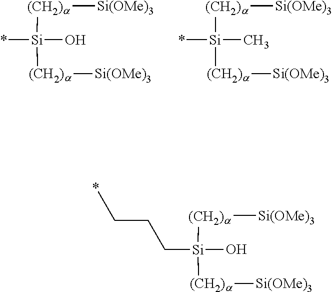

In the Group (3-1A-4), Q^{e} is —C(O)O—, —SO₂N(R^{d})—, —N(R^{d})SO₂—, —N(R^{d})C(O)—, or —C(O)N(R^{d})—.

The definition of R³¹ is the same as that described above. When w1 is 1 or 2, R³¹ is preferably a hydrogen atom.

s6 is 0 or 1.

Q^{a4} is a single bond, or an alkylene group which may have an etheric oxygen atom.

The number of carbon atoms of the alkylene group which may have an etheric oxygen atom is preferably from 1 to 20, more preferably from 1 to 10, further preferably from 1 to 6, and particularly preferably from 1 to 3.

t4 is 0 or 1 (when Q^{a4} is a single bond, t4 is 0).

As -Q^{a4}-(O)ₜ₄—, in a case where s6 is 0, a single bond, —CH₂O—, —CH₂OCH₂—, —CH₂OCH₂CH₂O—, —CH₂OCH₂CH₂OCH₂—, or —CH₂OCH₂CH₂CH₂CH₂OCH₂— is preferable, and in a case where s6 is 1, a single bond, —CH₂—, or —CH₂CH₂— is preferable from the viewpoint of the ease of manufacturing of the compound.

Q^{b4} is an alkylene group, and the alkylene group may have —O—, —C(O)N(R^{d})— (the definition of R^{d} is the same as that described above), a silphenylene skeleton group, a divalent organopolysiloxane group, or a dialkylsilylene group.

When the alkylene group has —O— or a silphenylene skeleton group, the alkylene group preferably has —O— or a silphenylene skeleton group between carbon atoms. When the alkylene group has —C(O)N(R^{d})—, a dialkylsilylene group, or a divalent organopolysiloxane group, it is preferable to have these groups between carbon atoms or at the terminal on the side which is bonded to (O)ᵤ₄.

The number of carbon atoms of the alkylene group represented by Q^{b4} is preferably from 1 to 30, more preferably from 1 to 20, further preferably from 2 to 20, may be from 2 to 10, and may be from 2 to 6. The number of carbon atoms may be, for example, 2, 3, 8, 9, or 11. Further, the number of carbon atoms may be from 1 to 10.

u4 is 0 or 1.

As —(O)ᵤ₄-Q^{b4}-, —CH₂CH₂—, —CH₂CH₂CH₂—, —CH₂OCH₂CH₂CH₂—, —CH₂OCH₂CH₂CH₂CH₂CH₂—, —OCH₂CH₂CH₂—, —OSi(CH₃)₂CH₂CH₂CH₂—, —OSi(CH₃)₂OSi(CH₃)₂CH₂CH₂CH₂—, and —CH₂CH₂CH₂Si(CH₃)₂PhSi(CH₃)₂CH₂CH₂— are preferable (note that the right side is bonded to Si).

w1 is an integer from 0 to 2, preferably 0 or 1, and particularly preferably 0.

In a case where there are two or more units of [—(O)ᵤ₄-Q^{b4}-Si(R²)ₙL₃₋ₙ], two or more units of [—(O)ᵤ₄-Q^{b4}-Si(R²)ₙL₃₋ₙ] may be the same as each other or different from each other.

In a case where there are two or more units of R³¹, two or more units of (—R³¹) may be the same as each other or different from each other.

In a case where the terminal of Z¹ on the side bonded to A¹ is an alkylene group, specific examples of the Group (3-1A-4) include the following groups. In the following formula, * represents a bonding position with Z¹.

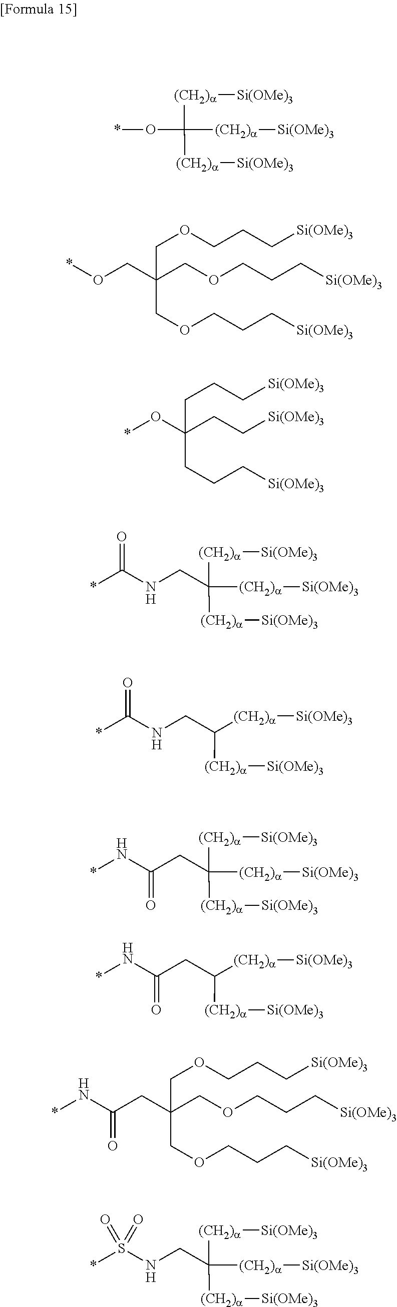

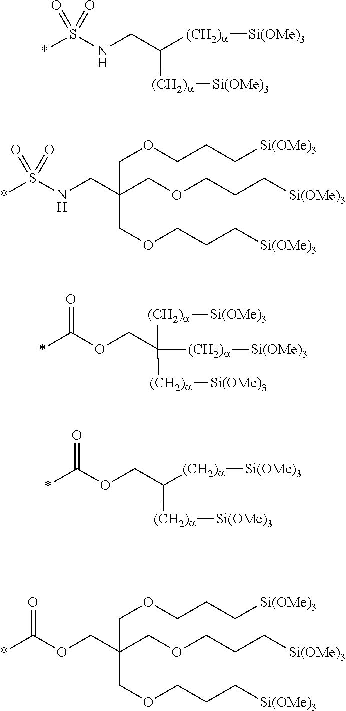

In a case where Z¹ is a polyalkylene oxide group, specific examples of the Group (3-1A-4) include the following groups. In the following formula, * represents a bonding position with Z¹.

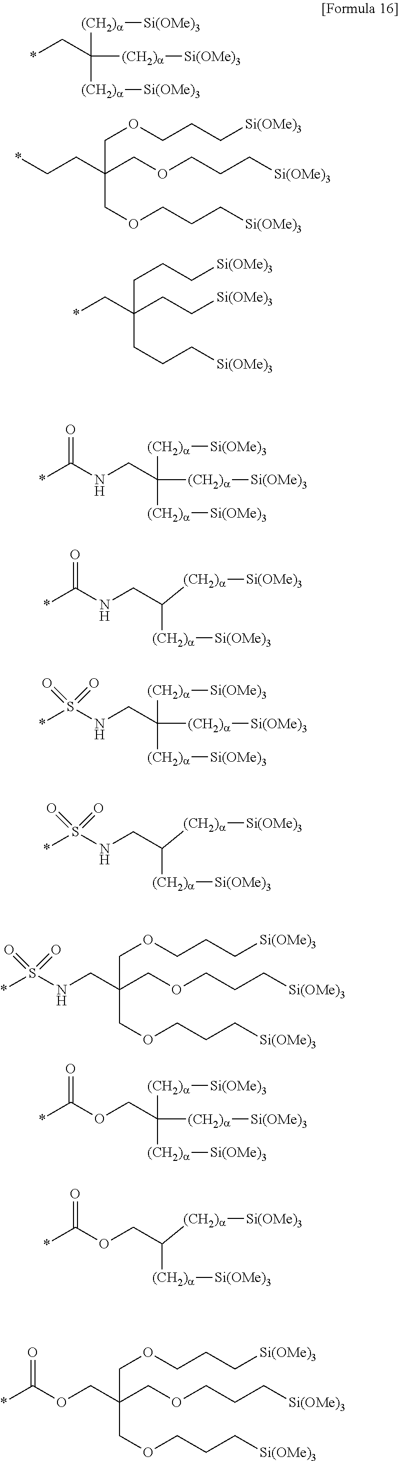

In the Group (3-1A-5), Q⁵ is an alkylene group which may have an etheric oxygen atom.

The number of carbon atoms of the alkylene group which may have an etheric oxygen atom is preferably from 1 to 10, and particularly preferably from 2 to 6.

As Q^{a5}, from the viewpoint of the ease of manufacturing of the compound, —OCH₂CH₂CH₂—, —OCH₂CH₂OCH₂CH₂CH₂—, —CH₂CH₂—, and —CH₂CH₂CH₂— are preferable (note that the right side is bonded to Si).

Q^{b5} is an alkylene group, or a group having an etheric oxygen atom or a divalent organopolysiloxane group between carbon atoms of the alkylene group having a number of carbon atoms of 2 or more.

The number of carbon atoms of the alkylene group represented by Q^{b5} is preferably from 1 to 30, more preferably from 1 to 20, further preferably from 2 to 20, may be from 2 to 10, and may be from 2 to 6. The number of carbon atoms may be, for example, 2, 3, 8, 9, or 11. Further, the number of carbon atoms may be from 1 to 10.

The number of carbon atoms of the group having an etheric oxygen atom or a divalent organopolysiloxane group between carbon atoms of the alkylene group having a number of carbon atoms of 2 or more represented by Q^{b5} is preferably from 2 to 20, more preferably from 2 to 10, and further preferably from 2 to 6.

Q^{b5} is preferably —CH₂CH₂CH₂— or —CH₂CH₂OCH₂CH₂CH₂— from the viewpoint of the ease of manufacturing of the compound (note that the right side is bonded to Si(R¹)ₙL₃₋ₙ).

Three units of [-Q^{b5}-Si(R²)ₙL₃₋ₙ] may be the same as each other or different from each other.

In a case where the terminal of Z¹ on the side bonded to A¹ is an alkylene group, specific examples of the Group (3-1A-5) include the following groups. In the following formula, * represents a bonding position with Z¹.

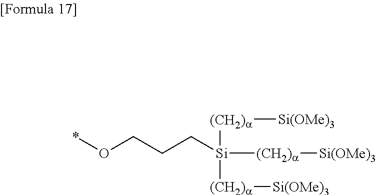

In a case where Z¹ is a polyalkylene oxide group, specific examples of the Group (3-1A-5) include the following groups. In the following formula, * represents a bonding position with Z¹.

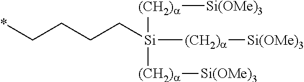

The definition of Q^{e} in Group (3-1A-6) is as defined in the above Group (3-1A-4).

v is 0 or 1.

Q^{a6} is an alkylene group which may have an etheric oxygen atom.

The number of carbon atoms of the alkylene group which may have an etheric oxygen atom is preferably from 1 to 10, and particularly preferably from 2 to 6.

Q^{a6} is preferably —CH₂OCH₂CH₂CH₂—, —CH₂OCH₂CH₂OCH₂CH₂CH₂—, —CH₂CH₂—, or —CH₂CH₂CH₂— from the viewpoint of ease of manufacturing of the compound (note that the right side is bonded to Z^{a}).

Z^{a} is a (w2+1)-valent organopolysiloxane group or a (w2+1)-valent group having an alkylene group between the organopolysiloxane group and the organopolysiloxane group.

w2 is an integer from 2 to 7.

Examples of the (w2+1)-valent organopolysiloxane group and the (w2+1)-valent group having an alkylene group between the organopolysiloxane group and the organopolysiloxane group include the following groups. However, R^{a} in the following formula is as described above. * represents a bonding position.

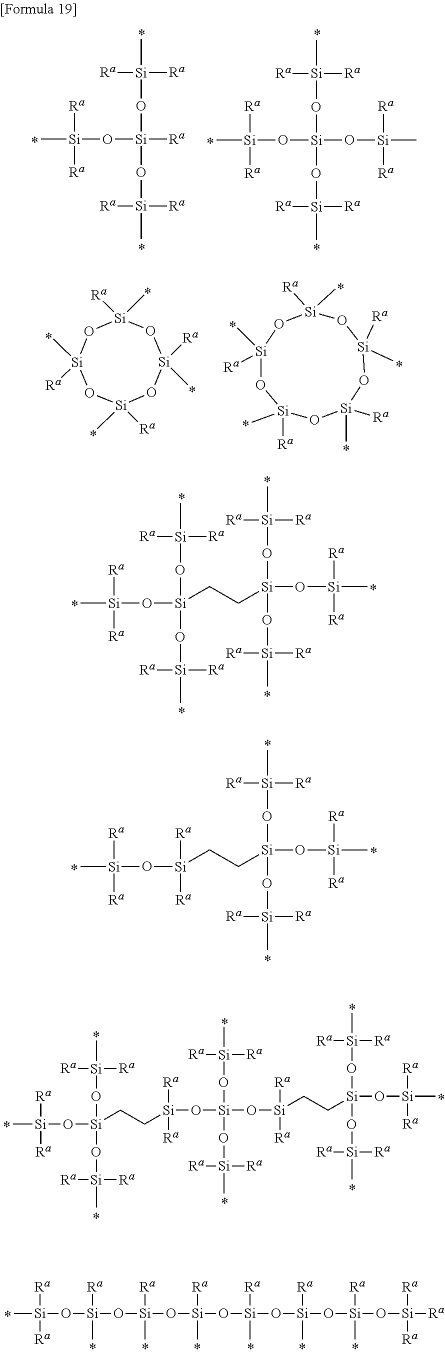

Q^{b6} is an alkylene group, or a group having an etheric oxygen atom or a divalent organopolysiloxane group between carbon atoms of the alkylene group having a number of carbon atoms of 2 or more.

The number of carbon atoms of the alkylene group represented by Q^{b6} is preferably from 1 to 30, more preferably from 1 to 20, further preferably from 2 to 20, may be from 2 to 10, and may be from 2 to 6. The number of carbon atoms may be, for example, 2, 3, 8, 9, or 11. Further, the number of carbon atoms may be from 1 to 10.

The number of carbon atoms of the group having an etheric oxygen atom or a divalent organopolysiloxane group between carbon atoms of the alkylene group having a number of carbon atoms of 2 or more represented by Q^{b6} is preferably from 2 to 20, more preferably from 2 to 10, and further preferably from 2 to 6.

Q^{b6} is preferably —CH₂CH₂— or —CH₂CH₂CH₂— from the viewpoint of the ease of manufacturing of the compound.

w2 units of [-Q^{b6}-Si(R²)ₙL₃₋ₙ] may be the same as each other or different from each other.

Specific examples of the Group (3-1A-6) include the following groups. In the following formula, * represents a bonding position with Z¹.

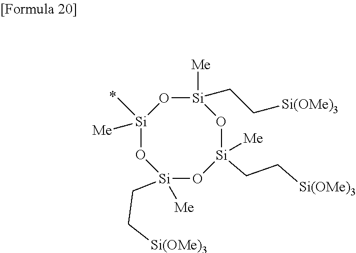

In the Group (3-1A-7), Z^{c} is a (w3+w4+1)-valent hydrocarbon group.

w3 is an integer of 4 or more.

w4 is an integer of 0 or more.

The definitions and preferred ranges of Q^{e}, s6, Q^{a4}, t4, Q^{b4}, and u4 are the same as the definitions of the respective reference symbols in the Group (3-1A-4).

Z^{c} may consist of a hydrocarbon chain, may have an etheric oxygen atom between carbon atoms of a hydrocarbon chain, and preferably consists of a hydrocarbon chain.

The valence of Z^{c} is preferably from 5 to 20, more preferably from 5 to 10, still more preferably from 5 to 8, and particularly preferably from 5 to 6.

The number of carbon atoms of Z^{c} is preferably from 3 to 50, more preferably from 4 to 40, and further preferably from 5 to 30.

w3 is preferably from 4 to 20, more preferably from 4 to 16, further preferably from 4 to 8, and particularly preferably from 4 to 5.

w4 is preferably from 0 to 10, more preferably from 0 to 8, further preferably from 0 to 6, particularly preferably from 0 to 3, and most preferably from 0 to 1.

In a case where there are two or more units of [—(O-Q^{b4})ᵤ₄-Si(R²)ₙL₃₋ₙ], the two or more units of [—(O-Q^{b4})ᵤ₄-Si(R²)ₙL₃₋ₙ] may be the same as each other or different from each other.

In a case where the terminal of Z¹ on the side of A¹ is an alkylene group, specific examples of the Group (3-1A-7) include the following groups. In the following formula, * represents a bonding position with Z¹.

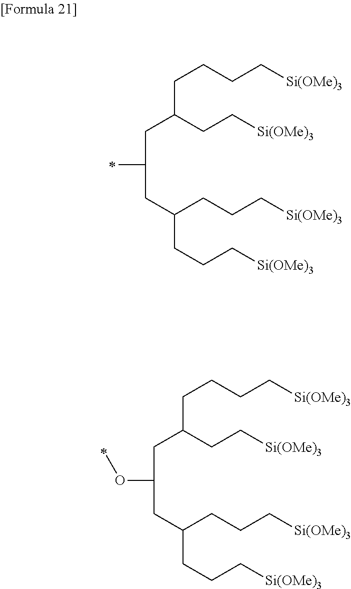

In a case where the terminal of Z¹ on the side of A¹ is a polyalkylene oxide group, specific examples of the Group (3-1A-7) include the following groups. In the following formula, * represents a bonding position with Z¹.

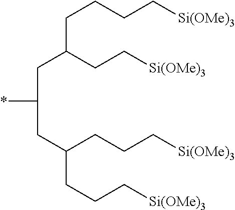

A¹ may be a Group (g2-1) (where j1=d1+d3, g1=d2+d4), a Group (g2-2) (where j1=e1, g1=e2), a Group (g2-3) (where j1=1, g1=2), a Group (g2-4) (where j1=h1, g1=h2), a Group (g2-5) (where j1=i1, g1=i2), a Group (g2-6) (where j1=1, g1=1), or a Group (g2-7) (where j1=1, g1=i3).

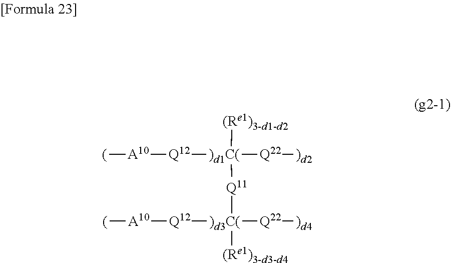

(-A¹⁰-Q¹²-)ₑ₁C(R^{e2})₄₋ₑ₁₋ₑ₂(-Q²²-)ₑ₂ (g2-2)

-A¹⁰-Q¹³-N(-Q²³-)₂ (g2-3)

(-A¹⁰-Q¹⁴-)ₕ₁Z(-Q²⁴-)ₕ₂ (g2-4)

(-A¹⁰-Q¹⁵-)ᵢ₁Si(R^{e3})₄₋ᵢ₁₋ᵢ₂(-Q²⁵-)ᵢ₂ (g2-5)

-A¹⁰-Q²⁶- (g2-6)

-A¹⁰-Q¹²-CH(-Q²²-)—Si(R^{e3})₃₋ᵢ₃(-Q²⁵-)ᵢ₃ (g2-7)

Note that in Formulas (g2-1) to (g2-7), the A¹⁰ side is bonded to Z¹, and the Q²², Q²³, Q²⁴, Q²⁵ or Q²⁶ side is bonded to [—Si(R²)ₙL₃₋ₙ].

In a case where the terminal of Z¹ on the side bonded to A¹⁰ is an alkylene group, the terminal of A¹⁰ on the side bonded to Z¹ is not an alkylene group.

In a case where Z¹ is a polyalkylene oxide group, the terminal of A¹ on the side bonded to Z¹ is not an alkylene oxide group.

A¹⁰ is a single bond, —C(O)NR¹⁶—, —C(O)—, —OC(O)O—, —NHC(O)O—, —NHC(O)NR¹⁶—, —O—, or —SO₂NR¹⁶—.

Q¹¹ is a single bond, —O—, an alkylene group, or a group having —C(O)NR¹⁶—, —C(O)—, —NR¹⁶—, or —O— between carbon atoms of an alkylene group having a number of carbon atoms of 2 or more.

Q¹² is a single bond, an alkylene group, or a group having —C(O)NR¹⁶—, —C(O)—, —NR¹⁶—, or —O— between carbon atoms of an alkylene group having a number of carbon atoms of 2 or more, and when A¹ has two or more units of Q¹², two or more units of Q¹² may be the same as each other or different from each other.

Q¹³ is a single bond (where A¹⁰ is —C(O)—), an alkylene group, a group having —C(O)NR¹⁶—, —C(O)—, —NR¹⁶—, or —O— between carbon atoms of an alkylene group having a number of carbon atoms of 2 or more, or a group having —C(O)— at an N-side terminal of an alkylene group.

Q¹⁴ is Q¹² when the atom in Z to which Q¹⁴ is bonded is a carbon atom, Q¹⁴ is Q¹³ when the atom in Z to which Q¹⁴ is bonded is a nitrogen atom, and when A¹ has two or more units of Q¹⁴, two or more units of Q¹⁴ may be the same as each other or different from each other.

Q¹⁵ is an alkylene group, or a group having —C(O)NR¹⁶—, —C(O)—, —NR¹⁶—, or —O— between carbon atoms of an alkylene group having a number of carbon atoms of 2 or more, and when A¹ has two or more units of Q¹⁵, two or more units of Q⁵ may be the same as each other or different from each other.

Q²² is an alkylene group, a group having —C(O)NR¹⁶—, —C(O)—, —NR¹⁶—, or —O— between carbon atoms of an alkylene group having a number of carbon atoms of 2 or more, a group having —C(O)NR¹⁶—, —C(O)—, —NR¹⁶—, or —O— at a terminal of the alkylene group on a side which is not connected to Si, or a group having —C(O)NR¹⁶—, —C(O)—, —NR¹⁶—, or —O— between carbon atoms of an alkylene group having a number of carbon atoms of 2 or more and having —C(O)NR¹⁶—. —C(O)—, —NR¹⁶—, or —O— at a terminal on a side which is not connected to Si, and when A¹ has two or more units of Q²², two or more units of Q²² may be the same as each other or different from each other.

Q²³ is an alkylene group, or a group having —C(O)NR¹⁶—, —C(O)—, —NR¹⁶—, or —O— between carbon atoms of an alkylene group having a number of carbon atoms of 2 or more, and two units of Q²³ may be the same as each other or different from each other.

Q²⁴ is Q²² when the atom in Z to which Q²⁴ is bonded is a carbon atom, Q²³ when the atom in Z to which Q²⁴ is bonded is a nitrogen atom, and when A¹ has two or more units of Q²⁴, two or more units of Q²⁴ may be the same as each other or different from each other.

Q²⁵ is an alkylene group, or a group having —C(O)NR¹⁶—, —C(O)—, —NR¹⁶—, or —O— between carbon atoms of an alkylene group having a number of carbon atoms of 2 or more, and when A¹ has two or more units of Q²⁵, two or more units of Q²⁵ may be the same as each other or different from each other.

Q²⁶ is an alkylene group, or a group having —C(O)NR¹⁶—, —C(O)—, —NR¹⁶—, or —O— between carbon atoms of an alkylene group having a number of carbon atoms of 2 or more.

In a case where Q²², Q²³, Q²⁴, Q²⁵, and Q²⁶ are alkylene groups, the number of carbon atoms is preferably from 1 to 20, more preferably from 1 to 10, and further preferably from 1 to 6.

Z is a group having a (h1+h2)-valent ring structure having a carbon atom or a nitrogen atom to which Q¹⁴ is directly bonded and having a carbon atom or a nitrogen atom to which Q²⁴ is directly bonded.

R^{e1} is a hydrogen atom or an alkyl group, and when A¹ has two or more units of R^{e1}, two or more units of R^{e1} may be the same as each other or different from each other.

R^{e2} is a hydrogen atom, a hydroxyl group, an alkyl group, or an acyloxy group.

R^{e3} is an alkyl group. R¹⁶ is a hydrogen atom, an alkyl group having a number of carbon atoms from 1 to 6, or a phenyl group.

d1 is an integer from 0 to 3, and preferably 1 or 2.

d2 is an integer from 0 to 3, and preferably 1 or 2.

d1+d2 is an integer from 1 to 3.

d3 is an integer from 0 to 3, and preferably 0 or 1.

d4 is an integer from 0 to 3, and preferably 2 or 3.

d3+d4 is an integer from 1 to 3.

d1+d3 is an integer from 1 to 5, and preferably 1 or 2.

d2+d4 is an integer from 1 to 5, and preferably 4 or 5.

e1+e2 is 3 or 4.

e1 is an integer from 1 to 3, and preferably 1 or 2.

e2 is an integer from 1 to 3, and preferably 2 or 3.

h1 is an integer of 1 or more, and preferably 1 or 2.

h2 is an integer of 1 or more, and preferably 2 or 3.

i1+i2 is 3 or 4.

i1 is an integer from 1 to 3, and preferably 1 or 2.

i2 is an integer from 1 to 3, and preferably 2 or 3.

i3 is 2 or 3.

The number of carbon atoms of the alkylene groups of Q¹¹, Q¹², Q¹³, Q¹⁴, Q⁵, Q²², Q²³, Q²⁴, Q²⁵, and Q²⁶ are preferably from 1 to 30, more preferably from 1 to 20, further preferably from 2 to 20, may be from 2 to 10, and may be from 2 to 6 from the viewpoint of the ease of manufacturing of the compound and because the abrasion resistance of the surface treatment layer becomes more excellent. The number of carbon atoms may be, for example, 2, 3, 8, 9, and 11. The number of carbon atoms may be from 1 to 10, from 1 to 6, or from 1 to 4. However, when the alkylene group has a specific bond between carbon atoms, the lower limit value of its number of carbon atoms is 2.

Examples of the ring structure in Z include the ring structures described above, and preferred forms are also the same. Q¹⁴ and Q²⁴ are directly bonded to the ring structure in Z, and thus, for example, there is no such a case where an alkylene group is linked to the ring structure and Q¹⁴ and Q²⁴ are linked to the alkylene group.

The number of carbon atoms of the alkyl group of R^{c1}, R^{e2}, or R^{e3} is preferably from 1 to 6, more preferably from 1 to 3, and particularly preferably from 1 to 2 from the viewpoint of the ease of manufacturing of the compound.

The number of carbon atoms of the alkyl group moiety of the acyloxy group of R^{e2} is preferably from 1 to 6, more preferably from 1 to 3, and particularly preferably from 1 to 2 from the viewpoint of the ease of manufacturing of the compound.

h1 is preferably from 1 to 6, more preferably from 1 to 4, further preferably 1 or 2, and particularly preferably 1 from the viewpoint of the ease of manufacturing of the compound and because the abrasion resistance of the surface treatment layer becomes more excellent.

h2 is preferably from 2 to 6, more preferably from 2 to 4, and particularly preferably 2 or 3 from the viewpoint of the ease of manufacturing of the compound and because the abrasion resistance of the surface treatment layer becomes more excellent.

Other forms of A¹ include a Group (g2-8) (where j1=d1+d3, g1=d2×k3+d4×k3), a Group (g2-9) (where j1=e1, g1=e2×k3), a Group (g2-10) (where j1=1, g1=2×k3), a Group (g2-11) (where j1=h1, g1=h2×k3), a Group (g2-12) (where j1=i1, g1=i2×k3), a Group (g2-13) (where j1=1, g1=k3), or a Group (g2-14) (where j1=1, g1=i3×k3).

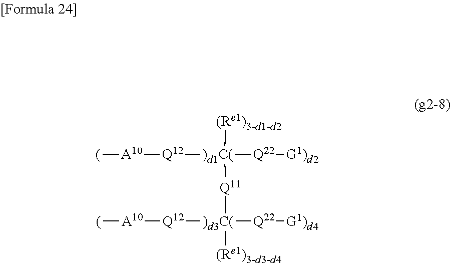

(-A¹⁰-Q¹²-)ₑ₁C(R^{e2})₄₋ₑ₁₋ₑ₂(-Q²²-G¹)ₑ₂ (g2-9)

-A¹⁰-Q¹³-N(-Q²³-G¹)₂ (g2-10)

(-A¹⁰-Q¹⁴-)ₕ₁Z(-Q²⁴-G¹)ₕ₂ (g2-11)

(-A¹⁰-Q¹⁵-)ᵢ₁Si(R^{e3})₄₋ᵢ₁₋ᵢ₂(-Q²⁵-G¹)ᵢ₂ (g2-12)

-A¹⁰-Q²⁶-G¹ (g2-13)

-A¹⁰-Q¹²-CH(-Q²²-G¹)-Si(R^{e3})₃₋ᵢ₃(-Q²⁵-G¹)ᵢ₃ (g2-14)

In Formulas (g2-8) to (g2-14), the A¹⁰ side is bonded to Z¹ and the G¹ side is bonded to [—Si(R²)ₙL₃₋ₙ].

In a case where the terminal of Z¹ on the side bonded to A¹⁰ is an alkylene group, the terminal of A¹⁰ on the side bonded to Z¹ is not an alkylene group.

In a case where Z¹ is a polyalkylene oxide group, the terminal of A¹⁰ on the side bonded to Z¹ is not an alkylene oxide group.

G¹ is the following Group (g3), and two or more units of G¹ of A¹ may be the same as each other or different from each other. The reference symbols other than G¹ are the same as the reference symbols in Formulas (g2-1) to (g2-7):

—Si(R⁸)₃₋ₖ₃(-Q³-)ₖ₃ (g3)
where in the Group (g3), the Si side is connected to Q²², Q²³, Q²⁴, Q²⁵, and Q²⁶, and the Q³ side is connected to [—Si(R²)ₙL₃₋ₙ]. R⁸ is an alkyl group. Q³ is an alkylene group, a group having —C(O)NR¹⁶—, —C(O)—, —NR¹⁶—, or —O— between carbon atoms of an alkylene group having a number of carbon atoms of 2 or more, or (OSi(R⁹)₂)ₚ—O—, and two or more units of Q³ may be the same as each other or different from each other. k3 is 2 or 3. R¹⁶ is a hydrogen atom, an alkyl group having a number of carbon atoms from 1 to 6, or a phenyl group. R⁹ is an alkyl group, a phenyl group, or an alkoxy group, and two units of R⁹ may be the same as each other or different from each other. p is an integer from 0 to 5, and when p is 2 or more, 2 or more (OSi(R⁹)₂) may be the same as each other or different from each other.

The number of carbon atoms of the alkylene group of Q³ is preferably from 1 to 30, more preferably from 1 to 20, further preferably from 2 to 20, may be from 2 to 10, or may be from 2 to 6 from the viewpoint of the ease of manufacturing of the compound and because the abrasion resistance of the surface treatment layer becomes more excellent. The number of carbon atoms may be, for example, 2, 3, 8, 9, or 11. Further, the number of carbon atoms may be from 1 to 10, may be from 1 to 6, or may be from 1 to 4. However, when the alkylene group has a specific bond between carbon atoms, the lower limit value of its number of carbon atoms is 2.

The number of carbon atoms of the alkyl group of R⁸ is preferably from 1 to 6, more preferably from 1 to 3, and further preferably from 1 to 2 from the viewpoint of the ease of manufacturing of the compound.

The number of carbon atoms of the alkyl group of R⁹ is preferably from 1 to 6, more preferably from 1 to 3, and further preferably from 1 to 2 from the viewpoint of the ease of manufacturing of the compound.

The number of carbon atoms of the alkoxy group of R⁹ is preferably from 1 to 6, more preferably from 1 to 3, and particularly preferably from 1 to 2 from the viewpoint of more excellent storage stability of the compound.

p is preferably from 0 or 1.

Examples of the compound according to the present disclosure include a compound of the following Formula. The compound of the following formula is preferable from the viewpoint of easy industrial production, easy handling, and being further excellent in fingerprint removal property and abrasion resistance of the surface treatment layer. R^{t} in the compound of the following formula is the same as [R¹¹-M¹(R¹)₂-(Q)ᵣ₁-Z¹] in Formula (1), and a preferable form is also the same.

In a case where the terminal of Z¹ on the side bonded to A¹ is an alkylene group, examples of the compound in which A¹ in Formula (1) is a Group (g2-1) include a compound of the following Formula.

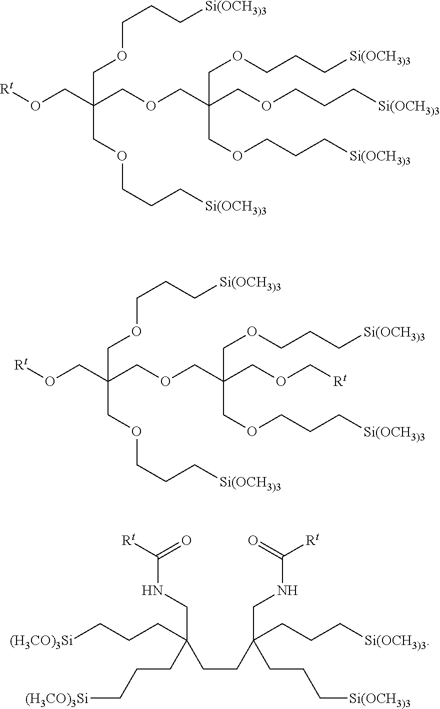

In a case where Z¹ is a polyalkylene oxide group, examples of the compound in which A¹ in Formula (1) is a Group (g2-1) include a compound of the following Formula.

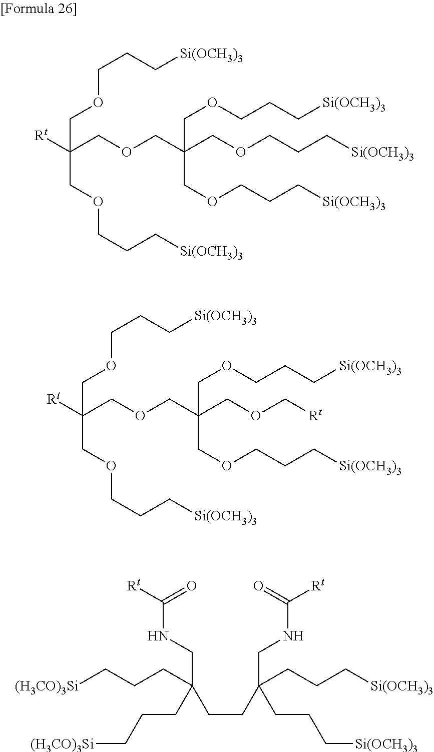

In a case where the terminal of Z¹ on the side bonded to A¹ is an alkylene group, examples of the compound in which A¹ in Formula (1) is a Group (g2-2) include a compound of the following Formula. In the following formula, Ak means an alkyl group (e.g., an alkyl group having a number of carbon atoms from 1 to 15).

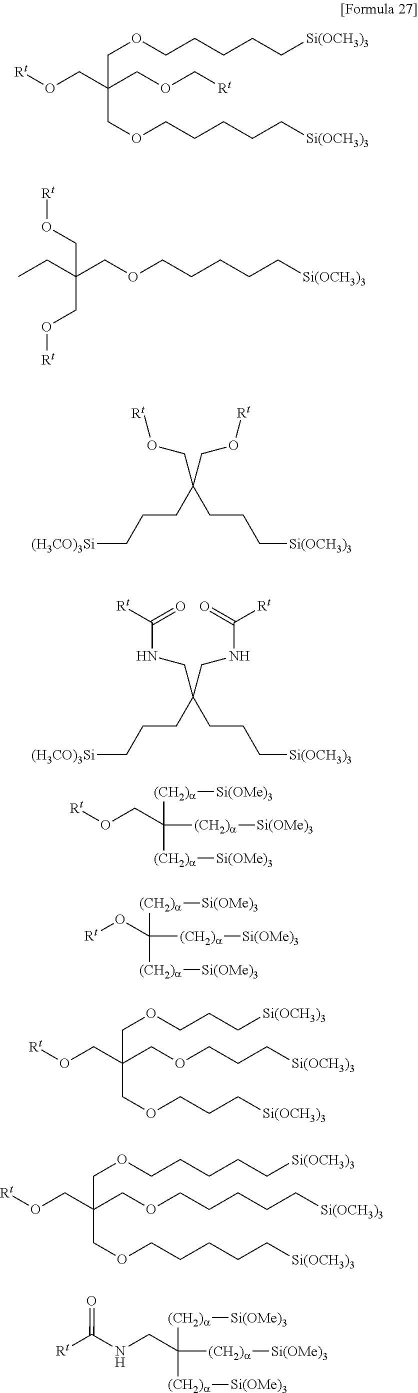

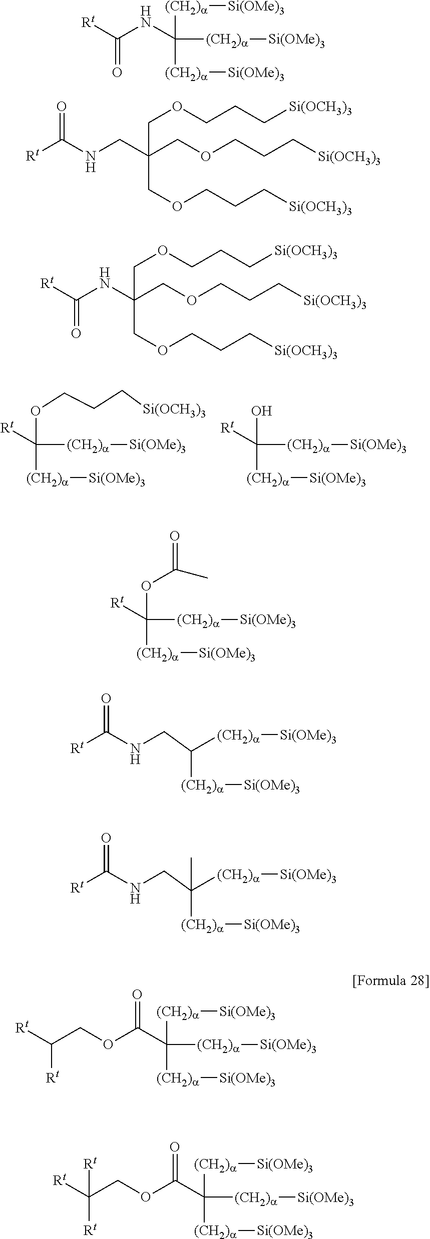

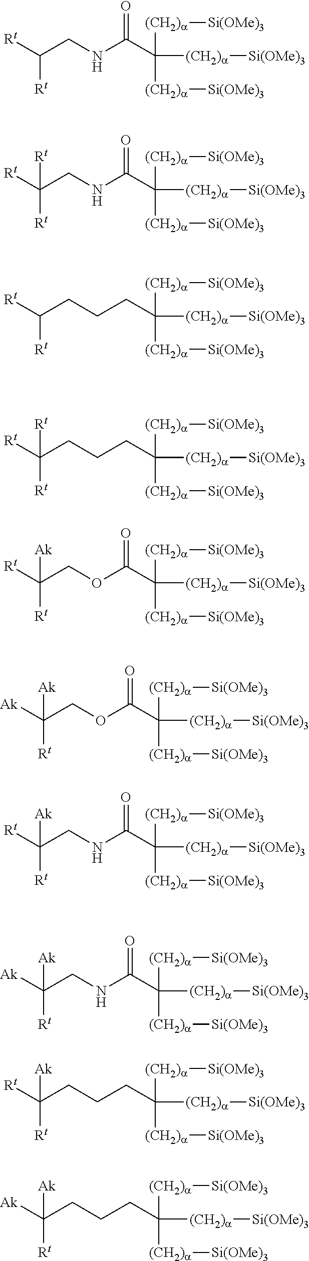

In a case where Z¹ is a polyalkylene oxide group, examples of the compound in which A¹ in Formula (1) is a Group (g2-2) include a compound of the following Formula.

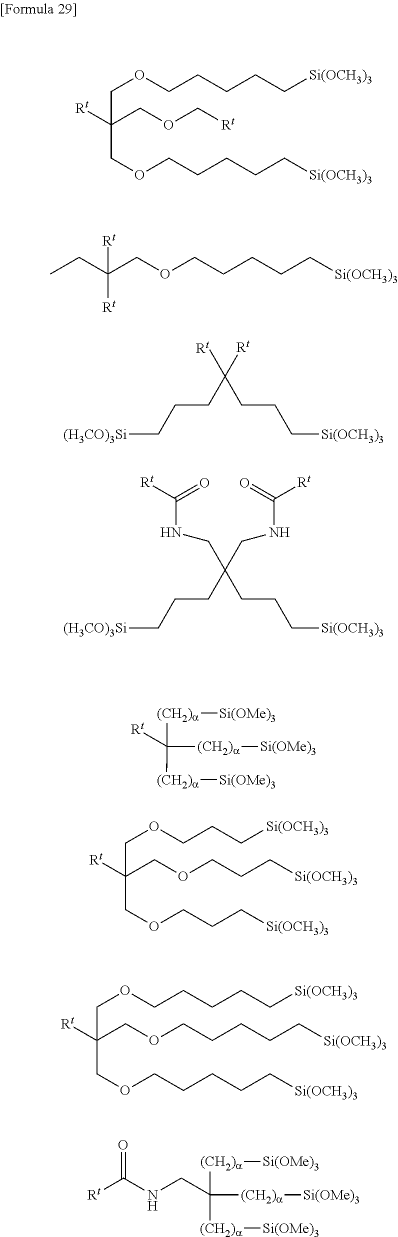

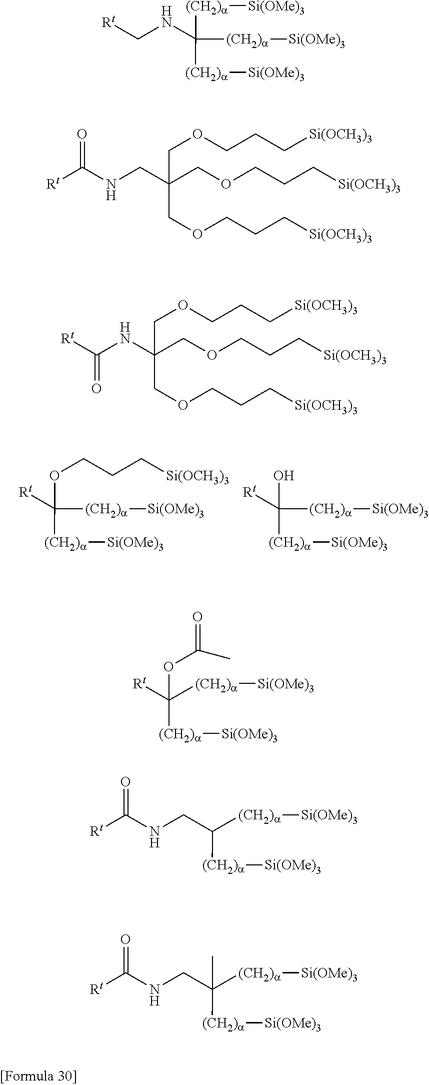

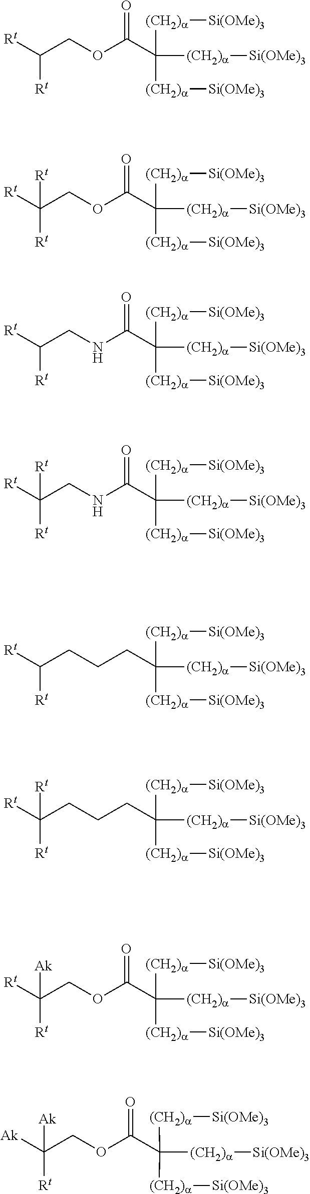

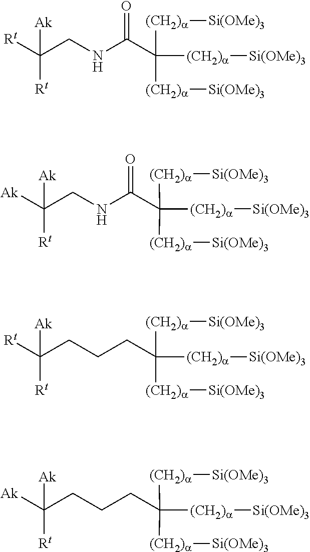

In a case where the terminal of Z¹ on the side bonded to A¹ is an alkylene group, examples of the compound in which A¹ in Formula (1) is a Group (g2-3) include a compound of the following Formula.

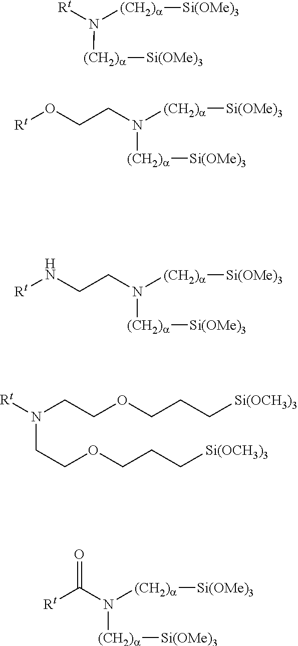

In a case where Z¹ is a polyalkylene oxide group, examples of the compound in which A¹ in Formula 1 is a Group (g2-3) include a compound of the following Formula.

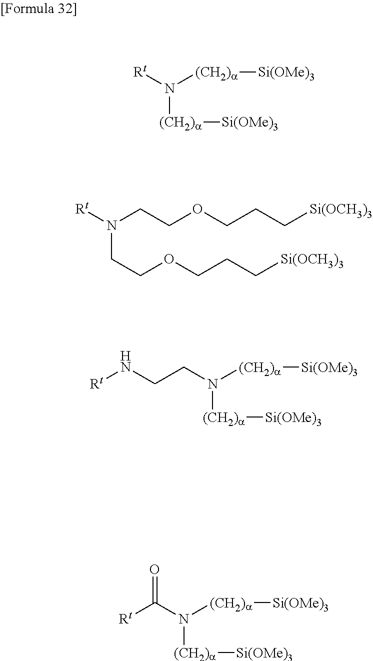

In a case where the terminal of Z¹ on the side bonded to A¹ is an alkylene group, examples of the compound in which A¹ in Formula (1) is a Group (g2-4) include a compound of the following Formula.

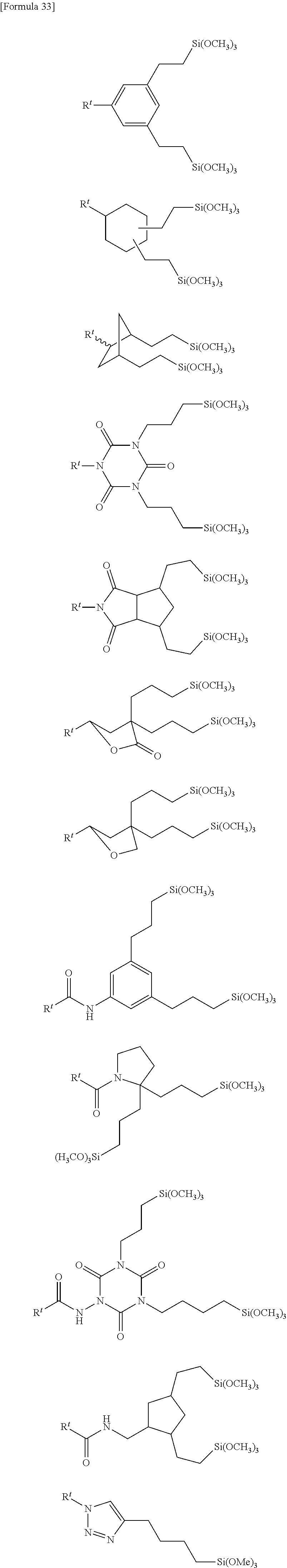

In a case where Z¹ is a polyalkylene oxide group, examples of the compound in which A¹ in Formula (1) is a Group (g2-4) include a compound of the following Formula.

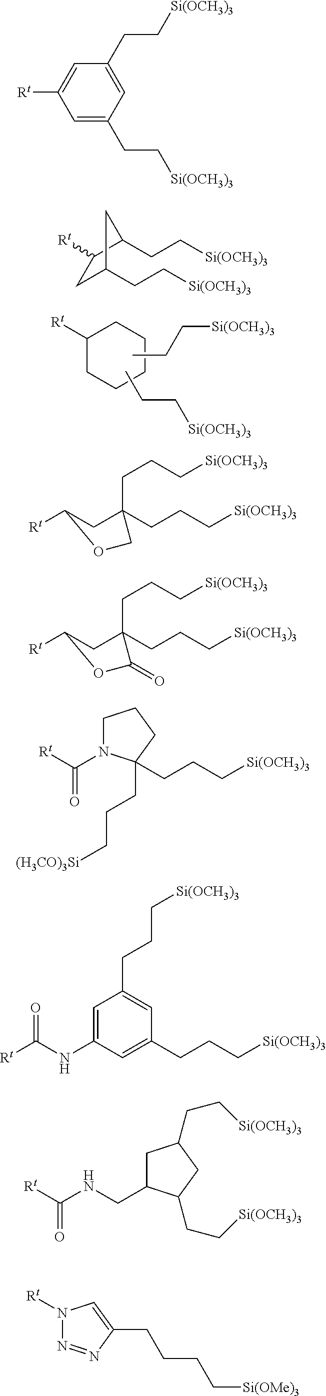

In a case where the terminal of Z¹ on the side bonded to A¹ is an alkylene group, examples of the compound in which A¹ in Formula (1) is a Group (g2-5) include a compound of the following Formula.

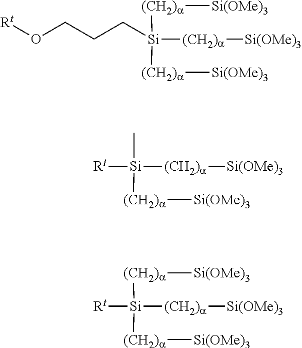

In a case where Z¹ is a polyalkylene oxide group, examples of the compound in which A¹ in Formula (1) is a Group (g2-5) include a compound of the following Formula.

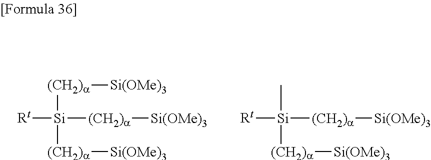

In a case where the terminal of Z¹ on the side bonded to A¹ is an alkylene group, examples of the compound in which A¹ in Formula (1) is a Group (g2-6) include a compound of the following Formula.

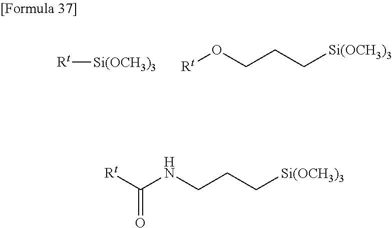

In a case where Z¹ is a polyalkylene oxide group, examples of the compound in which A¹ in Formula (1) is a Group (g2-6) include a compound of the following Formula.

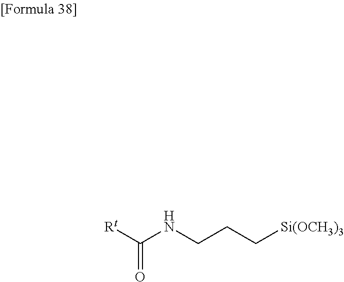

In a case where the terminal of Z¹ on the side bonded to A¹ is an alkylene group, examples of the compound in which A¹ in Formula (1) is a Group (g2-7) include a compound of the following Formula.

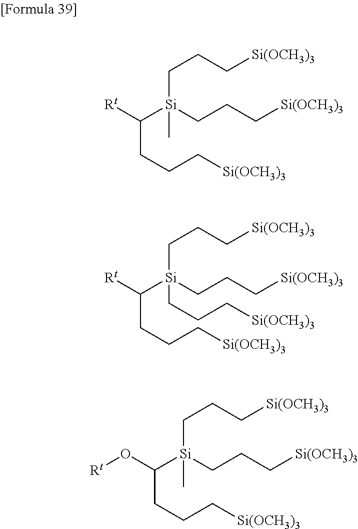

In a case where Z¹ is a polyalkylene oxide group, examples of the compound in which A¹ in Formula (1) is a Group (g2-7) include a compound of the following Formula.

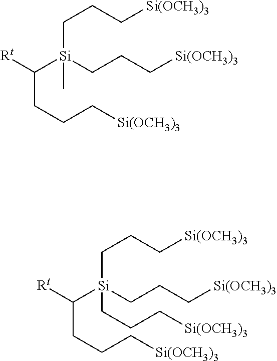

In a case where the terminal of Z¹ on the side bonded to A¹ is an alkylene group, examples of the compound in which A¹ in Formula (1) is a Group (g2-8) include a compound of the following Formula.

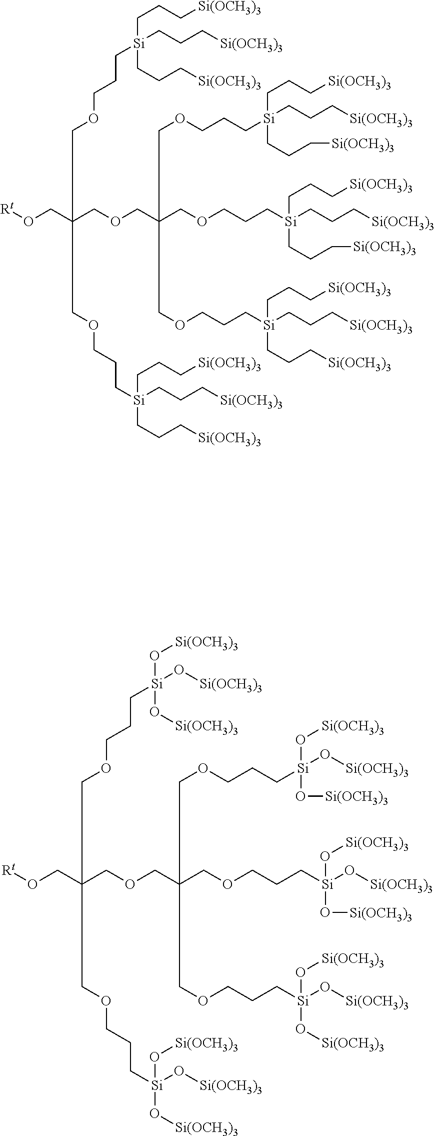

In a case where Z¹ is a polyalkylene oxide group, examples of the compound in which A¹ in Formula (1) is a Group (g2-8) include a compound of the following Formula.

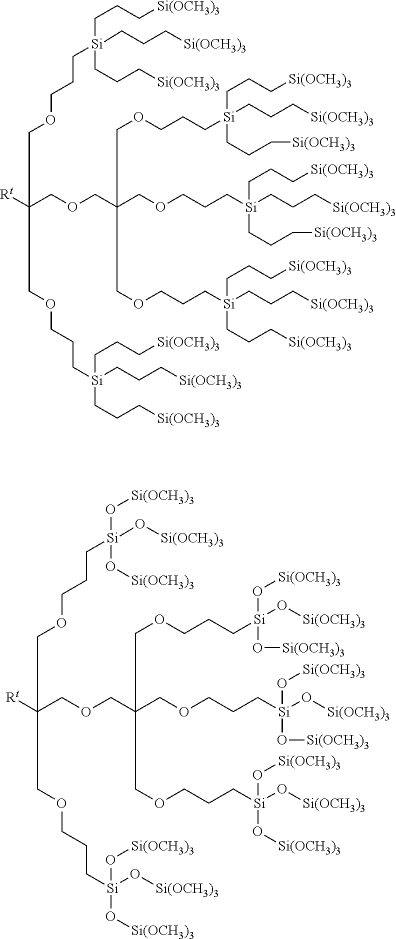

Examples of the compound in which A¹ in Formula (1) is a Group (g2-9) include a compound of the following Formula.

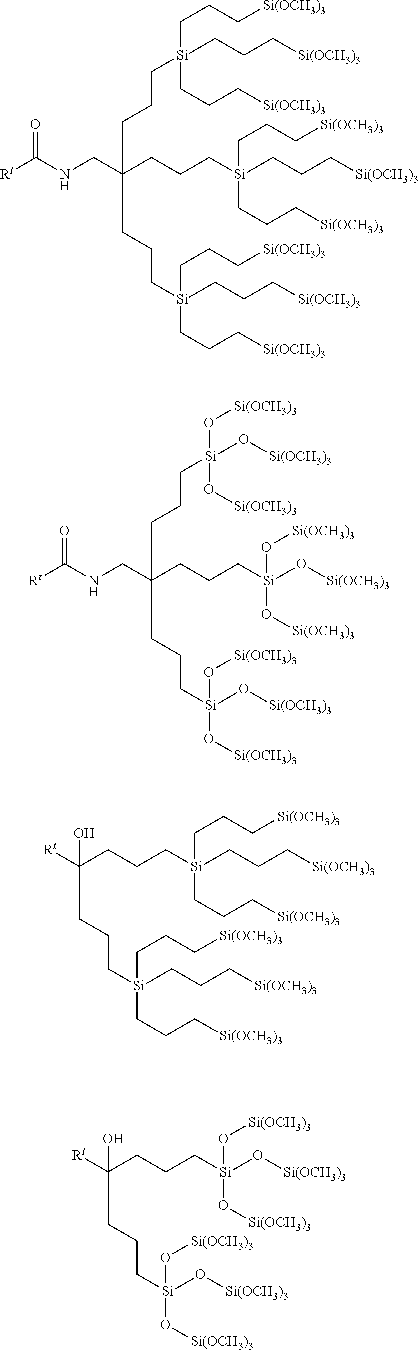

In a case where the terminal of Z¹ on the side bonded to A¹ is an alkylene group, examples of the compound in which A¹ in Formula (1) is a Group (g2-10) include a compound of the following Formula.

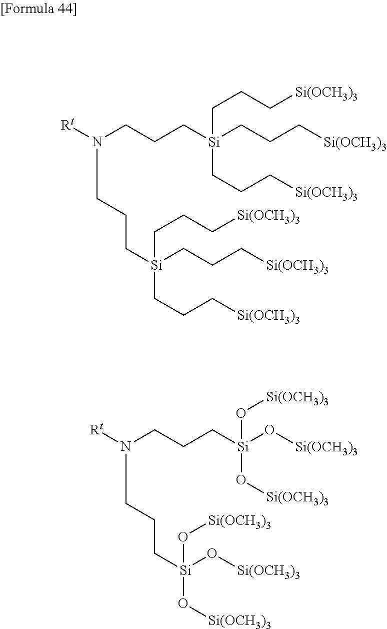

In a case where Z¹ is a polyalkylene oxide group, examples of the compound in which A¹ in Formula (1) is a Group (g2-10) include a compound of the following Formula.

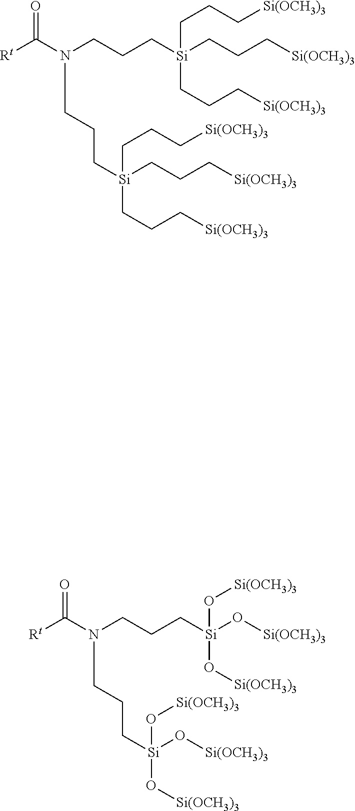

In a case where the terminal of Z¹ on the side bonded to A¹ is an alkylene group, examples of the compound in which A¹ in Formula (1) is a Group (g2-11) include a compound of the following Formula.

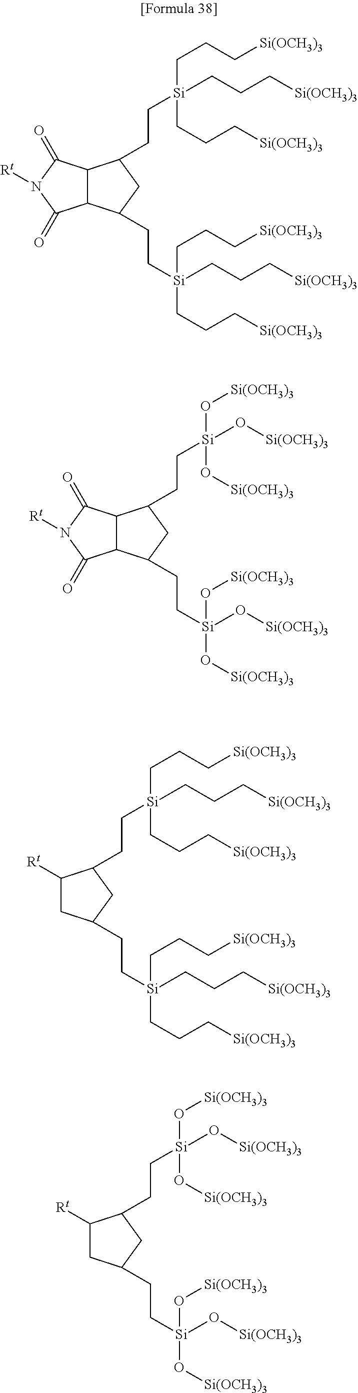

In a case where Z¹ is a polyalkylene oxide group, examples of the compound in which A¹ in Formula (1) is a Group (g2-11) include a compound of the following Formula.

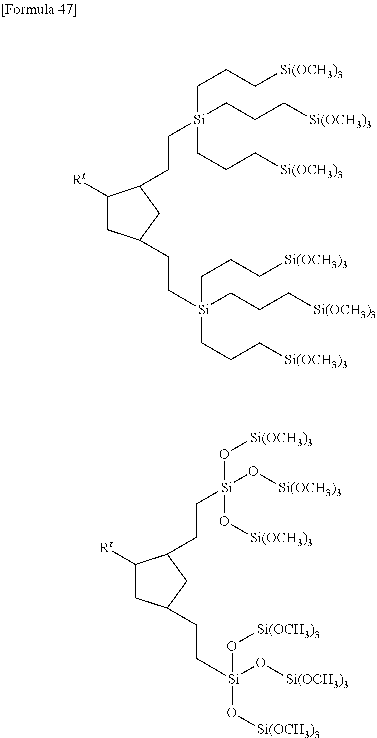

In a case where the terminal of Z¹ on the side bonded to A¹ is an alkylene group, examples of the compound in which A¹ in Formula (1) is a Group (g2-12) include a compound of the following Formula.

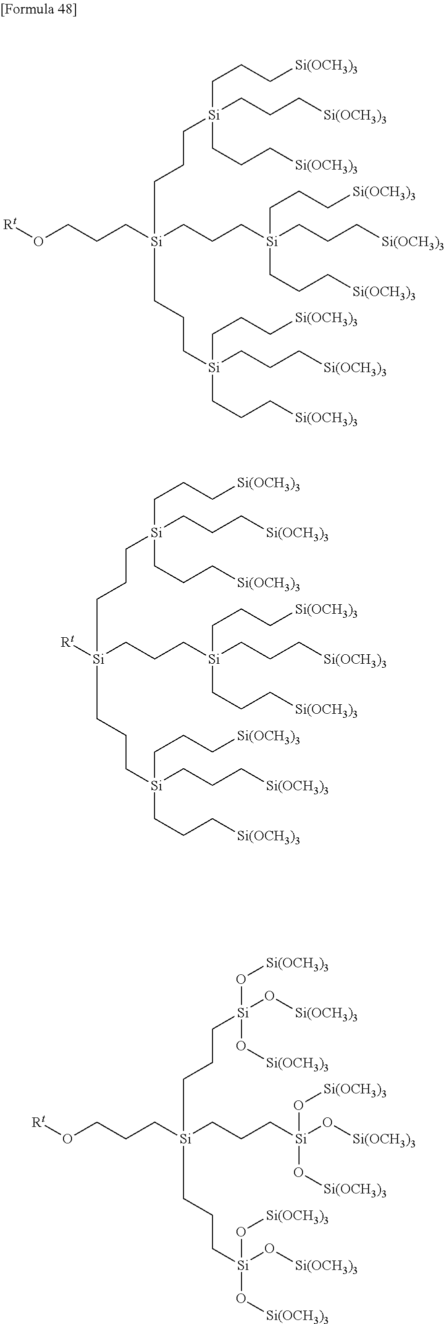

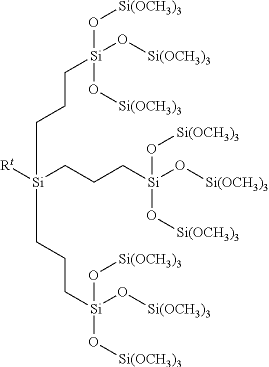

In a case where Z¹ is a polyalkylene oxide group, examples of the compound in which A¹ in Formula (1) is a Group (g2-12) include a compound of the following Formula.

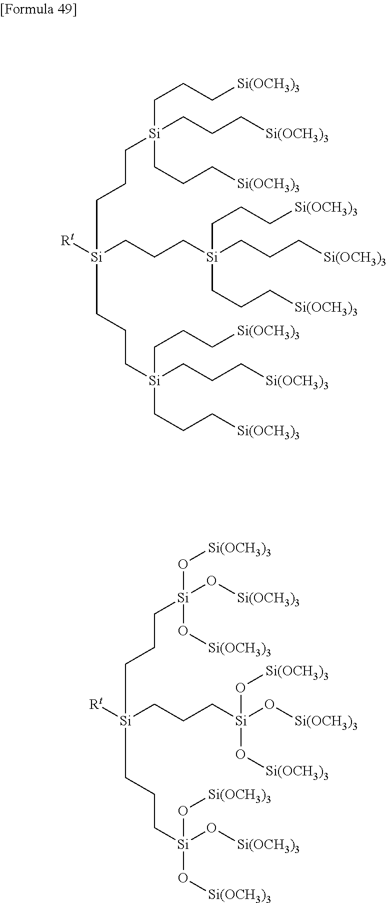

In a case where the terminal of Z¹ on the side bonded to A¹ is an alkylene group, examples of the compound in which A¹ in Formula (1) is a Group (g2-13) include a compound of the following Formula.

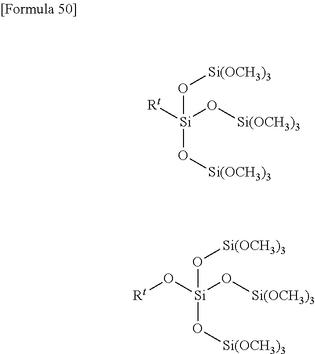

In a case where Z¹ is a polyalkylene oxide group, examples of the compound in which A¹ in Formula (1) is a Group (g2-13) include a compound of the following Formula.

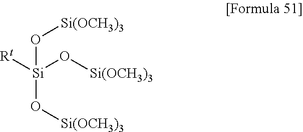

Examples of compounds in which A¹ in Formula 1 is a Group (g2-14) include a compound of the following Formula.

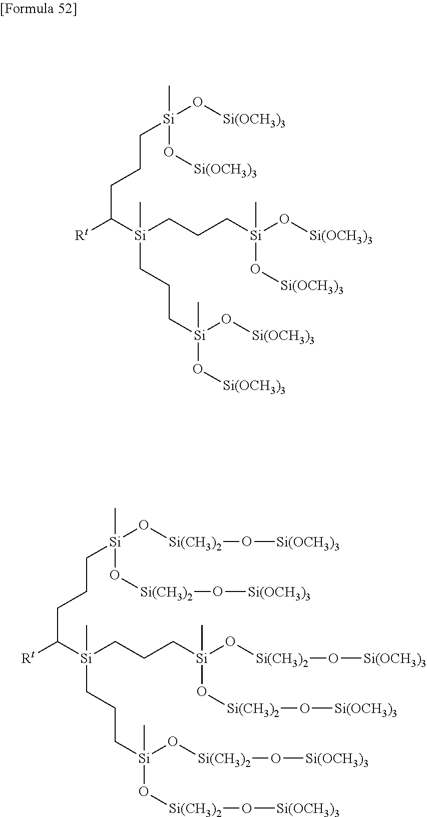

Specific examples of the compound according to the present disclosure include, but not limited to, a compound of the following Formula. Note that, for example, n^{a} and m^{a} can each independently represent a number from 0 to 500, and m^{b} can represent an integer of 1 or more but 30 or less.

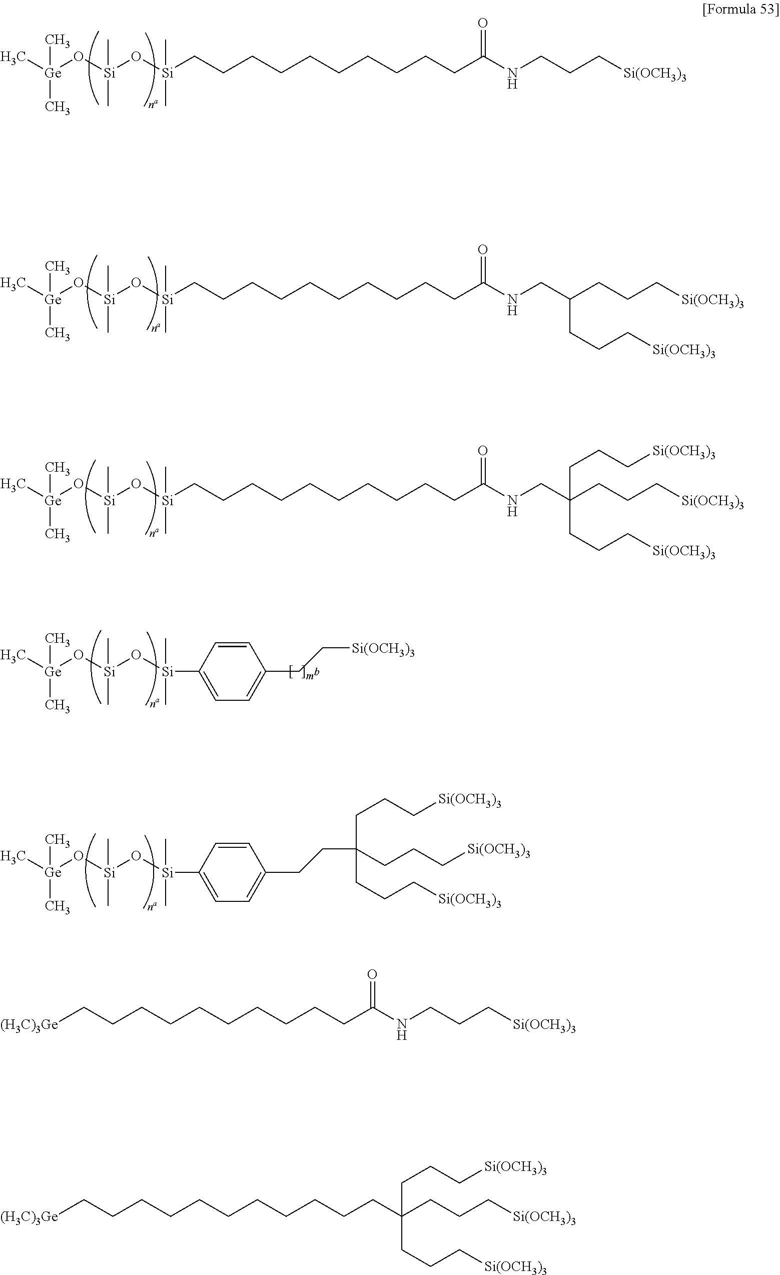

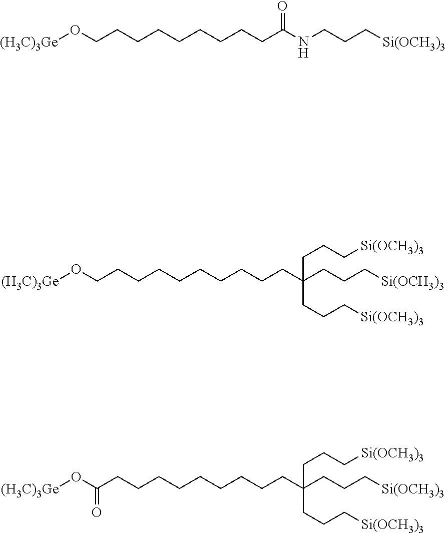

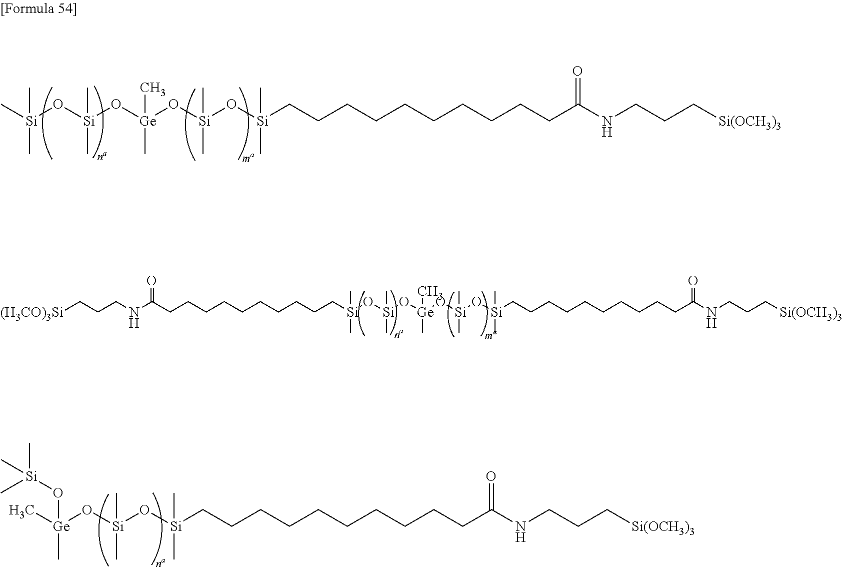

The number average molecular weight (Mn) of the compound according to the present disclosure is preferably from 500 to 20,000, more preferably from 600 to 18,000, and further preferably from 700 to 15,000.

When Mn is 500 or more, the abrasion resistance of the surface treatment layer is more excellent. When Mn is 20,000 or less, the viscosity is easily adjusted within an appropriate range, and the solubility is improved, and thus handleability at the time of film formation is excellent.

### [Method for Manufacturing Compound of Present Disclosure]

The aforementioned method for manufacturing the compound of the present disclosure is not particularly limited. For example, by adding dimethylchlorosilane to a compound having an unsaturated double bond, a compound represented by ClSi(Me)₂-R (where R is an organic group capable of introducing the Group Q) is synthesized. Then, by causing a compound comprising the above Group P: -M¹R¹₂— and Si(CH₃)OH, (—Si(CH₃)₂O—)ₙ, or the like to be reacted with the synthesized compound, a compound including an organopolysiloxane group including Group P can be synthesized. Note that M¹ and R¹ in the Group P have already been described above. Next, the compound of the present disclosure is obtained by introducing the Group Q by a known method.

As the compound including the above Group P: -M¹R¹₂—, Ge(CH₃)O—Si(CH₃)₂OSi(CH₃)₂OH may be, for example, used. While known synthesis according to related art can be used, the method according to Example 1 that will be described later can be, for example, referred to.

### [Composition]

The composition according to the present disclosure may contain the compound according to the present disclosure, and components other than the compound according to the present disclosure are not particularly limited.

That is, the composition according to the present disclosure may contain at least one of the compound represented by Formula (1) or the compound represented by Formula (2). Note that the composition according to the present disclosure may contain both of the compound represented by the Formula (1) and the compound represented by the Formula (2).

The composition of the present disclosure preferably contains the compound of the present disclosure and a liquid medium. When the composition of the present disclosure contains a liquid medium, the composition according to the present disclosure may be a solution, or may be a dispersion, as long as the composition is liquid.

The composition of the present disclosure may contain the compound of the present disclosure, and may contain impurities such as by-products generated in the step of manufacturing the compound of the present disclosure.

The content of the compound of the present disclosure is preferably from 0.001 to 40 mass %, more preferably from 0.01 to 20 mass %, and further preferably from 0.1 to 10 mass % based on the total amount of the composition of the present disclosure. In the case of the composition of the present disclosure used in the wet coating method, the content of the compound of the present disclosure may be from 0.01 to 10 mass %, from 0.02 to 5 mass %, from 0.03 to 3 mass %, or from 0.05 to 2 mass % based on the total amount of the composition of the present disclosure.

The liquid medium contained in the composition of the present disclosure may be of only one kind or two or more kinds.

The liquid medium is preferably an organic solvent.

Examples of organic solvents include compounds consisting solely of hydrogen atoms and carbon atoms, and compounds consisting solely of hydrogen atoms, carbon atoms, and oxygen atoms. Specifically, examples include hydrocarbon-based organic solvents, ketone-based organic solvents, ether-based organic solvents, ester-based organic solvents, glycol-based organic solvents, and alcohol-based organic solvents.

Specific examples of hydrocarbon-based organic solvents include pentane, hexane, heptane, octane, hexadecane, isohexane, isooctane, isononane, cycloheptane, cyclohexane, bicyclohexyl, benzene, toluene, ethylbenzene, o-xylene, m-xylene, p-xylene, o-diethylbenzene, m-diethylbenzene, p-diethylbenzene, n-butylbenzene, sec-butylbenzene, and tert-butylbenzene.

Specific examples of ketone-based organic solvents include acetone, methyl ethyl ketone, methyl isobutyl ketone, diisobutyl ketone, cyclohexanone, 2-heptanone, 4-heptanone, 3,5,5-trimethyl-2-cyclohexene-1-one, 3,3,5-trimethylcyclohexanone, and isophorone.

Specific examples of ether-based organic solvents include diethyl ether, cyclopentyl methyl ether, tetrahydrofuran, and 1,4-dioxane.

Specific examples of ester-based organic solvents include methyl acetate, ethyl acetate, propyl acetate, isopropyl acetate, butyl acetate, isobutyl acetate, tert-butyl acetate, amyl acetate, isoamyl acetate, ethyl 3-ethoxypropionate, ethyl lactate, ethylene glycol monobutyl ether acetate, diethylene glycol monobutyl ether acetate, propylene glycol monomethyl ether acetate, dipropylene glycol methyl ether acetate, 3-methoxy-3-methylbutyl acetate, 3-methoxybutyl acetate, propylene glycol monomethyl acetate, propylene glycol dimethyl acetate, ethylene glycol monoethyl ether acetate, ethylene glycol monomethyl ether acetate, diethylene glycol monoethyl ether acetate, cyclohexanol acetate, propylene glycol diacetate, propylene glycol monomethyl ether acetate, propylene glycol monomethyl ether propionate, propylene glycol monoethyl ether acetate, propylene glycol monobutyl ether acetate, propylene glycol monopropyl ether acetate, propylene glycol diacetate, 1,3-butylene glycol diacetate, 1,4-butanediol diacetate, 1,3-butylene glycol diacetate, 1,6-hexanediol diacetate, γ-butyrolactone, triacetin, and 2,2,4-trimethyl-1,3-pentanediol monoisobutyrate.

Specific examples of glycol-based organic solvents include ethylene glycol, ethylene glycol monobutyl ether, diethylene glycol monobutyl ether, triethylene glycol monobutyl ether, tetraethylene glycol monobutyl ether, ethylene glycol monohexyl ether, diethylene glycol monohexyl ether, ethylene glycol mono-2-ethylhexyl ether, diethylene glycol mono-2-ethylhexyl ether, propylene glycol monomethyl ether, propylene glycol monoethyl ether, propylene glycol monobutyl ether, propylene glycol monopropyl ether, ethylene glycol monoisopropyl ether, ethylene glycol monoethyl ether, ethylene glycol mono tert-butyl ether, ethylene glycol monopropyl ether, ethylene glycol monomethyl ether, diethylene glycol monoisopropyl ether, diethylene glycol monomethyl ether, dipropylene glycol monoethyl ether, dipropylene glycol monobutyl ether, dipropylene glycol monopropyl ether, dipropylene glycol monomethyl ether, tripropylene glycol monobutyl ether, tripropylene glycol monomethyl ether, propylene glycol monophenyl ether, 1,3-butylene glycol, propylene glycol n-propyl ether, propylene glycol n-butyl ether, diethylene glycol monoethyl ether, dipropylene glycol n-propyl ether, dipropylene glycol n-butyl ether, tripropylene glycol methyl ether, tripropylene glycol n-butyl ether, ethylene glycol dimethyl ether, ethylene glycol diethyl ether, ethylene glycol dibutyl ether, diethylene glycol diethyl ether, diethylene glycol dimethyl ether, dipropylene glycol dimethyl ether, diethylene glycol dibutyl ether, tetraethylene glycol dimethyl ether, dipropylene glycol dimethyl ether pentane, triethylene glycol dimethyl ether, and polyethylene glycol dimethyl ether.

Specific examples of alcohol-based organic solvents include methanol, ethanol, 1-propanol, isopropyl alcohol, n-butanol, diacetone alcohol, isobutanol, sec-butanol, tert-butanol, pentanol, 3-methyl-1,3-butanediol, 1,3-butanediol, 1,3-butylene glycol, octanediol, 2,4-diethylpentanediol, butylethylpropanediol, 2-methyl-1,3-propanediol, 4-hydroxy-4-methyl-2-pentanone, 2-ethyl-1-hexanol, 3,5,5-trimethyl-1-hexanol, isodecanol, isotridecanol, 3-methoxy-3-methyl-1-butanol, 2-methoxybutanol, 3-methoxybutanol, cyclohexanol, furfuryl alcohol, tetrahydrofurfuryl alcohol, benzyl alcohol, and methylcyclohexanol.

Further, examples of organic solvents include a halogen-based organic solvent, a nitrogen compound, a sulfur-containing compound, a siloxane compound, and a fluorine-containing organic solvent.

Specific examples of halogen-based organic solvents include dichloromethane, chloroform, carbon tetrachloride, dichloroethane, chlorobenzene, o-chlorotoluene, m-chlorotoluene, p-chlorotoluene, m-dichlorobenzene, and 1,2,3-trichloropropane.

Examples of nitrogen-containing compounds include nitrobenzene, acetonitrile, benzonitrile, N,N-dimethylformamide, N,N-dimethylacetamide, N-methylpyrrolidone, and 1,3-dimethyl-2-imidazolidinone.

Examples of sulfur-containing compounds include carbon disulfide and dimethyl sulfoxide.

Examples of siloxane compounds include hexamethyldisiloxane, hexaethyldisiloxane, octamethyltrisiloxane, octaethyltrisiloxane, hexamethylcyclotrisiloxane, hexaethylcyclotrisiloxane, octamethylcyclotetrasiloxane, octaethylcyclotetrasiloxane, and decamethyltetrasiloxane.

Examples of fluorine-containing organic solvents include polyfluoro aromatic hydrocarbons (e.g., 1,3-bis(trifluoromethyl) benzene); polyfluoro aliphatic hydrocarbons (e.g., C₆F₁₃CH₂CH₃ (e.g., Asahikrin (Registered Trademark) AC-6000 manufactured by AGC Inc.,), 1,1,2,2,3,3,4-heptafluorocyclopentane (e.g., Zeorora (Registered Trademark) H manufactured by Zeon Corporation); hydrofluoroethers (HFE) (e.g., perfluoroalkyl ethers (perfluoroalkyl group and alkyl group may be linear chain or branched) such as perfluoropropyl methyl ether (C₃F₇OCH₃) (e.g., Novec (Trademark) 7000 manufactured by 3M Japan Limited), perfluorobutyl methyl ether (C₄F₉OCH₃) (e.g., Novec (Trademark) 7100 manufactured by 3M Japan Limited), perfluorobutyl ethyl ether (C₄F₉OC₂H₅) (e.g., Novec (Trademark) 7200 manufactured by 3M Japan Limited), and perfluorohexyl methyl ether (C₂F₅CF(OCH₃)C₃F₇) (e.g., Novec (Trademark) 7300 manufactured by 3M Japan Limited), and CF₃CH₂OCF₂CHF₂ (e.g., Asahikrin (Registered Trademark) AE-3000 manufactured by AGC Inc.,); and hydrofluoroolefins (HFO) (e.g., 1-chloro-2,3,3-trifluoro-1-propene (HCFO-1233yd) (e.g., Amolea (Registered Trademark) AS-300 manufactured by AGC Inc.,)).

The content of the liquid medium is preferably from 60 to 99.999 wt. %, more preferably from 80 to 99.99 wt. %, and still more preferably from 90 to 99.9 wt. % based on the total amount of the composition according to the present disclosure. In the case where the composition according to the present disclosure is used in a wet coating method, the content of the liquid medium may be from 90 to 99.99 wt. %, from 95 to 99.98 wt. %, from 97 to 99.97 wt. %, or from 98 to 99.95 wt. % based on the total amount of the composition according to the present disclosure.

The composition of the present disclosure may contain other components in addition to the compound of the present disclosure and the liquid medium as long as the effects of the present disclosure are not impaired.

Examples of other components include known additives such as acid catalysts and basic catalysts that promote hydrolysis and condensation reaction of the group Q.

An arbitrary suitable acid or base, a transition metal (e.g., Ti, Ni, Sn, Zr, Al or B), a sulfur-containing compound having a non-covalent electron pair in the molecular structure, a nitrogen-containing compound (e.g., a sulfoxide compound, an aliphatic amine compound, an aromatic amine compound, a phosphoric acid amide compound, an amide compound, and a urea compound) can be used as the catalyst.

Examples of acid catalysts include acetic acid, formic acid, trifluoroacetic acid, hydrochloric acid, nitric acid, sulfuric acid, phosphoric acid, sulfonic acid, methanesulfonic acid, and p-toluenesulfonic acid.

Further, examples of base catalysts include ammonia, sodium hydroxide, and potassium hydroxide; and organic amines such as triethylamine and diethylamine.

Further, examples of other components also include metal compounds having hydrolyzable groups (metal compounds having hydrolyzable groups are hereinafter also referred to as “specific metal compounds”). When the composition according to the present disclosure contains a specific metal compound, the sliding property and the antifouling property of the surface treatment layer can be further improved. Examples of specific metal compounds include a metal compound represented by one of Formulas (M1) to (M3).

M(X^{b1})ₘ₁(X^{b2})ₘ₂(X^{b3})ₘ₃ (M1)

Si(X^{b4})(X^{b5})₃ (M2)

(X^{b6})₃Si—(Y^{b1})—Si(X^{b7})₃ (M3)

In Formula (M1),

M represents a trivalent or tetravalent metal atom.

X^{b1} each independently represents a hydrolyzable group.

X^{b2} each independently represents a siloxane skeleton-containing group.

X^{b3} each independently represents a hydrocarbon chain-containing group.
m1 is an integer from 2 to 4,
m2 and m3 are each independently an integer from 0 to 2, and
when M is a trivalent metal atom, m1+m2+m3 is 3, whereas when M is a tetravalent metal atom, m1+m2+m3 is 4.

In Formula (M2),
X^{b4} represents a hydrolyzable silane oligomer group, and
X^{b5} each independently represents a hydrolyzable group or an alkyl group having a number of carbon atoms from 1 to 4.

In Formula (M3),
X^{b6} and X^{b7} each independently represent a hydrolyzable group or a hydroxyl group, and
Y^{b1} represents a divalent organic group.

The metal represented by M in Formula (M1) includes semimetals such as Si and Ge. M is preferably a trivalent metal and a tetravalent metal, more preferably Al, Fe, In, Hf, Si, Ti, Sn, and Zr, further preferably Al, Si, Ti, and Zr, and particularly preferably Si.

Specific examples of the hydrolyzable group represented by X^{b1} in Formula (M1) include the same group as the hydrolyzable group represented by L in [—Si(R¹)ₙL₃₋ₙ] in the Group Q.

The siloxane skeleton-containing group represented by X^{b2} has a siloxane unit (—Si—O—), and may be either linear or branched. The siloxane unit is preferably a dialkylsilyloxy group, and examples include a dimethylsilyloxy group and a diethylsilyloxy group. The number of repetitions of the siloxane unit in the siloxane skeleton-containing group is 1 or more, preferably from 1 to 5, more preferably from 1 to 4, and further preferably from 1 to 3.

The siloxane skeleton-containing group may contain a divalent hydrocarbon group in a part of the siloxane skeleton. Specifically, an oxygen atom in a part of the siloxane skeleton may be replaced with a divalent hydrocarbon group. Examples of the aforementioned divalent hydrocarbon group include alkylene groups such as a methylene group, an ethylene group, a propylene group, and a butylene group.

A hydrolyzable group, a hydrocarbon group (preferably an alkyl group), or the like may be bonded to a silicon atom at the end of the siloxane skeleton-containing group.

The number of elements of the siloxane skeleton-containing group is preferably 100 or less, more preferably 50 or less, and further preferably 30 or less. The number of elements is preferably 10 or more.

The siloxane skeleton-containing group is preferably a group represented by *—(O—Si(CH₃)₂)ₙCH₃, where n is an integer from 1 to 5, and * represents a part bonded to an adjacent atom.

The hydrocarbon chain-containing group represented by X^{b3} may be a group consisting solely of a hydrocarbon chain or a group having an etheric oxygen atom between carbon atoms of a hydrocarbon chain. The hydrocarbon chain may be linear or branched, and is preferably linear. The hydrocarbon chain may be a saturated hydrocarbon chain or an unsaturated hydrocarbon chain, and is preferably a saturated hydrocarbon chain. The number of carbon atoms of the hydrocarbon chain-containing group is preferably from 1 to 3, more preferably from 1 to 2, and further preferably 1. The hydrocarbon chain-containing group is preferably an alkyl group, and more preferably a methyl group, an ethyl group, or a propyl group.

m1 is preferably 3 or 4.

The compound represented by Formula (M1) is preferably a compound represented by the following Formulas (M1-1) to (M1-5) in which M is Si, and more preferably a compound represented by Formula (M1-1). The compound represented by Formula (M1-1) is preferably tetraethoxysilane, tetramethoxysilane, or triethoxymethylsilane.

Si(X^{b1})₄ (M1-1)

CH₃—Si(X^{b1})₃ (M1-2)

C₂H₅—Si(X^{b1})₃ (M1-3)

n-C₃H₇—Si(X^{b1})₃ (M1-4)

(CH₃)₂CH—Si(X^{b1})₃ (M1-5)

In Formula (M2), the number of silicon atoms contained in the hydrolyzable silane oligomer group represented by X^{b4} is preferably 3 or more, more preferably 5 or more, and further preferably 7 or more. The number of silicon atoms is preferably 15 or less, more preferably 13 or less, and further preferably 10 or less.

The hydrolyzable silane oligomer group may have an alkoxy group that is bonded to a silicon atom. Examples of the alkoxy group include a methoxy group, an ethoxy group, a propoxy group, a butoxy group, and the like, and the alkoxy group is preferably a methoxy group and an ethoxy group. The hydrolyzable silane oligomer group may have one or two or more groups of alkoxy groups, and preferably has one group of alkoxy group.

Examples of the hydrolyzable silane oligomer group include (C₂H₅O)₃Si—(OSi(OC₂H₅)₂)₄O—*, and the like. Note that * represents a part bonded to an adjacent atom.

Examples of the hydrolyzable group represented by X^{b5} in Formula (M2) include the same group as the hydrolyzable group represented by L in [—Si(R¹)ₙL₃₋ₙ] in the above Group Q, a cyano group, a hydrogen atom, and an allyl group, and preferably an alkoxy group or an isocyanato group. The alkoxy group is preferably an alkoxy group having a number of carbon atoms from 1 to 4.

X^{b5} is preferably a hydrolyzable group.

Examples of the compound represented by Formula (M2) include (H₅C₂O)₃—Si—(OSi(OC₂H₅)₂)₄OC₂H₅.

The compound represented by Formula (M3) is a compound having Si(X^{b6})₃ or Si(X^{b7})₃ at both terminals of a divalent organic group, that is, bissilane.

Examples of the hydrolyzable group represented by X^{b6} and X^{b7} in Formula (M3) include an alkoxy group, an acyloxy group, a ketoxime group, an alkenyloxy group, an amino group, an aminoxy group, an amide group, an isocyanato group, and a halogen atom, and the hydrolyzable group represented by X^{b6} and X^{b7} in Formula (M3) is preferably an alkoxy group and an isocyanato group. As the alkoxy group, an alkoxy group having a number of carbon atoms from 1 to 4 is preferable, and a methoxy group and an ethoxy group are more preferable.

In Formula (M3), X^{b6} and X^{b7} may be the same group or different groups from each other. From the viewpoint of availability, X^{b6} and X^{b7} are preferably the same group.

In Formula (M3), Y^{b1} is a divalent organic group linking Si(X^{b6})₃ and Si(X^{b7})₃ that are present at both terminals. The number of carbon atoms in Y^{b1} of the divalent organic group is preferably from 1 to 8, and more preferably from 1 to 3.

Examples of Y^{b1} include an alkylene group, a phenylene group, and an alkylene group having an etheric oxygen atom between carbon atoms. Examples thereof include —CH₂CH₂—, —CH₂CH₂CH₂—, —CH₂CH₂CH₂CH₂—, —CH₂CH₂CH₂CH₂CH₂—, —CH₂CH₂CH₂CH₂CH₂CH₂—, —CH₂C(CH₃)₂CH₂—, —C(CH₃)₂CH₂CH₂C(CH₃)₂—, —CH₂CH₂OCH₂CH₂—, —CH₂CH₂CH₂OCH₂CH₂CH₂—, —CH(CH₃)CH₂OCH₂CH(CH₃)—, and —C₆H₄—.

Examples of the compound represented by Formula (M3) include (CH₃O)₃Si(CH₂)₂Si(OCH₃)₃, (C₂H₅O)₃Si(CH₂)₂Si(OC₂H₅)₃, (OCN)₃Si(CH₂)₂Si(NCO)₃, Cl₃Si(CH₂)₂SiCl₃, (CH₃O)₃Si(CH₂)₆Si(OCH₃)₃, and (C₂H₅O)₃Si(CH₂)₆Si(OC₂H₅)₃.

The content of other components that may be contained in the composition of the present disclosure is preferably 10 mass % or less and more preferably 1 mass % or less based on the total amount of the composition according to the present disclosure. When the composition according to the present disclosure contains a specific metal compound, the content of the specific metal compound is preferably from 0.01 to 30 mass %, more preferably from 0.01 to 10 mass %, and further preferably from 0.05 to 5 mass % based on the total amount of the composition of the present disclosure.

The total content (hereinafter also referred to as “solid content concentration”) of the compound of the present disclosure and the other components is preferably from 0.001 to 40 wt. %, more preferably from 0.01 to 20 wt. %, and still more preferably from 0.1 to 10 wt. % based on the total amount of the composition according to the present disclosure. The solid content concentration of the composition according to the present disclosure is a value calculated from the mass of the composition before being heated and the mass thereof after being heated in a convection-type dryer at 120° C. for 4 hours.

Since the composition according to the present disclosure contains a liquid medium, it is useful as a coating application and can be used as a coating liquid.

Examples of other components include compounds represented by the following Formula (4):

[Y¹₃Y²—(O)—Y³]ᵥ₂Y⁴(Si(Y⁵)ᵥ₃(Y⁶)₃₋ᵥ₃)ᵥ₄ (4)
where in Formula (4), Y² is Si, Sn, or Ge,
Y¹ is each independently a hydrocarbon group or a trialkylsilyloxy group,
v1 is 0 or 1,
Y³ is each independently an alkylene chain or a polyalkylene oxide chain, or a combination of an alkylene chain with a divalent polysiloxane residue,
Y⁴ is a single bond or a (v2+v4)-valent linking group,
Y⁵ is each independently a hydrocarbon group,
Y⁶ is each independently a hydrolyzable group or a hydroxyl group,
v3 is each independently an integer from 0 to 2, and
v2 and v4 are each independently an integer of 1 or more.

Y³ is preferably an alkylene chain or a polyalkylene oxide chain.

Specific examples of the compound (4) include the compounds shown below. γ in the formula is preferably from 9 to 50, more preferably from 11 to 30, and particularly preferably from 11 to 25.

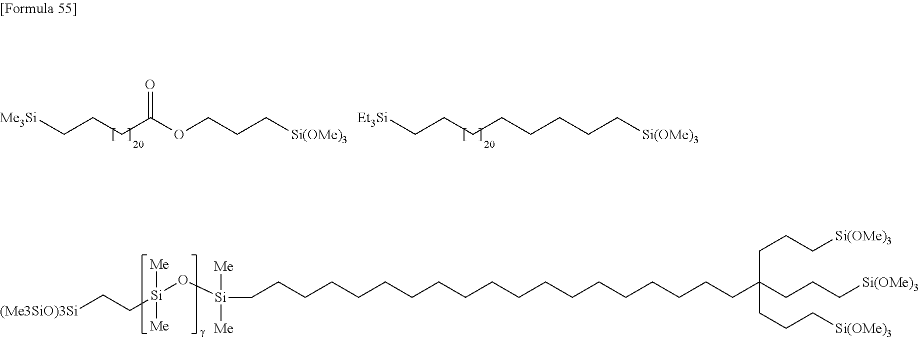

When the other component in the surface treatment agent disclosed herein is the compound (4), the content of the compound (4) is preferably 50 mass % or less, and more preferably 40 mass % or less.

### [Surface Treatment Agent]

In an embodiment, a surface treatment agent according to the present disclosure contains a compound according to the present disclosure. Further, the surface treatment agent according to the present disclosure may contain the compound according to the present disclosure and a liquid medium. The surface treatment agent according to the present disclosure may be a composition according to the present disclosure. Preferable forms of the liquid medium included in the surface treatment agent are the same as preferable forms of the liquid medium included in the composition of the present disclosure.

The compound according to the present disclosure includes an alkyl group having a number of carbon atoms of 2 or more, an organopolysiloxane group, and a Group Q. Therefore, by using a surface treatment agent comprising the compound of the present disclosure, a surface treatment layer with excellent water repellency and abrasion resistance can be formed.

The surface treatment agent according to the present disclosure is preferably used, in particular, for optical members.

### [Article]

In an embodiment, an article according to the present disclosure includes a substrate and a surface treatment layer which is disposed on the substrate and of which the surface is treated with a surface treatment agent according to the present disclosure.

The surface treatment layer may be formed on a part of the surface of the substrate or over the entire surface of the substrate. The surface treatment layer may be spread in the form of a film on the surface of the substrate or scattered in the form of dots.

In the surface treatment layer, the compound of the present disclosure is contained therein in a state in which the hydrolysis of some or all of the Group Q have progressed and the dehydration condensation reaction of silanol groups have progressed.

The thickness of the surface treatment layer is preferably from 1 to 100 nm and more preferably from 1 to 50 nm. When the thickness of the surface treatment layer is 1 nm or more, the effects of the surface treatment are likely to be obtained satisfactorily. When the thickness of the surface treatment layer is 100 nm or smaller, the usage efficiency is high. The thickness of the surface treatment layer can be calculated from the oscillation cycle of the interference pattern of the reflected X-ray, which is obtained by an X-ray reflectivity method using an X-ray diffractometer for thin film analysis (Product name: ATX-G, manufactured by Rigaku Corporation).

The type of the substrate is not limited to any particular types, and examples include a substrate which is required to have water repellency. Examples of the substrate include a substrate which may be used while touching it with another article (e.g., a stylus) or a human hand or fingers; a substrate which may be held by a human hand or fingers during the operation; and a substrate which may be placed on another article (e.g., a mounting table).

Examples of the material of the substrate include metals, resins, glass, sapphire, ceramics, semiconductors, stones, fibers, nonwoven fabric, paper, wood, fur, natural leather, artificial leather, pottery, and composite materials thereof. The glass may be one that is chemically reinforced.

Examples of substrates include building materials, decorative building materials, interior goods, transportation apparatuses (e.g., automobiles), signboards, bulletin boards, drinking containers, tableware, water tanks, ornamental apparatuses (e.g., frames and boxes), laboratory apparatuses, furniture, textile products, and packaging containers; glass or resins used for art, sports, games and the like; glass or resins used for exterior parts (excluding display parts) of apparatuses such as mobile phones (e.g., smartphones), mobile information terminals, game machines, and remote controllers. The shape of the substrate may be plate-like or film-like.

The substrate is preferably a substrate for a touch panel, a substrate for a display, or a lens for eyeglasses, and particularly preferably a substrate for a touch panel. The material of a substrate for a touch panel is preferably glass or a transparent resin.

The substrate may be a substrate of which a surface treatment such as a corona discharge treatment, a plasma treatment, a plasma graft polymerization treatment, or the like has been performed on one or both of the surfaces. The substrate subjected to the surface treatment has a more excellent adhesive property for the surface treatment layer, and the abrasion resistance of the surface treatment layer is further improved. Therefore, it is preferred to perform a surface treatment on the surface of the substrate on the side which is brought into contact with the surface treatment layer. Further, in the case where an underlayer (which will be described later) is provided, the substrate subjected to the surface treatment has a more excellent adhesive property for the underlayer, and the abrasion resistance of the surface treatment layer is further improved. Therefore, in the case where an underlayer is provided, it is preferred to perform a surface treatment on the surface of the substrate on the side which is brought into contact with the underlayer.

The surface treatment layer may be directly disposed on the surface of the substrate, or an underlayer may be provided between the substrate and the surface treatment layer. In order to further improve the water repellency and the abrasion resistance of the surface treatment layer, an article according to the present disclosure preferably includes a substrate, an underlayer disposed on the substrate, and a surface treatment layer which is disposed on the underlayer and of which the surface is treated with a surface treatment agent according to the present disclosure.

The underlayer is preferably a layer comprising an oxide comprising silicon and at least one specific element selected from the group consisting of Group 1 elements, Group 2 elements, Group 4 elements, Group 5 elements, Group 13 elements, and Group 15 elements in the periodic table.

Group 1 elements in the periodic table (hereinafter also referred to as “Group 1 elements”) mean lithium, sodium, potassium, rubidium, and cesium. Group 1 elements are preferably lithium, sodium, and potassium, and more preferably sodium and potassium because the surface treatment layer can be formed more uniformly on the underlayer without defects or because variations in the composition of the underlayer among samples are more suppressed. The underlayer may contain two or more kinds of Group 1 elements.

Group 2 elements in the periodic table (hereinafter also referred to as “Group 2 elements”) mean beryllium, magnesium, calcium, strontium, and barium. Group 2 elements are preferably magnesium, calcium, and barium, and more preferably magnesium and calcium because the surface treatment layer can be formed more uniformly on the underlayer without defects or because variations in the composition of the underlayer among samples are more suppressed. The underlayer may contain two or more kinds of Group 2 elements.

Group 4 elements in the periodic table (hereinafter also referred to as “Group 4 elements”) mean titanium, zirconium, and hafnium. Group 4 elements are preferably titanium and zirconium, and more preferably titanium because the surface treatment layer can be formed more uniformly on the underlayer without defects or because variations in the composition of the underlayer among samples are more suppressed. The underlayer may contain two or more kinds of Group 4 elements.

Group 5 elements in the periodic table (hereinafter also referred to as “Group 5 elements”) mean vanadium, niobium, and tantalum. Group 5 elements are particularly preferably vanadium because the abrasion resistance of the surface treatment layer becomes more excellent. The underlayer may contain two or more kinds of Group 5 elements.

Group 13 elements in the periodic table (hereinafter also referred to as “Group 13 elements”) mean boron, aluminum, gallium, and indium. Group 13 elements are preferably boron, aluminum, and gallium, and more preferably boron and aluminum because the surface treatment layer can be formed more uniformly on the underlayer without defects or because variations in the composition of the underlayer among samples are more suppressed. The underlayer may contain two or more kinds of Group 13 elements.

Group 15 elements in the periodic table (hereinafter also referred to as “Group 15 elements”) mean nitrogen, phosphorus, arsenic, antimony, and bismuth. Group 15 elements are preferably phosphorus, antimony, and bismuth, and more preferably phosphorus and bismuth because the surface treatment layer can be formed more uniformly on the underlayer without defects or because variations in the composition of the underlayer among samples are more suppressed. The underlayer may contain two or more kinds of Group 15 elements.

The specific element contained in the underlayer is preferably a Group 1 element, a Group 2 element, and a Group 13 element, more preferably a Group 1 element and a Group 2 element, and still more preferably a Group 1 element because the abrasion resistance of the surface treatment layer becomes more excellent.

Only one kind of element or two or more kinds of elements may be contained as the specific element(s).

The oxide contained in the underlayer may be a mixture of oxides each comprising only one of the aforementioned elements (silicon and specific element) (e.g., a mixture of silicon oxide and an oxide of a specific element), a composite oxide comprising two or more kinds of the aforementioned elements, or a mixture of an oxide comprising only one of the aforementioned elements and a composite oxide.

The ratio of the total molarity of the specific element in the underlayer to the molarity of silicon in the underlayer (specific element/silicon) is preferably from 0.02 to 2.90, more preferably from 0.10 to 2.00, and still more preferably from 0.20 to 1.80 because the abrasion resistance of the surface treatment layer becomes more excellent.

The molarity (mol %) of each element in the underlayer can be measured, for example, by a depth-direction analysis by X-ray photoelectron spectroscopy (XPS) using ion sputtering.

The underlayer may be a single layer or may consist of a plurality of layer. The underlayer may have an uneven surface(s).

The thickness of the underlayer is preferably from 1 to 100 nm, more preferably from 1 to 50 nm, and still more preferably from 2 to 20 nm. When the thickness of the underlayer is equal to or larger than the aforementioned lower limit value, the adhesive property of the surface treatment layer by the underlayer is further improved, so that the abrasion resistance of the surface treatment layer becomes more excellent. When the thickness of the underlayer is equal to or less than the aforementioned upper limit value, the abrasion resistance of the underlayer itself becomes excellent.

The thickness of the underlayer is measured by observing the cross section of the underlayer by a transmission electron microscope (TEM).

The underlayer can be formed, for example, by a vapor-deposition method using a vapor-deposition material or a wet coating method.

The vapor-deposition material used in the vapor-deposition method preferably an oxide comprising silicon and a specific element.

Specific examples of the form of the vapor-deposition material include a powder, a molten material, a sintered compact, granules, and a crushed material. Further, a molten material, a sintered compact, and granules are preferred in view of the handling property.

Note that the molten material means a solid material obtained by melting a powder of a vapor-deposition material at a high temperature, and then cooling and solidifying the molten vapor-deposition material. The sintered compact means a solid material obtained by firing a powder of a vapor-deposition material. Further, if necessary, instead of the powder of the vapor-deposition material, a molded compact formed by pressing the powder may be used. The granules means a solid material obtained by mixing and kneading a powder of a vapor-deposition material and a liquid medium (e.g., water or an organic solvent) and thereby obtaining particles thereof, and then drying the obtained particles.

The vapor-deposition material can be manufactured, for example, by the following methods.
A method in which a powder of a vapor-deposition material is obtained by mixing a powder of silicon oxide with a powder of an oxide of a specific element.
A method in which granules of a vapor-deposition material is obtained by, after obtaining particles by mixing and kneading a powder of the aforementioned vapor-deposition material and water, drying the obtained particles.
A method in which a sintered compact is obtained by drying a mixture obtained by mixing a powder comprising silicon (e.g., a powder made of silicon oxide, silica sand, or silica gel), a powder comprising a specific element (e.g., a powder of an oxide of a specific element, a carbonate, a sulfate, a nitrate, an oxalate, or a hydroxide), and water, and then firing the dried mixture or a molded article obtained by press-molding the dried mixture.
A method in which a molten material is obtained by melting a powder comprising silicon (e.g., a powder made of silicon oxide, silica sand, or silica gel) and a powder comprising a specific element (e.g., a powder of an oxide of a specific element, a carbonate, a sulfate, a nitrate, an oxalate, or a hydroxide) at a high temperature, and then cooling and solidifying the molten substance.

Specific examples of the vapor-deposition method using a vapor-deposition material include a vacuum vapor-deposition method. The vacuum vapor-deposition method is a method in which a vapor-deposition material is evaporated in a vacuum chamber and deposited on the surface of a substrate.

The temperature during the vapor-deposition (e.g., in the case where a vacuum deposition apparatus is used, the temperature of a boat in which the deposition material is disposed) is preferably from 100 to 3,000° C. and more preferably from 500 to 3,000° C.

The pressure during the vapor-deposition (e.g., in the case where a vacuum deposition apparatus is used, the pressure in a chamber in which the deposition material is disposed) is preferably 1 Pa or lower, and more preferably 0.1 Pa or lower.

When an underlayer is formed by using a vapor-deposition material, one vapor-deposition material may be used, or two or more vapor-deposition materials comprising different elements may be used.

Specific examples of the method for evaporating a vapor-deposition material include a resistive heating method in which a vapor-deposition material is melted and evaporated on a resistive heating boat made of a high melting-point metal, and an electron gun method in which a vapor-deposition material is irradiated with an electron beam and thereby directly heated, so that its surface is melted and evaporated. As the method for evaporating a vapor-deposition material, the electron gun method is preferred because since the material can be locally heated, even a material having a high melting point can be evaporated, and since an area that is not irradiated with the electron beam is kept at a low temperature, there is no risk of reaction with the container nor risk of contamination by impurities.

As the method for evaporating a vapor-deposition material, a plurality of boats may be used, or the whole vapor-deposition materials may be put in a single boat. The vapor-deposition method may be co-vapor deposition or alternating vapor deposition. Specific examples include an example in which silica and a specific source are mixed and used in the same boat, an example in which co-vapor deposition is performed in a state in which silica and a specific element source are put in separate boats, and an example in which alternating vapor deposition is performed in a similar manner, i.e., in a state in which silica and a specific element source are put in separate boats. The conditions for the vapor deposition, the order, and the like are selected as appropriate according to the structure of the underlayer.

In the wet coating method, it is preferred to form an underlayer on a substrate by a wet coating method using a coating liquid comprising a compound comprising silicon, a compound comprising a specific element, and a liquid medium.

Specific examples of silicon compounds include silicon oxide, silicic acid, partial condensate of silicic acid, alkoxysilane, and partial hydrolysis condensate of alkoxysilane.

Specific examples of compounds comprising a specific element include oxides of the specific element, alkoxides of the specific element, carbonates of the specific element, sulfates of the specific element, nitrates of the specific element, oxalates of the specific element, and hydroxides of the specific element.

Examples of liquid mediums include those similar to liquid mediums contained in the composition according to the present disclosure.

The content of the liquid medium is preferably from 0.01 to 20 mass % and more preferably from 0.1 to 10 mass % based on the total amount of the coating liquid used for the formation of the underlayer.

Specific examples of the wet coating method for forming an underlayer include a spin coating method, a wipe coating method, a spray coating method, a squeegee coating method, a dip coating method, a die coating method, an ink jet method, a flow coating method, a roll coating method, a casting method, a Langmuir-Blodgett method, and a gravure coating method.

After the substrate or the like is wet-coated with the coating liquid, the coating is preferably dried. The drying temperature of the coating is preferably from 20 to 200° C. and more preferably from 80 to 160° C.

The article according to the present disclosure may be an optical material including a surface treatment layer as the outermost layer.

Examples of preferred optical materials include a wide variety of optical materials in addition to optical materials related to displays or the like.

Examples of optical materials include a cathode ray tube (CRT; e.g., a computer monitor), a display such as a liquid crystal display, a plasma display, an organic EL display, an inorganic thin film EL dot matrix display, a rear projection-type display, a vacuum fluorescent display (VFD), and a field emission display (FED), a protective plate for such a display, or those in which an antireflection film treatment is performed on their surfaces.

The article according to the present disclosure is preferably an optical member. Examples of optical members include a car navigation system, a mobile phone, a smartphone, a digital camera, a digital video camera, a PDA, a portable audio player, a car audio system, a game apparatus, a lens for eyeglasses, a camera lens, a lens filter, sunglasses, a medical apparatus such as a gastroscope, a copying machine, a PC, a display (e.g., a liquid crystal display, an organic EL display, a plasma display, and a touch panel display), a touch panel, a protective film, and an antireflection film.

Further, examples of optical members include a front protective plate for a display such as a PDP and an LCD, an antireflection plate, a polarizing plate, and an antiglare plate; a disk surface of an optical disk such as a Blu-ray (Blu-ray (Registered Trademark)) disk, a DVD disk, a CD-R, and an MO; an optical fiber; and a display surface of a clock or a watch.

In particular, the article according to the present disclosure is preferably a display or a touch panel.

The article according to the present disclosure may be a medical apparatus or a medical material. Further, the article according to the present disclosure may also be an automobile interior or exterior member. Examples of exterior members include a window, a light cover, and an external camera cover. Examples of interior members include an instrument panel cover, a navigation system touch panel, and a decorative interior member.

When the article according to the present disclosure is an optical member, the material constituting the surface of the substrate is a material for an optical member, e.g., glass or transparent plastic. Further, when the article according to the present disclosure is an optical member, a functional layer such as a hard coat layer or an antireflection layer may be formed on the surface (outermost layer) of the substrate. The antireflection layer may be either a single-layer antireflection layer or a multi-layer antireflection layer.

Examples of inorganic substances that can be used for the antireflection layer include SiO₂, SiO, ZrO₂, TiO₂, TiO, Ti₂O₃, Ti₂O₅, Al₂O₃, Ta₂O₅, Ta₃O₅, Nb₂O₅, HfO₂, Si₃N₄, CeO₂, MgO, Y₂O₃, SnO₂, MgF₂, and WO₃. These inorganic substances may be used alone or in combination (e.g., as a mixture) of two or more of them. In the case of the multi-layer antireflection layer, it is preferred to use SiO₂ and/or SiO in the outermost layer. When the article according to the present disclosure is an optical glass component for a touch panel, a thin film using a transparent electrode, e.g., indium tin oxide (ITO) or indium zinc oxide, may be provided on a part of the surface of the substrate (glass). Further, the substrate may also include an insulating layer, an adhesive layer, a protective layer, a decorative frame layer (I—CON), an atomization film layer, a hard coating film layer, a polarizing film, a phase difference film, a liquid crystal display module, or the like according to its specific specifications.

### Method for Manufacturing Article

A method for manufacturing an article according to the present disclosure is, for example, a method for manufacturing an article including a surface treatment layer formed on a substrate by performing a surface treatment on the substrate by using a surface treatment agent according to the present disclosure. Examples of surface treatments include a dry coating method and a wet coating method.

Examples of dry coating methods include techniques such as vacuum vapor deposition, CVD, and sputtering. As the dry coating method, a vacuum vapor-deposition method is preferred in order to suppress the decomposition of the compound and in view of the simplicity of the apparatus. During the vacuum deposition, a pellet-like substance obtained by impregnating a porous material made of a metal such as iron or steel with a compound of the present disclosure may be used. A pellet-like substance, which is obtained by impregnating a porous material made of a metal such as iron or steel with a composition comprising a compound of the present disclosure and a liquid medium, and drying the liquid medium, may be used.

Examples of wet coating methods include a spin coating method, a wipe coating method, a spray coating method, a squeegee coating method, a dip coating method, a die coating method, an ink jet method, a flow coating method, a roll coating method, a casting method, a Langmuir-Blodgett method, and a gravure coating method.

In order to improve the abrasion resistance of the surface treatment layer, when necessary, an operation for accelerating the reaction between the compound of the present disclosure and the substrate may be performed. Examples of such operations include heating, humidification, and irradiation with light.

For example, it is possible to accelerate, by heating a substrate on which a surface treatment layer is formed in an atmosphere comprising moisture, the reaction such as a hydrolysis reaction of a hydrolyzable group, a reaction between a hydroxyl group or the like and a silanol group on the surface of the substrate, and formation of a siloxane bond by a condensation reaction of a silanol group.

After the surface treatment, compounds which are contained in the surface treatment layer and are not chemically bonded to other compounds nor the substrate may be removed as required. Examples of removal methods include a method in which a solvent is poured over the surface treatment layer, and a method in which the surface treatment layer or the like is wiped with a cloth impregnated with a solvent.

### EXAMPLES

The present invention will be described hereinafter in a more detailed manner by using Examples, but the present invention is not limited to these Examples. Note that, of Examples 1 to 8, Examples 1 to 7 are examples according to the present disclosure, and Example 8 is a comparative example.

### Example 1

### Synthesis Example 1A

2,3,4,5,6-pentafluorophenol (6.8 g), THF (tetrahydrofuran, 42 mL), and triethylamine (5.1 g) were added to a 100 mL flask under a nitrogen atmosphere, and the mixture was stirred at 25° C. Subsequently, 10-undecenoyl chloride (5.0 g) added dropwise, and the mixture was stirred for 1 hour. 7.9 g of a compound 1A was obtained by filtering the reaction solution, removing the solvent and low-boiling components by distillation under a reduced pressure, and performing flash column chromatography (developing solvent: hexane/ethyl acetate) using silica gel. The structure of the compound 1A was confirmed from NMR data shown below.

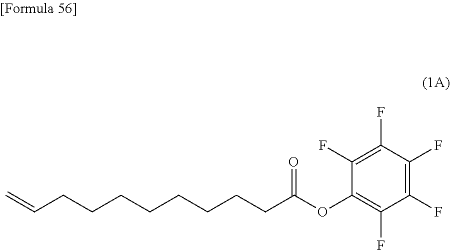 [SMILES: C=CCCCCCCCCC(=O)Oc1c(F)c(F)c(F)c(F)c1F]

¹H NMR (400 MHz, CDCl₃) δ 5.74 (ddt, J=16.9, 10.2, 6.6 Hz, 1H), 5.05-4.77 (m, 2H), 2.59 (t, J=7.4 Hz, 2H), 1.97 (q, J=7.1 Hz, 2H), 1.70 (p, J=7.4 Hz, 2H), 1.42-1.08 (m, 10H).

### Synthesis Example 1B

The compound 1A (5.6 g), THF (5.0 mL), chlorodimethylsilane (2.3 g), and a xylene solution of platinum/1,3-divinyl-1,1,3,3-tetramethyldisiloxane complex (platinum content: 3 mass %, 0.10 mL) were added to a 200 mL flask under a nitrogen atmosphere, and the mixture was stirred for 2 hours at 25° C. 7.2 g of a compound 1B was obtained by removing the solvent and low-boiling components from the reaction liquid by distillation under a reduced pressure. The structure of the compound 1B was confirmed from NMR data shown below.

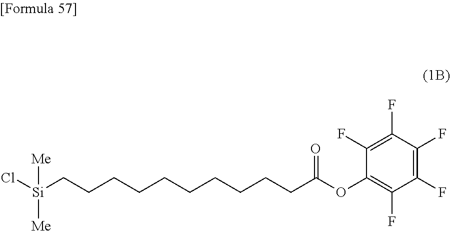 [SMILES: C[Si](C)(Cl)CCCCCCCCCCC(=O)Oc1c(F)c(F)c(F)c(F)c1F]

¹H NMR (400 MHz, CDCl₃) δ 2.63 (t, J=7.4 Hz, 2H), 1.74 (p, J=7.4 Hz, 2H), 1.46-1.17 (m, 14H), 0.90-0.69 (m, 2H), 0.37 (s, 6H).

### Synthesis Example 1C

A compound 1C was obtained by referring to the method disclosed in Organometallics 2014, 33, 2964-2967.

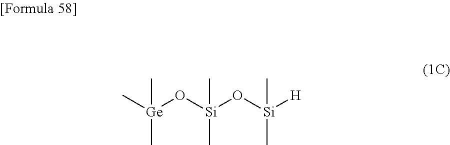

### Synthesis Example 1D

Dichloromethane (30 g) and trichloroisocyanuric acid (4.0 g) were added to the compound 1C (3.0 g), and the mixture was stirred at 25° C. for 2 hours. After removing insoluble matters by filtrating the reaction solution, dichloromethane was removed by distillation. Triethylamine (2.0 g), THF (20 g), and water (20 g) were added to the obtained compound, and the mixture was stirred at 25° C. for 2 hours. 1.0 g of a compound 1D was obtained by adding hexane to the reaction solution, performing extraction, and performing purification by distillation. The structure of the compound 1D was confirmed from NMR data shown below.

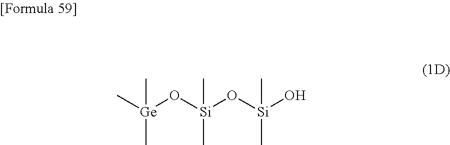

¹H NMR (400 MHz, CDCl₃) δ 3.55 (s, 1H), 0.35-0.03 (m, 21H).

### Synthesis Example 1E

THF (10 g) was added to the compound 1D (1.0 g), and the mixture was cooled to 0° C. After that, a methyl lithium solution (in diethoxymethane, 3.1 M) (1.0 mL) was added, the mixture was stirred for 10 minutes, then a solution obtained by dissolving hexamethylcyclotrisiloxane (4.7 g) in THF (20 mL) was dropped, and the mixture was stirred at 25° C. for 4 hours. After that, 2.0 g of the compound 1B was added, and the mixture was stirred at 25° C. for 1 hour. Hexane and ion-exchanged water were successively added to the reaction solution, and liquid separation was performed to separate an organic layer. 2.5 g of a compound 1E was obtained by removing the solvent and low-boiling components by distillation under a reduced pressure and then performing flash column chromatography (developing solvent: hexane/ethyl acetate) using silica gel. The structure of the compound 1E was confirmed from NMR data shown below. The average value of n^{b} in the compound 1E was 17.

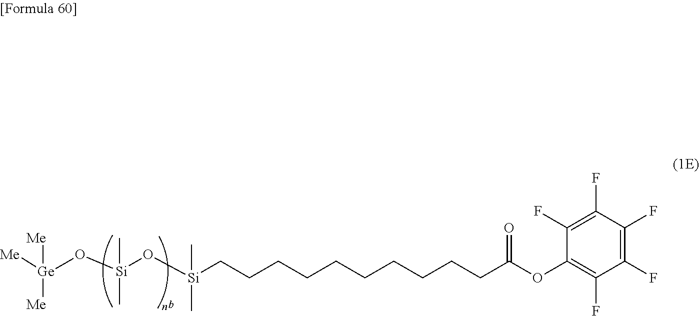

¹H NMR (400 MHz, CDCl₃) δ 2.80-2.45 (m, 2H), 1.73-1.05 (m, 16H), 0.50-0.05 (m, 119H).

### Synthesis Example 1F

Dichloromethane (10 g) was added to the compound 1E (1.0 g) and the mixture was made uniform, then 2,2-diallylpenta-4-ene-1-amine (0.32 g) was added, and the mixture was stirred at 25° C. for 12 hours. 0.85 g of a compound 1F was obtained by removing low-boiling components by distillation and then performing flash column chromatography (developing solvent: hexane/ethyl acetate) using silica gel. The structure of the compound 1F was confirmed from NMR data shown below. The average value of n^{b} in the compound 1F was 17.

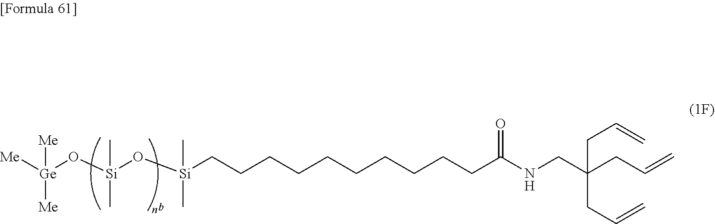

¹H NMR (400 MHz, CDCl₃) δ 5.80 (ddt, J=17.7, 10.6, 7.4 Hz, 3H), 5.15-4.90 (m, 6H), 3.12 (d, J=6.3 Hz, 2H), 2.09 (t, J=7.5 Hz, 2H), 1.96 (dd, J=7.6, 1.3 Hz, 6H), 1.34-1.07 (m, 16H), 0.45 (t, J=7.5 Hz, 2H), 0.30-0.10 (m, 117H).

### Synthesis Example 1G

The compound 1F (0.85 g), a toluene solution of a platinum/1,3-divinyl-1,1,3,3-tetramethyldisiloxane complex (platinum content: 3 mass %, 4.1 mg), aniline (2.6 mg), and trimethoxysilane (0.20 g) were added to dichloromethane (10 g), and the mixture was stirred at 50° C. for 2 hours. 0.90 g of a compound 1G was obtained by removing the solvent from the reaction solution by distillation under a reduced pressure. The structure of the compound 1G was confirmed from NMR data shown below. The average value of n^{b} in the compound 1G was 17.

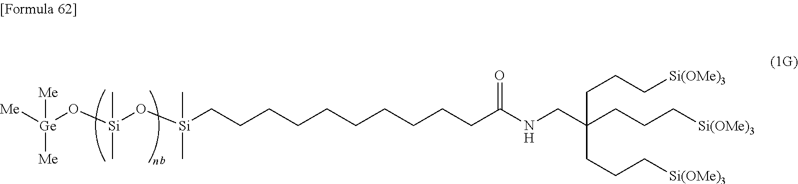

¹H NMR (400 MHz, CDCl₃) δ 5.66 (d, J=6.2 Hz, 1H), 3.58 (s, 27H), 3.29 (d, J=7.1 Hz, 2H) 2.12 (t, J=7.1 Hz, 2H), 1.61-1.42 (m, 2H), 1.32-1.02 (m, 26H), 0.53 (t, J=7.7 Hz, 6H), 0.45 (t, J=6.8 Hz, 2H), 0.36-0.24 (m, 117H).

### Example 2

### Synthesis Example 2A

Dichloromethane (10 g), 4-pentene-1-amine, and 2-(2-propene-1-yl) (0.25 g) were added to the compound 1E (1.0 g), and the mixture was stirred at 25° C. for 12 hours. 0.81 g of a compound 2A was obtained by removing low-boiling components from the reaction solution by distillation and performing flash column chromatography (developing solvent: hexane/ethyl acetate) using silica gel. The structure of the compound 2A was confirmed from NMR data shown below. The average value of n^{C} in the compound 2A was 17.

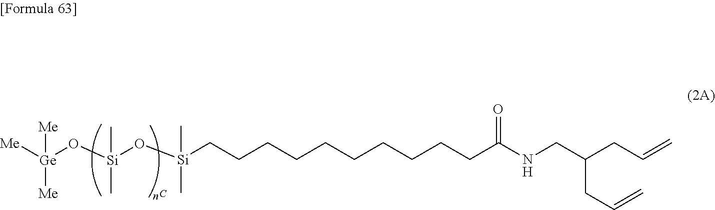

¹H NMR (400 MHz, CDCl₃) δ 5.71 (ddt, J=15.9, 10.4, 7.1 Hz, 2H), 5.52 (s, 1H), 5.08-4.81 (m, 4H), 3.16 (t, J=6.3 Hz, 2H), 2.29-1.33 (m, 7H), 1.33-1.00 (m, 16H), 0.45 (t, J=7.6 Hz, 2H), 0.36-0.24 (m, 117H).

### Synthesis Example 2B

The compound 2A (0.81 g), a toluene solution of a platinum/1,3-divinyl-1,1,3,3-tetramethyldisiloxane complex (platinum content: 3 mass %, 4.1 mg), aniline (2.6 mg), and trimethoxysilane (0.17 g) were added to dichloromethane (10 g), and the mixture was stirred at 50° C. for 2 hours. 0.85 g of a compound 2B was obtained by removing the solvent from the reaction solution by distillation under a reduced pressure. The structure of the compound 2B was confirmed from NMR data shown below. The average value of n^{C} in the compound 2B was 17.

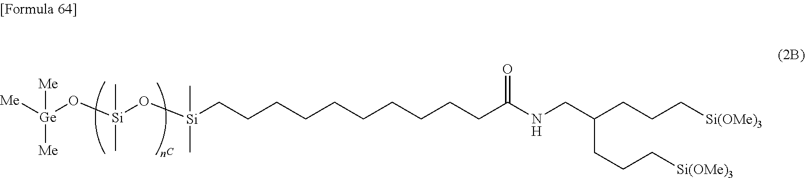

¹H NMR (400 MHz, CDCl₃) δ 5.52-5.38 (m, 1H), 3.49 (s, 18H), 3.11 (t, J=6.0 Hz, 2H), 2.21-1.99 (m, 2H), 1.67-0.91 (m, 25H), 0.64-0.35 (m, 6H), 0.10 (s, 117H).

### Example 3

### Synthesis Example 3A

Lithium chloride (23.7 g), water (6.45 g), and dimethyl sulfoxide (263 g) were added to diethyl diallyl malonate (60.0 g), and the mixture was stirred at 160° C. After the mixture was cooled to 25° C., water was added, and extraction was performed with ethyl acetate. Hexane was added to an organic layer, the mixture was washed with a saturated saline solution, and the mixture was dried with sodium sulfate. 39.5 g of a compound 3A was obtained by removing the solvent by distillation after the filtration. The structure of the compound 3A was confirmed from NMR data shown below.

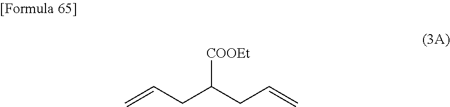

¹H NMR (400 MHz, CDCl₃) δ (ddt, J=17.1, 10.1, 7.0 Hz, 2H), 5.06-4.94 (m, 4H), 4.09 (q, J=7.1 Hz, 2H), 2.47 (ddd, J=14.0, 8.0, 6.1 Hz, 1H), 2.33 (dt, J=14.9, 7.5 Hz, 2H), 2.22 (dt, J=14.1, 6.5 Hz, 2H), 1.21 (t, J=7.1 Hz, 3H).

### Synthesis Example 3B

Diisopropylamine (29.8 mL) was added to THF (260 mL), and the solution was cooled to −78° C. An n-butyllithium hexane solution (2.76 M, 96.6 mL) was added, and the temperature was raised to 0° C. After the mixture was stirred at 0° C., the temperature was cooled to −78° C., and the THF solution of lithium diisopropylamide (LDA) was prepared. After the compound 3A (39.5 g) was added and stirred, allyl bromide (24.1 mL) was added. The temperature was raised to 0° C., 1M hydrochloric acid (100 mL) was added, and the THF was removed by distillation under a reduced pressure. After performing extraction with dichloromethane, sodium sulfate was added. After the filtration, the solvent was removed by distillation and flash column chromatography (developing solvent: ethyl acetate/hexane) using silica gel was performed to obtain 45.0 g of a compound 3B. The structure of the compound 3B was confirmed from NMR data shown below.

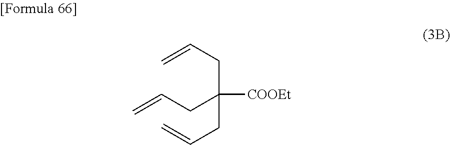

¹H NMR (400 MHz, CDCl₃) δ 5.74-5.62 (m, 3H), 5.04 (dd, J=13.6, 1.9 Hz, 6H), 4.10 (q, J=7.1 Hz, 2H), 2.29 (d, J=7.4 Hz, 6H), 1.22 (t, J=7.1 Hz, 3H).

### Synthesis Example 3C

THF (620 mL) was added to the compound 3B (45.0 g, 216 mmol), and the temperature was cooled to 0° C. A THF solution (104 mL) of lithium aluminum hydride were added, and the mixture was stirred. Water and a 15 mass % aqueous sodium hydroxide solution were added, the mixture was stirred at 25° C., and then this mixture was diluted with dichloromethane. After the filtration, the solvent was removed by distillation and flash column chromatography (developing solvent: ethyl acetate/hexane) using silica gel was performed to obtain 31.3 g of a compound 3C. The structure of the compound 3C was confirmed from NMR data shown below.

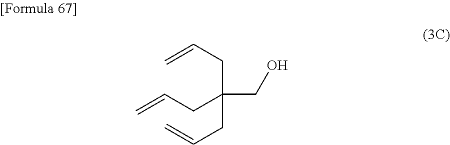

¹H NMR (400 MHz, CDCl₃) δ 5.90-5.76 (m, 3H), 5.10-5.02 (m, 6H), 3.38 (s, 2H), 2.03 (dt, J=7.5, 1.2 Hz, 6H), 1.45 (s, 1H).

### Synthesis Example 3D

The compound 3C (31.3 g), triphenylphosphine (64.3 g), and carbon tetrachloride (33.9 g) were added to acetonitrile (380 mL), and the mixture was stirred at 90° C. After the concentration, ethyl acetate/hexane was added and stirred. After the filtration and concentration, 28.2 g of a compound 3D was obtained by distillation (70° C., 3 hPa). The structure of the compound 3D was confirmed from NMR data shown below.

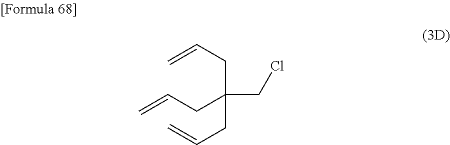

¹H NMR (400 MHz, CDCl₃) δ 5.83-5.67 (m, 3H), 5.16-5.01 (m, 6H), 3.32 (s, 2H), 2.05 (dt, J=7.5, 1.1 Hz, 6H).

### Synthesis Example 3E

THF (35 mL) and iodine (0.180 g) were added to magnesium (2.36 g, 97.2 mmol), and the mixture was stirred at 25° C. A solution (0.80 M) of a compound 3E was obtained by adding a THF (35 mL) solution of the compound 3D (14.0 g) and performing heating and refluxing for 2 hours.

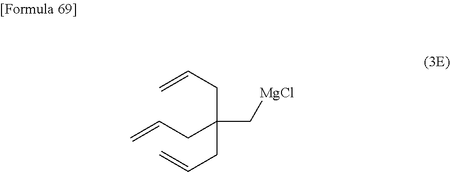

### Synthesis Example 3F

1-bromo-4-chlorobutane (2.89 g), 1-phenyl-1-propyne (0.198 g), and CuCl₂ (0.049 g) were added, and the mixture was stirred at 0° C. The compound 3E (0.80 M, 24.0 mL) was added and stirred. 1M hydrochloric acid was added, extraction was performed by dichloromethane, and sodium sulfate was added. 3.45 g of a compound 3F was obtained by performing distillation (120° C., 3 hPa) after filtration and concentration. The structure of the compound 3F was confirmed from NMR data shown below.

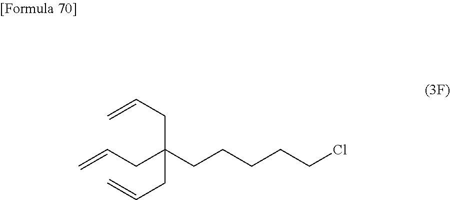 [SMILES: C=CCC(CC=C)(CC=C)CCCCCCl]

¹H NMR (400 MHz, CDCl₃) δ 5.76 (ddt, J=16.8, 10.4, 7.4 Hz, 3H), 5.07-4.92 (m, 6H), 3.49 (t, J=6.8 Hz, 2H), 1.94 (dt, J=7.4, 1.2 Hz, 6H), 1.79-1.67 (m, 2H), 1.42-1.30 (m, 2H), 1.30-1.20 (m, 2H), 1.20-1.10 (m, 2H).

### Synthesis Example 3G

THF (2.6 mL) and iodine (14.0 mg) were added to magnesium (0.168 g), and the mixture was stirred at 25° C. A solution (0.74 M) of a compound 3G was obtained by adding a THF (2.6 mL) solution of the compound 3F (1.41 g) and performing heating and refluxing for 2 hours.

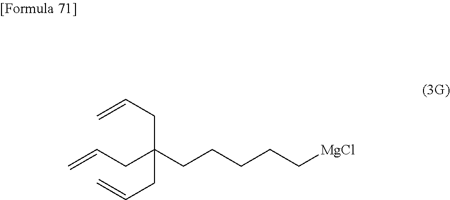

### Synthesis Example 3H

Trimethylchlorogermane (3.0 g) was added to a THF solution (0.74 M) (20 mL) of the compound 3G, and the mixture was stirred at 50° C. for 12 hours. Hydrochloric acid and hexane were added, an organic layer was extracted, and then low-boiling components were removed by distillation. After that, flash column chromatography (developing solvent: hexane/dichloromethane) using silica gel was performed to obtain 0.75 g of a compound 3H. The structure of the compound 3H was confirmed from NMR data shown below.

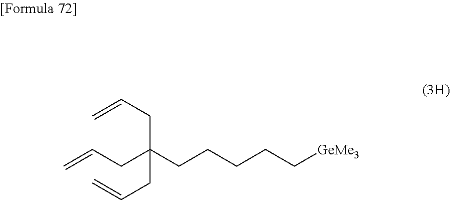

¹H NMR (500 MHz, CDCl₃) δ 5.70 (ddt, J=16.9, 11.4, 7.4 Hz, 3H), 5.27-4.83 (m, 6H), 1.84 (dt, J=7.3, 1.0 Hz, 6H), 1.44-0.71 (m, 10H), 0.13 (s, 9H).

### Synthesis Example 3I

Dichloromethane (10 g), compound 3H (0.75 g), a toluene solution of a platinum/1,3-divinyl-1,1,3,3-tetramethyldisiloxane complex (platinum content: 3 mass %, 4.1 mg), aniline (2.6 mg), and trimethoxysilane (1.5 g) were added, and the mixture was stirred at 50° C. for 2 hours. 1.25 g of a compound 31 was obtained by removing the solvent by distillation under a reduced pressure. The structure of the compound 31 was confirmed from NMR data shown below.

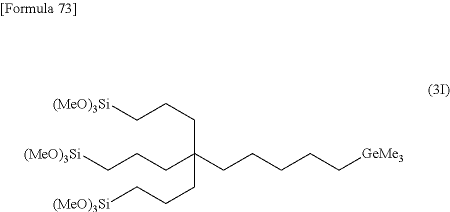

¹H NMR (500 MHz, CDCl₃) δ 3.58 (s, 27H), 1.48-0.79 (m, 22H), 0.68 (t, J=9.4 Hz, 6H), 0.13 (s, 9H).

### Example 4

### Synthesis Example 4A

Trimethyltin chloride (3.0 g) was added to a THF solution (0.74M) (20 mL) of the compound 3A, and the mixture was stirred at 50° C. for 12 hours. Hydrochloric acid and hexane were added, an organic layer was extracted, and then low-boiling components were removed by distillation. After that, 1.2 g of a compound 4A was obtained by performing flash column chromatography (developing solvent: hexane/dichloromethane) using silica gel. The structure of the compound 4A was confirmed from NMR data shown below.

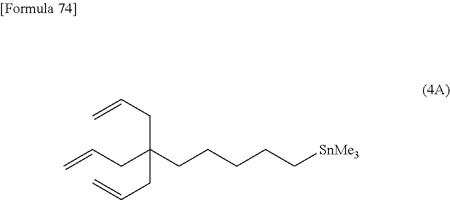

¹H NMR (500 MHz, CDCl₃) δ 5.70 (ddt, J=16.8, 11.3, 7.4 Hz, 3H), 5.33-4.78 (m, 6H), 1.84 (dt, J=7.3, 1.0 Hz, 6H), 1.51-0.36 (m, 10H), 0.16 (s, 9H).

### Synthesis Example 4B

The compound 4A (1.2 g), a toluene solution of a platinum/1,3-divinyl-1,1,3,3-tetramethyldisiloxane complex (platinum content: 3 mass %, 4.1 mg), aniline (2.6 mg), and trimethoxysilane (2.0 g) were added to dichloromethane (10 g), and the mixture was stirred at 50° C. for 2 hours. 1.9 g of a compound 4B was obtained by removing the solvent by distillation under a reduced pressure. The structure of the compound 4B was confirmed from NMR data shown below.

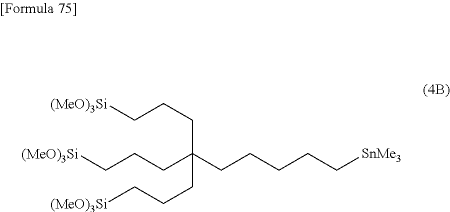

¹H NMR (500 MHz, CDCl₃) δ 3.55 (s, 27H), 1.48-0.65 (m, 22H), 0.55 (t, J=9.4 Hz, 6H), 0.16 (s, 9H).

### Example 5

### Synthesis Example 5A

THF (20 mL) and magnesium (1.1 g) were added to 11-bromo-1-undecene (10 g), and the mixture was stirred at 60° C. for 2 hours. 30 g of a THF solution of a compound 5A was obtained by filtrating the reaction solution. It has been confirmed, as a result of titration using 1,10-phenanthroline, that the concentration of the product was 0.8 M.

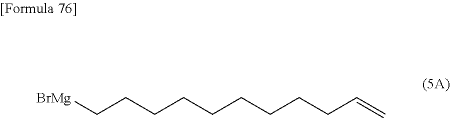

### Synthesis Example 5B

THF (20 mL), copper chloride (II) (0.05 g), and 1-phenyl-1-propyne (0.1 g) were added to 1,12-dibromododecane (15 g), the mixture was stirred to be made uniform, then a THF solution (30 g) of the compound 5A was added, and the mixture was stirred at 40° C. for 2 hours. Hydrochloric acid and hexane were added, an organic layer was extracted, and then low-boiling components were removed by distillation. After that, flash column chromatography (developing solvent: hexane) using silica gel was performed to obtain 1.3 g of a compound 5B. The structure of the compound 5B was confirmed from NMR data shown below.

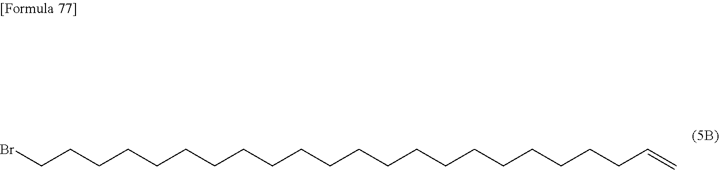 [SMILES: C=CCCCCCCCCCCCCCCCCCCCCCBr]

¹H NMR (400 MHz, CDCl₃) δ 5.84 (ddt, J=16.9, 10.2, 6.7 Hz, 1H), 5.16-4.74 (m, 2H), 3.43 (t, J=6.9 Hz, 2H), 2.10-2.02 (m, 2H), 1.88 (p, J=7.0 Hz, 2H), 1.50-1.06 (m, 36H).

### Synthesis Example 5C

THF (20 mL) and magnesium (0.3 g) were added to the compound 5B (1.3 g), and the mixture was stirred at 60° C. for 2 hours. After the reaction solution was filtered, trimethylchlorogermane (1.0 g) was added to the filtrate, and the mixture was stirred at 50° C. for 12 hours. Hydrochloric acid and hexane were added, an organic layer was extracted, and then low-boiling components were removed by distillation. After that, 0.73 g of a compound 5C was obtained by performing flash column chromatography (developing solvent: hexane/dichloromethane) using silica gel. The structure of the compound 5C was confirmed from NMR data shown below.

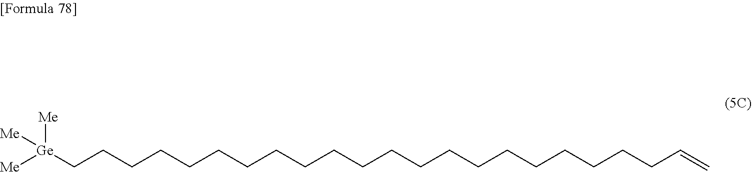

¹H NMR (400 MHz, CDCl₃) δ 5.80 (ddt, J=17.2, 10.2, 7.0 Hz, 1H), 5.21-4.73 (m, 2H), 2.03 (dtd, J=7.9, 6.8, 0.9 Hz, 2H), 1.49-0.72 (m, 40H), 0.14 (s, 9H).

### Synthesis Example 5D

The compound 5C (0.7 g), a toluene solution of a platinum/1,3-divinyl-1,1,3,3-tetramethyldisiloxane complex (platinum content: 3 mass %, 4.1 mg), aniline (2.6 mg), and trimethoxysilane (2.0 g) were added to dichloromethane (10 g), and the mixture was stirred at 50° C. for 2 hours. 0.8 g of a compound 5D was obtained by removing the solvent by distillation under a reduced pressure. The structure of the compound 5D was confirmed from NMR data shown below.

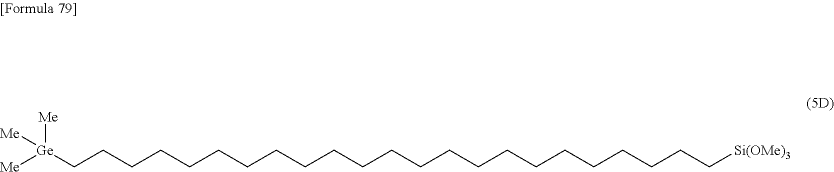

¹H NMR (400 MHz, CDCl₃) δ 3.58 (s, 9H), 1.51-1.11 (m, 42H), 0.97-0.58 (m, 4H), 0.35 (s, 9H).

### Example 6

### Synthesis Example 6A

The compound 5C (0.7 g), a toluene solution of a platinum/1,3-divinyl-1,1,3,3-tetramethyldisiloxane complex (platinum content: 3 mass %, 4.1 mg), trichlorosilane (2.0 g), and triacetoxymethylsilane (0.05 g) were added to dichloromethane (10 g), and the mixture was stirred at 30° C. for 2 hours. After the solvent was removed by distillation under a reduced pressure, allylmagnesium bromide (0.7M) (20 mL) was added, and heating and stirring were performed at 50° C. for 24 hours. Hydrochloric acid and hexane were added, an organic layer was extracted, and then low-boiling components were removed by distillation. After that, 0.8 g of a compound 6A was obtained by performing flash column chromatography (developing solvent: hexane/dichloromethane) using silica gel. The structure of the compound 6A was confirmed from NMR data shown below.

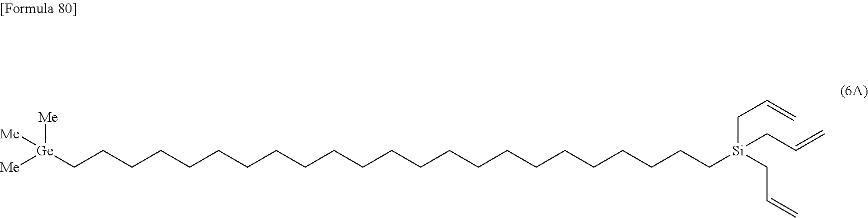

¹H NMR (400 MHz, CDCl₃) δ 5.67-5.30 (m, 3H), 5.17-4.81 (m, 6H), 1.62-0.80 (m, 50H), 0.57-0.18 (m, 11H).

### Synthesis Example 6B

The compound 6A (0.7 g), a toluene solution of a platinum/1,3-divinyl-1,1,3,3-tetramethyldisiloxane complex (platinum content: 3 mass %, 4.1 mg), aniline (2.6 mg), and trimethoxysilane (2.0 g) were added to dichloromethane (10 g), and the mixture was stirred at 50° C. for 2 hours. 1.1 g of a compound 6B was obtained by removing the solvent by distillation under a reduced pressure. The structure of the compound 6B was confirmed from NMR data shown below.

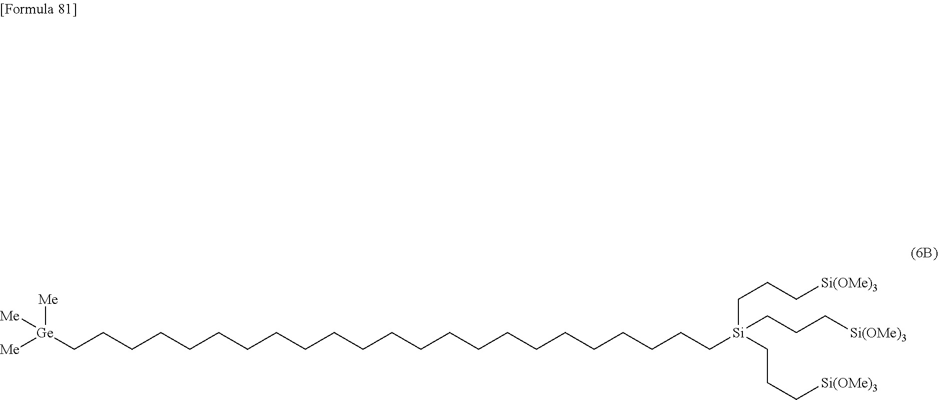

¹H NMR (400 MHz, CDCl₃) δ 3.58 (s, 27H), 1.46-−0.00 (m, 73H).

### Example 7

### Synthesis Example 7A

A THF solution (0.8M) (20 mL) of the compound 5A was added to dimethylgermanium dichloride (1.0 g), and the mixture was stirred at 60° C. for 2 hours. Hydrochloric acid and hexane were added, an organic layer was extracted, and then low-boiling components were removed by distillation. After that, 1.5 g of a compound 7A was obtained by performing flash column chromatography (developing solvent: hexane/dichloromethane) using silica gel. The structure of the compound 7A was confirmed from NMR data shown below.

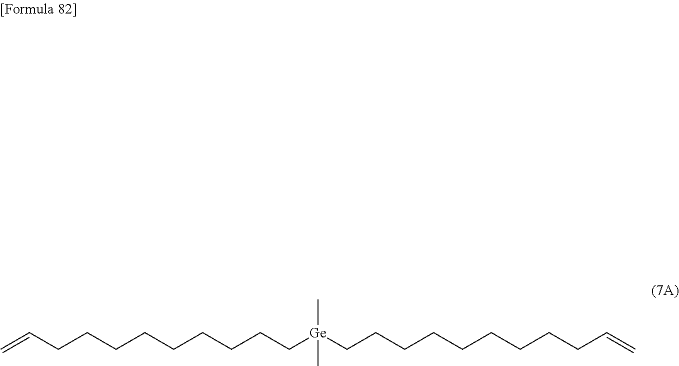

¹H NMR (400 MHz, CDCl₃) δ 5.80 (ddt, J=17.2, 10.2, 7.0 Hz, 2H), 5.23-4.81 (m, 4H), 2.03 (tdt, J=7.8, 6.7, 1.0 Hz, 4H), 1.42-0.71 (m, 32H), 0.20 (s, 6H).

### Synthesis Example 7B

The compound 7A (1.0 g), a toluene solution of a platinum/1,3-divinyl-1,1,3,3-tetramethyldisiloxane complex (platinum content: 3 mass %, 4.1 mg), aniline (2.6 mg), and trimethoxysilane (2.0 g) were added to dichloromethane (10 g), and the mixture was stirred at 50° C. for 2 hours. 1.5 g of a compound 7B was obtained by removing the solvent by distillation under a reduced pressure. The structure of the compound 7B was confirmed from NMR data shown below.

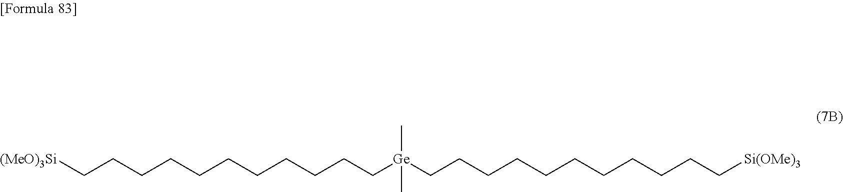

¹H NMR (400 MHz, CDCl₃) δ 3.58 (s, 18H), 1.57-0.71 (m, 20H), 0.74-0.18 (m, 10H).

### Synthesis Example 8A

2,2-diallyl-4-pentene-1-amine (1.71 g), 1-(3-dimethylaminopropyl)-3-ethylcarbodiimide hydrochloride (1.98 g), triethylamine (1.44 mL), 4-dimethylaminopyridine (84 mg), and dichloromethane (30 mL) were added to (CH₃)₃Si—O(Si(CH₃)₂O)₁₇—Si(CH₃)₂—(CH₂)₁₀—COOH (10 g), and the mixture was stirred at 25° C. for 24 hours. A compound 5A (8.88 g) was obtained by diluting the reaction solution with dichloromethane, washing the diluted solution with hydrochloric acid and water, and performing concentration under a reduced pressure. The structure of the compound 8A was confirmed from NMR data shown below. The average value of n^{d} in the compound 5A was 17.

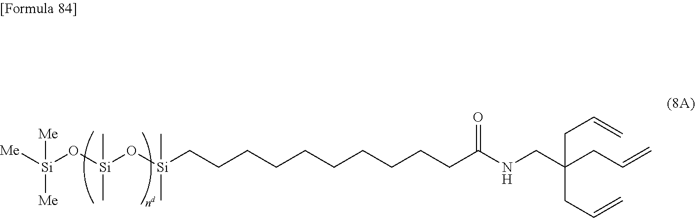

¹H NMR (400 MHz, CDCl₃) δ −0.20-0.25 (m), 1.45-1.59 (m, 2H), 1.20-1.48 (m, 14H), 1.53-1.65 (m, 2H), 2.03 (d, 7.6 Hz, 2H), 2.16 (t, 7.6 Hz, 2H), 3.20 (d, 6.4 Hz, 2H), 5.05-5.14 (m, 6H), 5.51-5.60 (m, 1H), 5.80-5.93 (m, 3H).

¹³C NMR (133 MHz, CDCl₃) δ 0.2, 1.0, 1.8, 18.3, 23.2, 29.3, 29.4, 29.6, 30.3, 33.5, 37.1, 40.0, 40.1, 45.0, 118.1, 134.2, 172.9.

### Synthesis Example 8B

Toluene (10 mL), a xylene solution of a Karstedt catalyst (2 mass %, 0.29 mL), aniline (46 mg), and trimethoxysilane (1.43 mL) were added to the compound 8A (2 g), and the mixture was stirred at 25° C. for 24 hours. A compound 8B (2.21 g) was obtained by concentrating the reaction solution under a reduced pressure. The structure of the compound 8B was confirmed from NMR data shown below. The average value of n^{d} in the compound 8B was 17.

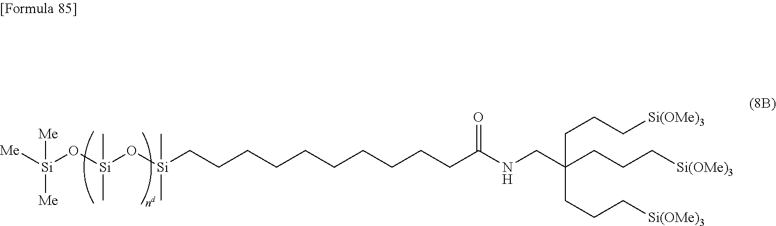

¹H NMR (400 MHz, CDCl₃) δ −0.2-0.21 (m), 0.41-0.65 (m, 8H), 1.10-1.50 (m, 26H), 1.55-1.65 (m, 2H), 2.14 (t, 7.2 Hz, 2H), 3.09 (d, 6.0 Hz, 2H), 3.45-3.62 (m, 27H), 5.67-5.75 (m, 1H).

¹³C NMR (133 MHz, CDCl₃) δ 0.1, 1.0, 1.7, 9.5, 16.1, 18.2, 23.2, 26.0, 29.4, 29.4, 29.6, 30.2, 33.4, 37.0, 38.1, 39.1, 43.6, 50.4, 173.0.

### [Manufacturing of Article]

30 g of silicon oxide was disposed as a vapor deposition source on a copper hearth in a vacuum vapor deposition apparatus (VTR-350M manufactured by ULVAC Kiko Co., Ltd.). A glass substrate was disposed in the vacuum vapor deposition apparatus, and the inside of the vacuum vapor deposition apparatus was evacuated until the pressure reached 5×10⁻³ Pa or less. The hearth was heated to about 2,000° C., and silicon oxide was vacuum-deposited on the surface of the substrate, whereby a substrate with the silicon oxide layer including a silicon oxide layer having a thickness of about 20 nm was prepared.

The substrate with the silicon oxide layer was placed on a sample stage of a spray coater (API-90RS manufactured by Apiros Co., Ltd.) so that the silicon oxide layer was on the surface. Next, 13 g of a heptane solution comprising 0.2% by mass of each compound obtained in each example was charged into a syringe in the spray coater, and spray-applied at an atomization pressure of 130 kPa, a distance between a nozzle and a sample surface of 50 mm, and a scanning speed of 300 mm/sec (wet coating method). Thereafter, the substrate with the silicon oxide layer having the surface on which the compound was applied was heat-treated at 140° C. for 30 minutes, whereby an evaluation sample (article) in which the substrate, the silicon oxide layer, and the surface treatment layer are layered in this order was obtained.

### [Evaluations]

### <Water Repellency>

Approximately 2 μL of distilled water was dropped on the surface treatment layer of the article, and the initial water contact angle was measured using a contact angle measuring apparatus (product name “DM-500”, manufactured by Kyowa Interface Science Co., Ltd.). The water repellency of the surface treatment layer was evaluated based on the following criteria using the average value obtained by performing measurement at five locations on the surface treatment layer as a water contact angle. The 20 method was used to calculate the water contact angle. Table 1 shows the results.

A: The water contact angle was 1050 or more.
B: The water contact angle was 100 or more but less than 105°.
C: The water contact angle was less than 100°.

### <Oil Repellency>

Approximately 2 μL of n-hexadecane was dropped on the surface treatment layer of the article, and the initial oil contact angle (n-hexadecane contact angle) was measured using a contact angle measuring apparatus (product name “DM-500”, manufactured by Kyowa Interface Science Co., Ltd.). The oil repellency of the surface treatment layer was evaluated based on the following criteria using the average value obtained by performing measurement at five locations on the surface treatment layer as an oil contact angle. The 20 method was used to calculate the oil contact angle. Table 1 shows the results.

A: The oil contact angle was 380 or more.
B: The oil contact angle was less than 38°.

### <Friction Resistance>

A steel wool Bonstar (#0000) was reciprocated 10,000 times on the surface treatment layer of the article at a pressure of 98.07 kPa and a speed of 320 cm/min according to JIS L0849: 2013 (corresponding to ISO: 105-X12: 2001) by using a reciprocating traverse tester (manufactured by KNT), and then, the water contact angle after the friction test was measured. The method for measuring the water contact angle after the friction test was similar to that for the initial water contact angle in the above-described method for evaluating water repellency. The smaller the decrease in the water repellency (water contact angle) after the friction, the smaller the decrease in the performance due to the friction, and the better the friction resistance is. The friction resistance (abrasion resistance) of the surface treatment layer was evaluated based on the following evaluation criteria. Table 1 shows the results.

Change in water contact angle=(Initial water contact angle)−(Water contact angle after friction test)

AA: Change in the water contact angle was 3 degrees or less.
A: Change in the water contact angle was above 3 degrees but 5 degrees or less.
B: Change in the water contact angle was above 5 degrees.

### <Fingerprint Removal Property>

A 1 kg weight including a red rubber stopper having a diameter of 2 cm as a fingerprint stamp portion was prepared. Then, 70 μL of an artificial fingerprint solution (manufactured by Isekyu Co., Ltd.) was dropped onto a cloth, and the fingerprint stamp was attached to the artificial fingerprint solution for 1 minute. In order to remove the artificial fingerprint solution excessively attached to the fingerprint stamp, the fingerprint stamp was attached to the new cloth for 20 seconds. Thereafter, the article on which the surface treatment layer was formed was placed on a hot plate with the temperature adjusted to 23° C. The fingerprint stamp was stamped against the surface treatment layer.

Next, the article to which the artificial fingerprint solution was attached was placed on a sliding device (product name “HHS-2000”, manufactured by Shinto Scientific Co., Ltd.). A planar indenter having an area of 1 cm square was attached to a wiping cloth (Savina Minimax manufactured by KB SEIREN Co., Ltd.) using a double-sided tape, and was installed in a sliding device. The artificial fingerprint solution attached to the surface treatment layer was wiped off with the wiping cloth in one direction with a load of 100 g. The haze of the wiped portion was measured with a haze meter (product name “NDH7000SP”, manufactured by Nippon Denshoku Industries Co., Ltd.). The fingerprint removal property of the surface was evaluated based on the following evaluation criteria. Table 1 shows the results.

A: Haze value was less than 0.1%.
B: Haze value was 0.1% or more and less than 1%.
C: Haze value was 1% or more.

### <Water Resistance Test>

An article was cut into pieces having an area of 1 cm×1 cm square and the pieces of the article was immersed in ultrapure water at 20° C. for 100 hours. After that the pieces of the article were retrieved, washed with ethanol, dried, and the water contact angle was measured. The smaller the decrease in the water repellency (water contact angle) after the immersion, the smaller the decrease in the performance due to water and the higher the water resistance property. The evaluation criteria were as follows.

A: Decrease in the water contact angle after immersion was 3° or less.
B: Decrease in the water contact angle after immersion was above 3° but 5° or less.
C: Decrease in the water contact angle after immersion was above 5° but 10° or less.
D: Decrease in the water contact angle after immersion was above 10°.

TABLE 1

| | | Evaluations | | | | |
|---|---|---|---|---|---|---|
| Ex- | | | | | Fingerprint | Water |
| am- | Com- | Water | Oil | Friction | removal | resistance |
| ple | pound | repellency | repellency | resistance | property | property |
| 1 | 1G | A | A | A | A | C |
| 2 | 2B | A | A | A | A | C |
| 3 | 3I | A | A | A | A | B |
| 4 | 4B | A | A | A | A | B |
| 5 | 5D | A | A | A | A | A |
| 6 | 6B | A | A | A | A | A |
| 7 | 7B | B | B | AA | A | A |
| 8 | 8B | A | B | A | B | C |

As shown in Table 1, it has been confirmed that the compounds in Examples 1-7 having the Group P and the Group Q can form a surface treatment layer having a fingerprint removal property compared to the compound in Example 8 which has a similar structure but does not include the group Q.

A compound of the present disclosure is useful as a surface treatment agent. Such a surface treatment agent can be used, for example, for substrates in display devices such as touch panel displays, optical members, semiconductor elements, building materials, automobile components, and nanoimprinting technologies. Further, such a surface treatment agent can be used for bodies, window glasses (front glasses, side glasses, and rear glasses), mirrors, bumpers, and the like in transportation apparatuses such as trains, automobiles, ships, and airplanes. Further, such a surface treatment agent can be used for exterior walls of buildings, tents, photovoltaic modules, sound insulating plates, and outdoor articles such as concrete; and fishing nets, sweep nets, and water tanks. Further, such a surface treatment agent can be used for kitchens, bathrooms, washstands, mirrors, and toiletry components; chandeliers and ceramics such as tiles; and artificial marble and various indoor apparatuses such as air conditioners. Further, such a surface treatment agent can be used for antifouling treatments of jigs, inner walls, pipes, and the like in factories. Further, such a surface treatment agent can be used for goggles, glasses, helmets, pachinko, fibers, umbrellas, play equipment, and soccer balls. Further, such a surface treatment agent can be used as adhesion inhibitors for various packaging materials such as packaging materials for foods, packaging materials for cosmetics, and the interior of pots. Further, such a surface treatment agent can be used for car navigation systems, mobile phones, smart phones, digital cameras, digital video cameras, PDAs, portable audio players, car audios, game apparatuses, lenses for eyeglasses, camera lenses, lens filters, sunglasses, medical apparatuses such as gastroscopes, copy machines, PCs, displays (e.g., liquid crystal displays, organic EL displays, plasma displays, and touch panel displays), touch panels, protective films, and optical components such as antireflection films.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A compound comprising the following Group P and the following group Q:
Group P: -M¹R¹₂—
Group Q: —Si(R²)ₙL₃₋ₙ
wherein
M¹ is Sn or Ge,
R¹ is each independently a hydrocarbon group or a trialkylsilyloxy group,
R² is each independently a hydrocarbon group,
L is each independently a hydrolyzable group, a group having a hydrolyzable group, or a hydroxyl group, and
n is an integer from 0 to 2.

2. The compound according to claim 1, wherein the compound is represented by the following Formula (1) or the following Formula (2):
[R¹¹-M¹(R¹)₂-(Q)ᵣ₁-Z¹]ₚ₁A¹(Si(R²)ₙL₃₋ₙ)_{q1} (1)
(L₃₋ₙ(R²)ₙSi)_{q1}A²[Z¹-(Q)ᵣ₁-M¹(R¹)₂-(Q)ᵣ₁-Z¹]A²(Si(R²)ₙL₃₋ₙ)_{q1} (2)
where
M¹ is Sn or Ge,
R¹ is each independently a hydrocarbon group or a trialkylsilyloxy group,
R¹¹ is each independently a hydrocarbon group or a trialkylsilyloxy group, or an organopolysiloxane group,
Q is each independently —O— or —OC(═O)—,
r1 is each independently 0 or 1,
Z¹ is each independently an alkylene group, a polyalkylene oxide group, an organopolysiloxane group, or a combination of an alkylene group with an organopolysiloxane group,
A¹ is a single bond or a (p1+q1)-valent linking group,
R² is each independently a hydrocarbon group,
L is each independently a hydrolyzable group, a group having a hydrolyzable group, or a hydroxyl group,
n is each independently an integer from 0 to 2,
p1 and q1 are each independently an integer of 1 or more, and
A² is each independently a single bond or a (1+q1)-valent linking group.

3. The compound according to claim 1, wherein M¹ is Ge.

4. The compound according to claim 2, wherein the Z¹ is each independently a group represented by the following Formula (3):
—[{Si(R³)₂—O}ₛ₁—Si(R³)₂—(O)ᵣ₂]ₛ₂—(R²¹)ₛ₃— (3)
where
R³ is each independently a hydrocarbon group,
R²¹ is an alkylene group,
r2 is 0 or 1,
s1 is a number from 0 to 500,
s2 is 0 or 1,
s3 is 0 or 1, and
s2+s3 is 1 or 2.

5. The compound according to claim 2, wherein the p1 is an integer from 1 to 4.

6. The compound according to claim 2, wherein the q1 is each independently an integer from 1 to 4.

7. A composition comprising the compound according to claim 1 and a liquid medium.

8. A surface treatment agent comprising the compound according to claim 1.

9. A surface treatment agent comprising the compound according to claim 1 and a liquid medium.

10. A method for manufacturing an article including a surface treatment layer formed on a substrate by performing a surface treatment on the substrate by using a surface treatment agent comprising the compound according to claim 1.

11. An article comprising a substrate, and a surface treatment layer disposed on the substrate, a surface of the surface treatment layer being treated with a surface treatment agent comprising the compound according to claim 1.

12. The article according to claim 11, wherein the article is an optical member.

13. The article according to claim 11, wherein the article is a display or a touch panel.
